(19) United States
(12) Patent Application Publication
(10) Pub. No.: US 2006/0222786 A1
(43) Pub. Date: Oct. 5, 2006

(54) Cellulose acylate, cellulose acylate film, and method for production and use thereof

(75) Inventors: Toyohisa Oya, Minami-Ashigara-shi (JP); Saisuke Watanabe, Minami-Ashigara-shi (JP)

Correspondence Address: BIRCH STEWART KOLASCH & BIRCH, PO BOX 747, FALLS CHURCH, VA, 22040-0747, US

(73) Assignee: FUJI PHOTO FILM CO., LTD., Minami-Ashigara-shi (JP)

(21) Appl. No.: 11/344,223

(22) Filed: Feb. 1, 2006

(30) Foreign Application Priority Data
Feb. 1, 2005 (JP) 025232/2005
Feb. 1, 2005 (JP) 025227/2005
Feb. 1, 2005 (JP) 025229/2005
Feb. 1, 2005 (JP) 025230/2005

(51) Int. Cl. C08B 13/00; C09K 19/00

(52) U.S. Cl. 428/1.31; 536/58

(57) ABSTRACT

A cellulose acylate solution containing a cellulose acylate which satisfies 2.5≦A+B≦3, 0≦A≦2.5, 0.3≦B≦3 (wherein A is the substitution degree of an acetyl group, and B is the sum of the substitution degrees of an acyl group having 3 to 7 carbon atoms) and whose content of sulfur atoms of residual sulfate moiety S is such that 50 ppm<S<500 ppm. When solution casting is carried out using this solution, a cellulose acylate film having good surface state and low peel-off load can be produced.

### BACKGROUND OF THE INVENTION

1. Field of the Invention

The present invention relates to cellulose acylate and a method for production thereof, a cellulose acylate solution, a cellulose acylate film and a method for production thereof. The invention further relates to a high grade retardation film, a polarizing plate, an optical compensation film, a reflection-preventing film and an image display device employing the cellulose acylate film.

2. Description of the Related Art

Due to the transparency, toughness and optical isotropy, cellulose acetate is increasingly finding its usefulness in a variety of applications, including the use in the support of photographic sensitive materials, as well as the use in optical films for image display devices including liquid display devices and organic EL display devices. With regard to the optical film for liquid crystal display devices, methods of using cellulose acetate for polarizing plate protective films, or for retardation films for liquid crystal display devices of STN (Super Twisted Nematic) mode or the like by stretching the film to attain in-plane retardation (Re) and retardation of the thickness direction (Rth), are being implemented.

In recent years, there have been developed display devices of VA (Vertical Alignment) mode or OCB (Optical Compensated Bend) mode, where higher values of retardation such as Re and Rth are required compared with the STN mode. Thus, an optical film material having excellent property of manifesting retardation is on demand.

In order to cope with such demand, a cellulose acylate film has been disclosed as a new material for optical film, which is produced by a solution casting method in which a solution of mixed esters of an acetyl group and a propionyl group of cellulose (cellulose acetate propionate) is flow cast on a support, the solvent is evaporated, and then a cellulose acylate film is peeled off from the support (see, for example, JP-A-2001-188128).

The solution flow casting method is a film casting method of excellent productivity; however, depending on the structure of the cellulose acylate, a large peel-off load may be required when the cellulose acylate film formed on the support is peeled off from the support. In this case, the peel-off tension fluctuates, the film surface undergoes plastic deformation, stepped unevenness (peel-off steps) occurs, and the form of the surface may be deteriorated. Further, when the peel-off load is large, the film may be fractured before the film is peeled off from the support, and thus improvement is needed in the aspect of productivity.

As commercially available products of cellulose acylate, apart from cellulose acetate, various cellulose acetate butyrate and cellulose acetate propionate are disclosed for the uses for molding or for painting (see, for example, the 1994 catalogue of Eastman Chemical, Inc.).

Furthermore, for a retardation film having specific retardations, it is described that a liquid crystal display device capable of long-term use can be provided by using a cellulose acylate having a total substitution degree of an acyl group, a content of Group 2 element of 1 to 50 ppm, an amount of residual sulfate of 1 to 50 ppm in terms of sulfur atoms, and an amount of free acid of 1 to 100 ppm (see, for example, JP-A-2003-279729). Nevertheless, the techniques of the related art do not show the relationship between the structure of cellulose acylate or the amount of residual sulfate and the peel-off property of the solution cast film.

In addition, with respect to the solution cast film of cellulose acetate, it is known to use a peel-off promoting agent as a means to improve the peel-off property (See, for example, Technical Report of Japan Institute of Invention and Innovation, 2001-1745 (2001), p. 20). However, compared with cellulose acetate, mixed esters such as cellulose acetate butyrate may have poor peel-off property due to a decrease in the dope viscosity, and additives such as peel-off promoting agent may cause bleeding or surface failure depending on the method of use. Thus, it is strongly desired to develop a technique of enhancing the peel-off property of the solution cast film by improving the cellulose acylate material itself.

### SUMMARY OF THE INVENTION

It is an object of the present invention to provide a solution casting method for forming a cellulose acylate film by flow casting a cellulose acylate solution on a support and evaporating off the solvent, whereby the peel-off load is reduced not through modification of the structure of cellulose acylate, and also a cellulose acylate film having the film surface in good state can be produced with good productivity. It is another object of the invention to provide a cellulose acylate solution which enables the solution casting method, to provide a method for production of a cellulose acylate film using the solution casting method, and to provide a cellulose acylate film produced by the method for production. Further, it is another object of the invention to provide cellulose acylate which can be used for the cellulose acylate solution, thus resulting in a cellulose acylate having excellent thermal stability and optical performance, and a method for production thereof. Furthermore, it is another object of the invention to provide a high grade retardation film, a polarizing plate, an optical compensation film, a reflection-preventing film and an image display device.

These objects can be achieved by the following aspects of the invention.

[1] A method for production of cellulose acylate satisfying the requirements of (1) to (3) below:

(1): 2.5≦A+B≦3

(2): 0≦A≦2.5

(3): 0.3≦B≦3

wherein A represents the substitution degree of an acetyl group, and B represents the sum of the substitution degrees of an acyl group having 3 to 7 carbon atoms, and

comprising at least

1) contacting cellulose with a carboxylic acid having 2 to 7 carbon atoms and maintaining the system at 20° C. to 100° C. (pretreatment process);

2) acylating the cellulose obtained after the pretreatment process, with an acylating agent in the presence of a sulfuric acid catalyst (acylation process); and

3) maintaining the reaction mixture at 30° C. to 100° C. for at least 1 hour in a state where base is present in a stoichiometric excess with respect to sulfate moiety (post-heating process), the post-heating process being carried out in any step between after the acylation process and before re-precipitation.

[2] The method for production of cellulose acylate according to [1], wherein A in (2) is 0.05 or larger.

[3] The method for production of cellulose acylate according to [1] or [2], wherein the acylation process satisfies the requirement of (B) below:

(B): 0<(MA/MB)≦2.0

wherein MA represents the total molar amount of the acetyl group contained in the reaction mixture for the acylation process, and MB represents the total molar amount of an acyl group having 3 to 7 carbon atoms contained in the reaction mixture for the acylation process.

[4] The method for production of cellulose acylate according to any one of [1] to [3], which produces a cellulose acylate having a propionyl group or a butyryl group as the acyl group having 3 to 7 carbon atoms.

[5] The method for production of cellulose acylate according to any one of [1] to [4], wherein the cellulose and the carboxylic acid having 2 to 7 carbon atoms are contacted with each other and maintained at 40° C. to 100° C. in the pretreatment process.

[6] The method for production of cellulose acylate according to any one of [1] to [5], wherein the maximum temperature reached during acylation is controlled to be 30° C. or lower in the acylation process.

[7] The method for production of cellulose acylate according to any one of [1] to [6], wherein the amount of base in the post-heating process is 1.2 equivalent to 50 equivalent with respect to sulfate moiety.

[8] The method for production of cellulose acylate according to any one of [1] to [7], wherein the base used in the post-heating process is the carbonate, organic acid salt, phosphate, hydroxide or oxide of at least one selected from the group consisting of ammonium, alkali metals, Group 2 metals and Group 13 elements.

[9] The method for production of cellulose acylate according to any one of [1] to [8], wherein the reaction mixture is maintained at 40° C. to 100° C. in the post-heating process.

[10] The method for production of cellulose acylate according to any one of [1] to [8], wherein the reaction mixture is maintained at 30° C. to 100° C. for 2 hours to 100 hours in the post-heating process.

[11] The method for production of cellulose acylate according to any one of [1] to [10], comprising washing cellulose acylate at 40° C. to 95° C. for 1 hour to 100 hours.

[12] Cellulose acylate produced by the method for production according to any one of [1] to [11].

[13] A cellulose acylate solution satisfying the requirements of (1) to (3) below, and containing a cellulose acylate having an amount of residual sulfate moiety such that 50 ppm<S<500 ppm, wherein S is the content of sulfur atoms of the residual sulfate moiety:

(1): 2.5≦A+B≦3

(2): 0≦A≦2.5

(3): 0.3≦B≦3

wherein A represents the substitution degree of an acetyl group, and B represents the sum of the substitution degrees of an acyl group having 3 to 7 carbon atoms.

[14] The cellulose acylate solution according to [13], wherein the cellulose acylate satisfies the requirements of (4) to (6) below:

(4): 2.5≦A+B≦3

(5): 0.1≦A≦1.7

(6): 0.9≦B≦2.95

wherein A represents the substitution degree of an acetyl group, and B represents the sum of the substitution degrees of an acyl group having 3 to 7 carbon atoms.

[15] The cellulose acylate solution according to [13] or [14], wherein the acyl group having 3 to 7 carbon atoms is a butyryl group.

[16] The cellulose acylate solution according to [13] or [14], wherein the acyl group having 3 to 7 carbon atoms is a propionyl group.

[17] The cellulose acylate solution according to any one of [13] to [16], wherein the amount of residual sulfate moiety is 50 ppm<S<300 ppm, wherein S is the content of sulfur atoms of the residual sulfate moiety.

[18] The cellulose acylate solution according to any one of [13] to [17], wherein the sum M of the amount of residual alkali metal M1 and the amount of residual Group 2 element M2 of the cellulose acylate is 50 ppm<M<1000 ppm.

[19] The cellulose acylate solution according to any one of [13] to [18], wherein the metal/sulfur equivalent ratio obtained from the following Formula (A) involving the amount of residual sulfate moiety S′, S′ being the molar-equivalent amount of the content of sulfur atoms, the molar-equivalent amount of residual alkali metal M1′ and the molar-equivalent amount of residual Group 2 element M2′ of the cellulose acylate, is 0.25 to 3:
Metal/sulfur equivalent ratio={(M1′/2)+M2′}/S′ (A):

[20] The cellulose acylate solution according to any one of [13] to [19], wherein the apparent density of the cellulose acylate is 0.7 to 1.2.

[21] The cellulose acylate solution according to any one of [13] to [20], wherein the weight average degree of polymerization/number average degree of polymerization obtained by gel permeation chromatography of the cellulose acylate is 1.6 to 3.6.

[22] The cellulose acylate solution according to any one of [13] to [21], wherein the cellulose acylate is a cellulose acylate made from cotton linter.

[23] The cellulose acylate solution according to any one of [13] to [21], wherein the cellulose acylate is a cellulose acylate made from softwood pulp or hardwood pulp.

[24] The cellulose acylate solution according to anyone of [13] to [23], wherein the cellulose acylate is a cellulose acylate produced by at least

1) contacting cellulose with a carboxylic acid having 2 to 7 carbon atoms and maintaining the system at 20° C. to 100° C. (pretreatment process);

2) acylating the cellulose obtained after the pretreatment process, with an acylating agent in the presence of a sulfuric acid catalyst (acylation process); and

3) maintaining the reaction mixture at 30° C. to 100° C. for at least 1 hour in a state where base is present in a stoichiometric excess with respect to sulfate moiety (post-heating process), the post-heating process being carried out in any step between after the acylation process and before re-precipitation.

[25] A method for production of cellulose acylate film, comprising forming a film from the cellulose acylate solution according to any one of [13] to [24] by the solution casting method.

[26] A cellulose acylate film formed from the cellulose acylate solution according to any one of [13] to [24] by the solution casting method.

[27] A cellulose acylate film formed by dissolving the cellulose acetate according to [12].

[28] The cellulose acylate film according to [26] or [27], wherein the in-plane retardation (Re) and the retardation of the thickness direction (Rth) satisfy the requirements of (7) to (9) below:

(7): Re≦Rth

(8): 0 nm≦Re≦300 nm

(9): 0 nm≦Rth≦500 nm.

[29] The cellulose acylate film according to any one of [26] to [28], which is stretched 1% to 500% in at least one direction.

[30] A retardation film using the cellulose acylate film according to any one of [26] to [29].

[31] A polarizing plate comprising a polarizing layer and two sheets of protective films having the polarizing layer interposed in between, wherein at least one of the protective films is the cellulose acylate film according to any one of [26] to [29] or the retardation film according to [30].

[32] An optical compensation film having an optically anisotropic layer formed by aligning a liquid crystalline compound on the cellulose acylate film according to any one of [26] to [29] or the retardation film according to [30].

[33] A reflection-preventing film having a reflection-preventing layer on the cellulose acylate film according to any one of [26] to [29] or the retardation film according to [30].

[34] An image display device employing at least one selected from the group consisting of the cellulose acylate film according to any one of [26] to [29], the retardation film according to [30], the polarizing plate according to [31], the optical compensation film according to [32], and the reflection-preventing film according to [33].

### BEST MODE OF CARRYING OUT THE INVENTION

Hereinafter, the present invention will be described in detail. The explanation of the constitutional requirements described below is based on the representative embodiments of the invention, but the invention is not intended to be limited by those embodiments. In addition, the numerical value range expressed with symbol “to” in the present specification implies that the range includes the values described before and after the symbol “to” as the lower limit value and the upper limit value.

<Cellulose Acylate>

(Degree of Acyl Substitution)

The cellulose acylate of the invention has a degree of acyl substitution which satisfies the requirements of (1) to (3) below:

(1): 2.5≦A+B≦3

(2): 0≦A≦2.5

(3): 0.3≦B≦3

wherein A represents the substitution degree of an acetyl group, and B represents the sum of the substitution degrees of an acyl group having 3 to 7 carbon atoms.

The glucose unit constituting the cellulose by means of β-1,4-glycoside bonding has free hydroxyl groups at the 2-position, 3-position and 6-position. The cellulose acylate according to the invention is a polymerization product (polymer) having part or all of these hydroxyl groups esterified with acyl groups. The term “substitution degree” indicates the sum of the ratios at which the cellulose is esterified at the 2-position, 3-position and 6-position of the repeating unit. Specifically, the substitution degree is 1 for the respective cases where the respective hydroxyl groups at the 2-position, 3-position and 6-position of cellulose are 100% esterified. Accordingly, when all of the hydroxyl groups at the 2-position, 3-position and 6-position of cellulose are 100% esterified, the substitution degree is 3 at maximum.

Preferred examples of the acyl group having 3 to 7 carbon atoms which is the subject of the B in (1) to (3) include a propionyl group, a butyryl group, a 2-methylpropionyl group, a pentanoyl group, a 3-methylbutyryl group, a 2-methylbutyryl group, a 2,2-dimethylpropionyl (pivaloyl) group, a hexanoyl group, a 2-methylpentanoyl group, a 3-methylpentanoyl group, a 4-methylpentanoyl group, a 2,2-dimethylbutyryl group, a 2,3-dimethylbutyryl group, a 3,3-dimethylbutyryl group, a cyclopentanecarbonyl group, a heptanoyl group, a cyclohexanecarbonyl group, a benzoyl group and the like. More preferred are a propionyl group, a butyryl group, a pentanoyl group, a hexanoyl group and a benzoyl group, and particularly preferred are a propionyl group and a butyryl group. A cellulose acylate substituted with an acyl group having 8 or more carbon atoms has low production suitability and poor dynamic strength, and the film produced therefrom is susceptible to fracture due to contractile stress in the process of drying by volatilizing the residual solvent from the solution cast film, and thus is undesirable.

The cellulose acylate according to the invention is characterized in satisfying that A+B is 2.5 to 3, as indicated in the above-described (1). A+B is preferably 2.55 to 3, more preferably 2.6 to 2.99, and particularly preferably 2.65 to 2.97.

When A+B is less than 2.5, hydrophilicity of cellulose acylate increases, resulting in increased moisture permeability of the film, and thus it is not desirable.

The cellulose acylate according to the invention is characterized in satisfying that A is 0 to 2.5, as indicated in the above-described (2). A is preferably 0.05 to 2.5, more preferably 0.1 to 1.7, even more preferably 0.1 to 1.6, still more preferably 0.1 to 1.5, and particularly preferably 0.2 to 1.4.

When A is larger than 2.5, the glass transition temperature of the film increases, resulting in lowering of the film drawability, and thus it is not desirable.

The cellulose acylate according to the invention is characterized in satisfying that B is 0.3 to 3, as indicated in the above-described (3). B is preferably 0.9 to 2.95, more preferably 0.9 to 2.85, even more preferably 0.9 to 2.8, and particularly preferably 1.0 to 2.75.

When B is less than 0.3, the glass transition temperature of the film increases, resulting in lowering of the film drawability, and thus it is not desirable.

When the cellulose acylate satisfying the requirements of (1) to (3) and having the amount of residual sulfate moiety in a specific range is used for solvent casting, a cellulose acylate film having small peel-off load and good thermal stability, thus being appropriate as an optical film, can be obtained. Further, the cellulose acylate according to the invention preferably has a degree of acyl substitution satisfying the requirements of (4) to (6) below:

(4): 2.5≦A+B≦3

(5): 0.1≦A≦1.7

(6): 0.9≦B≦2.95

wherein A represents the substitution degree of an acetyl group, and B represents the sum of the substitution degrees of an acyl group having 3 to 7 carbon atoms.

<Method for Production of Cellulose Acylate>

Next, the method for production of cellulose acylate according to the invention will be described in detail. The raw material cotton and the synthesis method for the cellulose acylate according to the invention are described in detail in p. 7 to p. 12 of Technical Report of Japan Institute of Invention and Innovation (Article No. 2001-1745, published on Mar. 15, 2001, Japan Institute of Invention and Innovation).

(Raw Material and Pretreatment)

For the cellulose raw material, materials derived from hardwood pulp, softwood pulp and cotton linter are favorably used. When cotton linter is used, it is easy to peel off the formed film from the support after solution casting in particular, and thus a cellulose acylate film having good properties can be easily obtained. Further, when hardwood pulp or softwood pulp is used, good cellulose acylate films can be produced at low costs. For the cellulose raw material, materials of high purity having an α-cellulose content of 92 wt % to 99.9 wt % are favorably used.

When the cellulose raw material is in a sheet form or in a lump form, the material is preferably broken loose beforehand, and the cellulose is preferably continued to be broken loose until a fluffy state is attained.

(Activation)

The cellulose raw material is preferably subjected to a pretreatment (activation) of being contacted with an activating agent, prior to acylation. Carboxylic acid or water can be used as the activating agent, but when water is used, it is desirable to include a process of dehydrating by adding acid anhydride in excess, or washing with carboxylic acid to purge water, or adjusting the conditions for acylation, after the activation. The activating agent may be added after being adjusted to any temperature, and the method of addition can be selected from methods of spraying, dropping, immersion and the like.

Examples of the carboxylic acid that is preferable as the activating agent are carboxylic acids having 2 to 7 carbon atoms (for example, acetic acid, propionic acid, butyric acid, 2-methylpropionic acid, valeric acid, 3-methylbutyric acid, 2-methylbutyric acid, 2,2-dimethylpropionic acid (pivalic acid), hexanoic acid, 2-methylvaleric acid, 3-methylvaleric acid, 4-methylvaleric acid, 2,2-dimethylbutyric acid, 2,3-dimethylbutyric acid, 3,3-dimethylbutyric acid, cyclopentanecarboxylic acid, heptanoic acid, cyclohexanecarboxylic acid, benzoic acid, etc.), more preferably acetic acid or butyric acid, and particularly preferably acetic acid.

Upon activation, an acylation catalyst such as sulfuric acid can be further added, if necessary. However, when a strong acid such as sulfuric acid is added, depolymerization may be promoted, and thus the amount of addition thereof is preferably limited to about 0.1 wt % to 10 wt % with respect to cellulose. Two or more types of activating agents may be used in combination, or a carboxylic acid anhydride having 2 to 7 carbon atoms may be added.

The amount of the activating agent to be added is preferably 5 wt % or more, more preferably 10 wt % or more, and particularly preferably 30 wt % or more, with respect to cellulose. When the amount of the activating agent is larger than or equal to the lower limit value, it is desirable because there arises no problem such as the extent of cellulose activation being reduced, or the like. The amount of the activating agent to be added is not particularly limited as long as the productivity is not decreased; however, the amount of addition is preferably 100-folds or less by weight, more preferably 20-folds or less, and particularly preferably 10-folds or less, with respect to cellulose. The process of activation may be carried out in a large excess of the activating agent with respect to cellulose, and then the amount of the activating agent may be reduced by carrying out operations such as filtering, blow drying, heat drying, vacuum distillation, solvent substitution or the like.

The temperature for activation is preferably 20° C. to 100° C., more preferably 25° C. to 100° C., even more preferably 40° C. to 100° C., and particularly preferably 40° C. to 80° C. The process of cellulose activation can be carried out under the conditions of overpressure or underpressure. Also, electromagnetic wave such as microwave or infrared ray may be used as a means for heating. The time for activation is preferably 20 minutes or longer, more preferably 1 hour or longer, and particularly preferably 1.5 hours or longer. The upper limit is not particularly limited as long as it is within a range of not affecting the productivity, but the upper limit is preferably 72 hours or less, more preferably 24 hours or less, and particularly preferably 12 hours or less.

(Acylation)

In order to produce cellulose acylate, cellulose is preferably acylated in the presence of catalyst. Specifically, it is preferable to acylate the hydroxyl group of cellulose by adding a carboxylic acid anhydride to cellulose and reacting them in the presence of a Brønsted acid or Lewis acid as the catalyst. For the catalyst, sulfuric acid can be favorably used.

The synthesis of cellulose acylate having large substitution degree at 6-position is described in JP-A-11-5851, JP-A-2002-212338, JP-A-2002-338601 or the like.

For other methods for synthesizing cellulose acylate, mention may be made of a method of reacting cellulose with a carboxylic acid anhydride or a carboxylic acid halide in the presence of base (sodium hydroxide, potassium hydroxide, barium hydroxide, sodium carbonate, pyridine, triethylamine, tert-butoxypotassium, sodium methoxide, sodium ethoxide, etc.), or a method of using a mixed acid anhydride (mixed anhydride of carboxylic acid·trifluoroacetic acid, mixed anhydride of carboxylic acid-methanesulfonic acid, etc.). In particular, the latter method is effective for introducing an acyl group having a large number of carbon atoms, or an acyl group for which acylation by means of carboxylic acid anhydride-acetic acid-sulfuric acid catalysts is difficult.

For the method of obtaining a mixed acylate of cellulose that can be used, mention may be made of a method of mixing or sequentially adding two types of carboxylic acid anhydrides as the acylating agent, and allowing them to react, a method of using a mixed acid anhydride of two types of carboxylic acids (for example, mixed anhydride of acetic acid·butyric acid), a method of using acid anhydrides of a carboxylic acid and a different carboxylic acid (for example, acetic acid anhydride and butyric acid anhydride) as the starting materials to synthesize a mixed acid anhydride (for example, mixed acid anhydride of acetic acid·butyric acid) in the system and reacting the mixed acid anhydride with cellulose, a method of first synthesizing a cellulose acylate having a substitution degree of less than 3, and further acylating the remaining hydroxyl groups of the cellulose acylate using an acid anhydride or acid halide, and the like.

(Acid Anhydride)

The acid anhydride of carboxylic acid is preferably an acid anhydride of a carboxylic acid having 2 to 7 carbon atoms, and examples thereof include anhydrous acetic acid, propionic acid anhydride, butyric acid anhydride, 2-methylpropionic acid anhydride, valeric acid anhydride, 3-methylbutyric acid anhydride, 2-methylbutyric acid anhydride, 2,2-dimethylpropionic acid anhydride (pivalic acid anhydride), hexanoic acid anhydride, 2-methylvaleric acid anhydride, 3-methylvaleric acid anhydride, 4-methylvaleric acid anhydride, 2,2-dimethylbutyric acid anhydride, 2,3-dimethylbutyric acid anhydride, 3,3-dimethylbutyric acid anhydride, cyclopentanecarboxylic acid anhydride, heptanoic acid anhydride, cyclohexanecarboxylic acid anhydride, benzoic acid anhydride and the like. Preferred ones are anhydrous acetic acid, propionic acid anhydride, butyric acid anhydride, valeric acid anhydride, hexanoic acid anhydride, and heptanoic acid anhydride, and particularly preferred ones are anhydrous acetic acid, propionic acid anhydride and butyric acid anhydride.

For the purpose of producing a mixed ester, it is preferable to use these acid anhydrides in combination. The mixing ratio is preferably determined in accordance with the rate of substitution of the target mixed ester. The acid anhydride is usually added in an equivalent excess with respect to the cellulose. That is, the acid anhydride is preferably added in an amount of 1.1 to 50 equivalents, more preferably 1.2 to 30 equivalents, and particularly preferably 1.3 to 10 equivalents, with respect to the hydroxyl group of the cellulose.

(Catalyst)

For the catalyst for acylation used for the production of the cellulose acylate according to the invention, it is desirable to use a Brønsted acid or a Lewis acid. The definitions for the Brønsted acid and the Lewis acid are described in, for example, “Encyclopedia of Physics and Chemistry”, Vol. 5 (2000). Preferred examples of the Brønsted acid include sulfuric acid, perchloric acid, phosphoric acid, methanesulfonic acid, benzenesulfonic acid, p-toluenesulfonic acid and the like. Preferred examples of the Lewis acid include zinc chloride, tin chloride, antimony chloride, magnesium chloride and the like.

For the catalyst, sulfuric acid or perchloric acid is more preferred, and sulfuric acid is particularly preferred. It is also preferable to use sulfuric acid and other catalysts in combination. A preferred amount of addition for the catalyst is 0.1 to 30 wt %, more preferably 1 to 15 wt %, and particularly preferably 3 to 12 wt %, with respect to the cellulose.

(Solvent)

In carrying out the acylation, a solvent may be added for the purpose of adjusting the viscosity, rate of reaction, stirrability, rate of acyl substitution, or the like. For the solvent, dichloromethane, chloroform, carboxylic acid, acetone, ethyl methyl ketone, toluene, dimethylsulfoxide, sulfolane or the like can be used, but preferably used are carboxylic acids. Examples of such carboxylic acid include carboxylic acids having 2 to 7 carbon atoms (for example, acetic acid, propionic acid, butyric acid, 2-methylpropionic acid, valeric acid, 3-methylbutyric acid, 2-methylbutyric acid, 2,2-dimethylpropionic acid (pivalic acid), hexanoic acid, 2-methylvaleric acid, 3-methylvaleric acid, 4-methylvaleric acid, 2,2-dimethylbutyric acid, 2,3-dimethylbutyric acid, 3,3-dimethylbutyric acid, cyclopentanecarboxylic acid) and the like, and more preferably, acetic acid, propionic acid, butyric acid and the like. These solvents may be used in mixtures.

(Conditions for Acylation)

In carrying out the acylation, an acid anhydride, a catalyst, and optionally a solvent may be mixed first, and then cellulose may be mixed with these, or alternatively, the acid anhydride, catalyst and solvent may be separately and sequentially mixed with cellulose. However, it is usually preferable to prepare a mixture of an acid anhydride and a catalyst, or a mixture of an acid anhydride, a catalyst and a solvent, as the acylating agent, and then to react the mixture with cellulose. In order to suppress temperature elevation in the reactor due to the heat of reaction upon acylation, the acylating agent is preferably preliminarily cooled. The cooling temperature is preferably −50° C. to 20° C., more preferably −35° C. to 10° C., and particularly preferably −25° C. to 5° C. The acylating agent may be added in the liquid state, or in the solid state by freezing the agent into a crystal, flake or block form.

The acylating agent may be also added all at once or may be added in portions, to the cellulose. Alternatively, cellulose may be added all at once or may be added in portions, to the acylating agent. When the acylating agent is added in portions, an acylating agent of identical composition may be used, or a plurality of acylating agents of different compositions may be also used. For preferred methods, mention may be made of 1) a method of first adding a mixture of an acid anhydride and a solvent and then adding a catalyst, 2) a method of first adding a mixture of an acid anhydride, a solvent and a portion of a catalyst, and then adding a mixture of the other potion of the catalyst and a solvent, 3) a method of first adding a mixture of an acid anhydride and a solvent, and then a mixture of a catalyst and the solvent, 4) a method of first adding a solvent, and then a mixture of an acid anhydride and a catalyst, or a mixture of an acid anhydride, a catalyst and a solvent, and the like.

The acylation of cellulose is an exothermic reaction, but for the method for production of cellulose acylate according to the invention, it is preferable if the maximum reached temperature during acylation is 50° C. or lower. When the reaction temperature is 50° C. or lower, it is preferable because a situation where depolymerization proceeds, making it difficult to obtain cellulose acylate having degrees of polymerization appropriate for the uses of the invention, or the like does not occur. The maximum reached temperature upon the acylation is preferably 45° C. or lower, more preferably 40° C. or lower, even more preferably 35° C. or lower, and particularly preferably 30° C. or lower. The reaction temperature may be controlled by using a temperature adjusting device, or may be controlled by means of the initial temperature of the acylating agent. The reaction temperature can be also controlled by the heat of vaporization of liquid components in the reaction system, generated by pressure reduction in the reactor. In addition, since the exotherm of the acylation is large at the beginning of the reaction, the temperature can be controlled by cooling the reaction system during the initiation of the reaction and then heating the system, or the like. The termination point of the acylation can be determined by such means as the light permeability, solution viscosity, temperature changes in the reaction system, solubility of the reactants in an organic solvent, observation with a polarized microscope, and the like.

The minimum temperature of the reaction is preferably −50° C. or more, more preferably −30° C. or more, and particularly preferably −20° C. or more. Preferred time for acylation is 0.5 hours to 24 hours, more preferably 1 hour to 12 hours, and particularly preferably 1.5 hours to 6 hours. For 0.5 hours, the reaction does not proceed sufficiently under normal reaction conditions, while the reaction time exceeding 24 hours is not preferable in the aspect of industrial production.

(Acyl Composition)

The degree of acylation preferably satisfies the requirement of (B) below:
0<(MA/MB)≦2.0 (B):
wherein MA represents the total molar amount of the acetyl group contained in the reaction mixture for the acylation process. Specifically, MA is the summed molar amounts of the acetyl group contained as the acylating agent, the acetyl group contained in the carboxylic acid used for the pretreatment process, and the acetyl group contained in the produced cellulose acylate. MB represents the total molar amount of the acyl group having 3 to 7 carbon atoms contained in the reaction mixture for the acylation process. Specifically, MB is the summed molar amounts of the acyl group having 3 to 7 carbon atoms contained in the acylating agent, the acyl group having 3 to 7 carbon atoms contained in the carboxylic acid used for the pretreatment process, and the acyl group having 3 to 7 carbon atoms contained in the produced cellulose acylate.

As such, the total molar amount of the acetyl group and the total molar amount of the acyl group having 3 to 7 carbon atoms are determined by the compositions and amounts of the activating agent, acylating agent (acid anhydride, carboxylic acid) and solvent (carboxylic acid) used in the pretreatment process. According to the invention, the amount of the acyl group of acid anhydride is calculated in terms of the constituting carboxylic acid. That is, it is calculated such that about 1 mole of an acid anhydride is equivalent to 2 moles of an acyl group. Likewise, the number of moles of the acyl group in the produced cellulose acylate is calculated in terms of the carboxylic acid generated when all of the ester bonds are hydrolyzed. Although the amounts of the acid anhydride and carboxylic acid in the reaction mixture constantly change as the acylation of cellulose proceeds, by performing the calculation, the total number of moles of all the acyl groups contained in the acid anhydride, carboxylic acid and produced cellulose acylate in the reaction mixture is constant throughout the process of acylation, as long as no new acid anhydride or carboxylic acid is added to the reaction system.

The acylation process of the invention refers to the period from the initiation of acylation of the hydroxyl groups of cellulose to the point when substantially most of the hydroxyl groups of the cellulose are acylated (for example, the degree of acyl substitution is 2.0 or greater, preferably 2.5 or greater, more preferably 2.8 or greater, and particularly preferably 2.9 or greater), and does not include the phase where the acylation is substantially almost completed, and further addition of acid anhydride or carboxylic acid to the reaction system has virtually no effect on the acyl composition of the product cellulose acylate.

According to the invention, MA/MB is preferably such that 0<(MA/MB)≦2.0, more preferably 0.001≦(MA/MB)≦1.5, even more preferably 0.01≦(MA/MB)≦1.0, and particularly preferably 0.05≦(MA/MB)≦0.7. When MA/MB exceeds 2, the degree of acetyl substitution of the cellulose acylate becomes excessively high, and there may be problems such as deterioration of drawability, increase of the melting temperature for melt casting, resulting in difficult film formation, and the like.

(Reaction Terminating Agent)

According to the method for production of cellulose acylate used in the invention, it is desirable to add a reaction terminating agent after the acylation reaction.

For the reaction terminating agent, any substance capable of decomposing acid anhydrides may be used, and preferred examples thereof include water, alcohol (for example, ethanol, methanol, propanol, isopropyl alcohol, etc.) or compositions containing these, and the like. Further, the reaction terminating agent may contain a neutralizing agent to be described later. Upon addition of the reaction terminating agent, a large exotherm surpassing the cooling capacity of the reactor apparatus is generated, possibly causing a decrease in the degree of polymerization of cellulose acylate, precipitation of cellulose acylate into an undesired form, or the like. Thus, in order to avoid such inconveniences, it is preferable to add a mixture of water and a carboxylic acid such as acetic acid, propionic acid, butyric acid or the like, rather than to directly add water or alcohol, and acetic acid is particularly preferable as the carboxylic acid. The composition ratio of the carboxylic acid and water used may be at any arbitrary ratio, but it is preferable to have the content of water in the range of 5 wt % to 80 wt %, more preferably 10 wt % to 60 wt %, and particularly preferably 15 wt % to 50 wt %.

The reaction terminating agent may be added to the acylation reactor, or the reactants may be added to the vessel of the reaction terminating agent. The reaction terminating agent is preferably added over a time period of 3 minutes to 3 hours. When the time for addition of the reaction terminating agent is longer than 3 minutes, there does not occur a situation where the exotherm becomes excessively large, causing a decrease in the degree of polymerization, insufficient hydrolysis of the acid anhydride, reduced stability of the cellulose acylate, or the like, and thus it is desirable. When the time for addition of the reaction terminating agent is less than or equal to 3 hours, there does not occur a problem such as deterioration of industrial productivity or the like, and it is desirable. The time for addition of the reaction terminating agent is preferably 4 minutes to 2 hours, more preferably 5 minutes to 1 hour, and particularly preferably 10 minutes to 45 minutes. Upon addition of the reaction terminating agent, the reactor may be cooled or not cooled, but for the purpose of inhibiting depolymerization, it is also desirable to inhibit temperature increase by cooling the reactor. It is also preferable to have the reaction terminating agent preliminarily cooled.

(Neutralizing Agent)

During the process of acylation reaction termination or after the process of acylation reaction termination, a neutralizing agent or its solution may be added for the purpose of hydrolysis of the excessive anhydrous carboxylic acid remaining in the system, neutralization of part or all of the carboxylic acid and esterification catalyst, adjustment of the amount of residual sulfate moiety and the amount of residual metal, and the like.

Preferred examples of the neutralizing agent include carbonates, hydrogen carbonates, organic acid salts (for example, acetates, propionates, butyrates, benzoates, phthalates, hydrogen phthalates, citrates, tartrates, etc.), phosphates, hydroxides or oxides of ammonium, organic quaternary ammonium (for example, tetramethylammonium, tetraethylammonium, tetrabutylammonium, diisopropyldiethylammonium, etc.), alkali metals (preferably lithium, sodium, potassium, rubidium, cesium, even more preferably lithium, sodium, potassium, and particularly preferably sodium, potassium), elements of Group 2 (preferably beryllium, calcium, magnesium, strontium, barium, beryllium, calcium, magnesium, and particularly preferably calcium, magnesium), metals of Groups 3 through 12 (for example, iron, chromium, nickel, copper, lead, zinc, molybdenum, niobium, titanium, etc.), or elements of Groups 13 through 15 (for example, aluminum, tin, antimony, etc.), and the like. These neutralizing agents may be used in mixtures, or may form mixed salts (for example, magnesium acetate propionate, potassium sodium tartrate, etc.). When the anion of such neutralizing agent is divalent or higher, the agent may form hydrogen salts (for example, sodium hydrogen carbonate, potassium hydrogen carbonate, sodium dihydrogen phosphate, magnesium hydrogen phosphate, etc.).

More preferred examples of the neutralizing agent include carbonates, hydrogen carbonates, organic acid salts, hydroxides or oxides of ammonium, alkali metals, elements of Group 2, or elements of Group 13, or the like, and particularly preferred examples include carbonate, hydrogen carbonate, acetate or hydroxide of sodium, potassium, magnesium or calcium.

Preferred examples of the solvent for the neutralizing agent include water, alcohols (for example, ethanol, methanol, propanol, isopropyl alcohol, etc.), organic acids (for example, acetic acid, propionic acid, butyric acid, etc.), ketones (for example, acetone, ethyl methyl ketone, etc.), polar solvents such as dimethylsulfoxide, and solvent mixtures thereof.

(Partial Hydrolysis)

The cellulose acylate thus obtained has a degree of acyl substitution of nearly 3, but for the purpose of obtaining a cellulose acylate of desired substitution degree, a process of partially hydrolyzing the ester bonds by maintaining the cellulose acylate at 20 to 90° C. for a few minutes to a few days in the presence of a small amount of catalyst (generally an acylation catalyst such as residual sulfate) and water, in order to reduce the degree of acyl substitution of the cellulose acylate to a desired degree (so-called aging) is usually carried out. The amount of the sulfuric acid ester bound to the cellulose can be reduced in the process of partial hydrolysis by also allowing hydrolysis of the sulfuric acid ester of cellulose, and by adjusting the conditions for hydrolysis.

(Termination of Partial Hydrolysis)

It is preferable to terminate the partial hydrolysis at the time point of obtaining the desired cellulose acylate by completely neutralizing the catalyst remaining in the system using a neutralizing agent or its solution as described above.

When sulfuric acid is used as the catalyst, the amount of the neutralizing agent added to the reaction mixture is preferably an excessive equivalent amount with respect to the sulfate moiety (free sulfuric acid, cellulose-bound sulfuric acid). According to the invention, the neutralizing agent can be added in portions, but it is desirable to add the neutralizing agent after completion of the partial hydrolysis (aging) so that the amount of the neutralizing agent is an excessive equivalent amount with respect to the sulfate moiety. The sulfuric acid bound to the cellulose (cellulose sulfate) is a monovalent acid, but the equivalent of the neutralizing agent is calculated in terms of free sulfuric acid. Thereby, the equivalent of the neutralizing agent can be determined from the amount of the sulfuric acid added. A preferred amount of the neutralizing agent to be added is preferably 1.2 to 50 equivalents, more preferably 1.3 to 20 equivalents, and particularly preferably 1.5 to 10 equivalents, with respect to sulfate moiety.

It is also desirable to effectively remove the catalyst in the solution or bound to the cellulose by adding a neutralizing agent which produces a salt of low solubility to the reaction solution (for example, magnesium carbonate, magnesium acetate, etc.).

(Post-Heating Process)

The reaction mixture after the termination of the partial hydrolysis is preferably further maintained at 30° C. to 100° C. for at least one hour (post-heating process). By carrying out this process, a cellulose acylate having good thermal stability can be obtained by reducing the amount of the sulfuric acid bound to cellulose acylate. As to the reason for the reduction of the amount of the sulfuric acid bound to cellulose acylate, although details have not been clarified, it is believed that heating a cellulose acylate solution in the presence of base in excess leads to gradual de-esterification of the sulfuric acid ester which is more likely to undergo hydrolysis than acyl ester, and free sulfuric acid that is neutralized by the base drives the equilibrium to be lopsided to the production system and thus promotes the reaction.

For the post-heating process, the maintenance temperature is preferably 40° C. to 100° C., more preferably 50° C. to 90° C., and particularly preferably 60° C. to 80° C. When the temperature is less than 30° C., the effect of reducing the amount of bound sulfuric acid is insufficient, while when the temperature exceeds 100° C., the process is difficult in the aspect of operability or stability. Also, for the post-heating process, the time for maintenance is preferably 1 hour to 100 hours, more preferably 2 hours to 100 hours, and particularly preferably 2 hours to 50 hours. When the time is less than 1 hour, the effect of reducing the amount of bound sulfuric acid is insufficient, while when the time exceeds 100 hours, there is a problem in the aspect of industrial productivity. For the post-heating process, the reaction mixture is preferably stirred. Also the neutralizing agent may be further added during the post-heating process.

(Filtration)

It is preferably to carry out filtration of the reaction mixture (dope) for the purpose of removing or reducing the unreacted reactants, sparingly soluble salts and other foreign matters in the cellulose acylate. Filtration may be carried out at any step between the completion of the acylation process and the re-precipitation process, but in general, it is preferably carried out as a step preceding the re-precipitation process. It is also preferable to carry out dilution with an appropriate solvent prior to filtration, for the purpose of controlling the filtration pressure or handlability.

(Re-Precipitation)

The desired cellulose acylate can be obtained by mixing the cellulose acylate solution thus obtained into a poor solvent such as water or an aqueous carboxylic acid solution (for example, acetic acid, propionic acid, butyric acid, etc.), or by mixing a poor solvent into the cellulose acylate solution to re-precipitate the cellulose acylate, and washing and stabilizing the obtained cellulose acylate. The re-precipitation may be carried out continuously or in a batch mode with definite amounts. It is also preferable to control the form or molecular weight distribution of the re-precipitated cellulose acylate by adjusting the concentration of the cellulose acylate solution and the composition of the poor solvent by means of the mode of substitution or degree of polymerization of the cellulose acylate.

Furthermore, for the purpose of improving the purification effect, adjusting the molecular weight distribution or apparent density, or the like, the operation of conducting re-precipitation may be carried out once or several times, as needed, by re-dissolving the once re-precipitated cellulose acylate in a good solvent (for example, acetic acid, acetone, etc.) and subjecting the solution to a poor solvent (for example, water, carboxylic acid (for example, acetic acid, propionic acid, butyric acid), etc.).

(Washing)

The produced cellulose acylate is preferably subjected to washing. The washing solvent may be any one that has low dissolvability for cellulose acylate and is capable of removing impurities, but usually washing water such as water or warm water is used. The temperature of the washing water is preferably 20° C. to 100° C., more preferably 30° C. to 95° C., and particularly preferably 40° C. to 95° C. The temperature during the washing process may be constant or may vary within an arbitrary temperature range; however, the invention preferably comprises washing the cellulose acylate at preferably 40° C. to 95° C., more preferably 50° C. to 95° C., and particularly preferably 60° C. to 90° C., for preferably 1 hour to 100 hours, more preferably 2 hours to 50 hours, and particularly preferably 3 hours to 10 hours. The above-described washing process at 40° C. to 95° C. and another washing process in another temperature range may be combined.

The washing treatment may be carried out in a so-called batch mode where alternation of filtration and washing liquid is repeated, or may be carried out using a continuous washing apparatus. It is preferable to reuse the waste water generated in the re-precipitation and washing processes as the poor solvent for the re-precipitation process, or to recover the solvent such as carboxylic acid by means of distillation or the like and reuse the solvent.

The course of washing may be traced by any means, but preferred examples include methods involving hydrogen ion concentration, ion chromatography, electric conductivity, ICP, elemental analysis, atomic absorption spectrum and the like.

Such treatment allows removal of catalyst (sulfuric acid, perchloric acid, trifluoroacetic acid, p-toluenesulfonic acid, methanesulfonic acid, zinc chloride, etc.), neutralizing agent (for example, carbonate, acetate, hydroxide or oxide of calcium, magnesium, iron, aluminum or zinc, etc.), reaction product between the neutralizing agent and the catalyst, carboxylic acid (acetic acid, propionic acid, butyric acid, etc.), reaction product between the neutralizing agent and carboxylic acid, and the like, and thus is effective in enhancing the stability of the cellulose acylate.

(Stabilization)

It is also preferable to treat the cellulose acylate, after the washing by warm water treatment, with an aqueous solution of weak base (for example, carbonate, hydrogen carbonate, hydroxide, oxide or the like of sodium, potassium, calcium, magnesium, aluminum or the like), in order to further enhance the stability or to reduce the odor of the carboxylic acid.

The amount of residual impurities can be controlled by the metal content in the water used (the amount of metal ions contained in the water used, such as washing water or the like, as trace components), the amount of the washing liquid, the washing temperature, time, agitation method, the form of the washing vessel, or the composition or concentration of the stabilizer. According to the invention, the conditions for the acylation, partial hydrolysis, neutralization and washing are set such that the amount of residual sulfate moiety (in terms of the content of sulfur atoms) is 50 to 500 ppm. The amount of residual alkali metal and the amount of Group 2 element also can be adjusted by the conditions of partial hydrolysis, neutralization and washing.

(Drying)

In order to adjust the water content in the cellulose acylate to a preferred amount in the invention, it is desirable to dry the cellulose acylate. The method of drying is not particularly limited as long as the desired water content can be obtained, but it is preferable to carry out the drying efficiently by using the means such as heating, blow drying, pressure reduction, agitation and the like individually or in combination. The drying temperature is preferably 0 to 200° C., more preferably 40 to 180° C., and particularly preferably 50 to 160° C. The cellulose acylate according to the invention has a water content of preferably 2 wt % or less, more preferably 1 wt % or less, and particularly preferably 0.7 wt % or less.

(Form)

The cellulose acylate according to the invention can be in various forms such as particulate form, powdered form, fiber form, lump form or the like. However, since the particulate form or powdered form is preferable for the raw material for film production, the dried cellulose acylate may be pulverized or sieved for the purpose of uniformizing the particle size or improving the handlability. When the cellulose acylate is in the particulate form, 90 wt % or greater of the particles used preferably have a particle size of 0.5 to 5 mm. Also, 50 wt % or greater of the particles used preferably have a particle size of 1 to 4 mm. The cellulose acylate particles preferably have a shape proximate to the spherical shape as much as possible. Furthermore, the cellulose acylate according to the invention preferably has an apparent density of 0.5 to 1.3, more preferably 0.7 to 1.2, and particularly preferably 0.8 to 1.15. The method for measuring the apparent density is provided in JIS K-7365.

The cellulose acylate according to the invention has an angle of repose of preferably 10 to 70°, more preferably 15 to 60°, and particularly preferably 20 to 50°.

(Degree of Polymerization)

The degree of polymerization of the cellulose acylate preferably used in the invention is, as the average degree of polymerization, preferably 150 to 700, more preferably 180 to 550, even more preferably 200 to 400, and particularly preferably an average degree of polymerization of 200 to 350. The average degree of polymerization can be measured by the intrinsic viscosity method of Uda et al. (Kazuo Uda and Hideo Saito: Journal of the Society of Fiber Science and Technology, Japan, Vol. 18, No. 1, pp. 105-120, 1962), the molecular weight distribution measurement by GPC, or the like. The average degree of polymerization is also described in detail in JP-A-9-95538.

According to the invention, the weight average degree of polymerization/number average degree of polymerization based on the GPC results for cellulose acylate is preferably 1.6 to 3.6, more preferably 1.7 to 3.3, and particularly preferably 1.8 to 3.2.

Next, microscopic foreign matters in the cellulose acylate will be described in detail.

It is difficult to recognize the microscopic foreign matters in the cellulose acylate with naked eyes, and thus the substances are observed by using a polarizing microscope. When a protective film for polarizing plate is produced from a cellulose acylate containing foreign matters and incorporated into an image display device, particularly in the case of black display where lights are all blocked, the cellulose acylate film causes failure due to light leakage.

These microscopic foreign matters have a diameter of from 1 μm to less than 10 μm, and are observed by a polarizing microscope under the cross-nicol conditions. The permitted amount of the microscopic foreign matters in the case of using the cellulose acylate film of the invention as an optical film is preferably 0/mm² to 10/mm², more preferably 0/mm² to 8/mm², and particularly preferably 0/mm² to 5/mm².

These microscopic foreign matters can be removed by filtering the cellulose acylate solution (dope) or the molten product to some extent during the process of film formation, but in order to prevent a slight increase in the filtering pressure and a subsequent increase in the in the exchange frequency for the filtering agent, it is preferable to remove most of the microscopic foreign matters at the step of production of cellulose acylate.

It is possible to reduce the amount of microscopic foreign matters to a large extent by enhancing the reactivity of the raw material cellulose by sufficiently conducting the process of pretreatment (activation) so that unreacted cellulose virtually does not remain behind during the acylation reaction.

The cellulose acylate thus produced can be formed to a cellulose acylate film by the melt casting method or solution casting method described below.

<Melt Casting Method>

(Additives)

In the case of producing a cellulose acylate film according to the melt casting method, only one species of cellulose acylate may be used, or two or more species may be used in combination. Alternatively, a polymer component other than cellulose acylate may be also appropriately mixed. The polymer component to be mixed preferably has excellent compatibility with cellulose acylate, and the permeability of when formed into a film is preferably 80% or greater, more preferably 90% or greater, and particularly preferably 92% or greater.

According to the invention, it is favorable to add plasticizers. Examples of the plasticizer include alkylphthalylalkyl glycolates, phosphoric acid esters, carboxylic acid esters and the like.

Examples of the alkylphthalylalkyl glycolate include methylphthalylmethyl glycolate, ethylphthalylethyl glycolate, propylphthalylpropyl glycolate, butylphthalylbutyl glycolate, octylphthalyloctyl glycolate, methylphthalylethyl glycolate, ethylphthalylmethyl glycolate, ethylphthalylpropyl glycolate, methylphthalylbutyl glycolate, ethylphthalylbutyl glycolate, butylphthalylmethyl glycolate, butylphthalylethyl glycolate, propylphthalylbutyl glycolate, butylphthalylpropyl glycolate, methylphthalyloctyl glycolate, ethylphthalyloctyl glycolate, octylphthalylmethyl glycolate, octylphthalylethyl glycolate and the like.

Examples of the phosphoric acid ester include triphenyl phosphate, tricresyl phosphate, phenyl diphenyl phosphate and the like.

Examples of the carboxylic acid ester include phthalic acid esters such as dimethyl phthalate, diethyl phthalate, dibutyl phthalate, dioctyl phthalate and diethylhexyl phthalate, and citric acid ester such as acetyltrimethyl citrate, acetyltriethyl citrate, acetyltributyl citrate and the like. In addition to these, it is also favorable to use butyl oleate, methylacetyl linolate, dibutyl sebacate, triacetin and the like individually or in combination.

The amount of these plasticizers is preferably 0 wt % to 15 wt %, more preferably 0 wt % to 10 wt %, and particularly preferably 0 wt % to 8 wt %, with respect to the cellulose acylate film. These plasticizers may be used in combination of two or more species, if necessary.

In addition to the plasticizer, various additives (for example, ultraviolet blocking agent, deterioration preventing agent, optical anisotropy controlling agent, microparticles, infrared absorbent, surfactant, odor trapping agent (amines, etc.), etc.) may be also added. For the infrared absorbing dye, for example, those described in JP-A-2001-194522 can be used, for the ultraviolet absorbing dye, for example, those described in JP-A-2001-151901 can be used, and the respective dyes are preferably contained in an amount of 0.001 to 5 wt % with respect to the cellulose acylate. Microparticles that can be used preferably have an average particle size of 5 to 3000 nm, and may be formed from metal oxides or crosslinked polymers. The microparticles are preferably contained in an amount of 0.001 to 5 wt % with respect to the cellulose acylate. The deterioration preventing agent is preferably contained in an amount of 0.0001 to 2 wt % with respect to the cellulose acylate. The optical anisotropy controlling agent that can be used may be exemplified by those described in JP-A-2003-66230 and JP-A-2002-49128, and is preferably contained in an amount of 0.1 to 15 wt % with respect to the cellulose acylate.

(Specific Procedure of Melt Casting Method)

Hereinafter, the specific procedure of the melt casting method will be described.

[1] Drying

It is desirable to use pelletized cellulose acylate as the raw material for the formation of cellulose acylate film. Thus, prior to melt casting, the water content in the pellet is adjusted to 1% or less, more preferably 0.5% or less, and then the pellet is charged into the hopper of a melt extruder. Here, the hopper temperature is preferably set to from (Tg−50° C.) to (Tg+30° C.), more preferably from (Tg−40° C.) to (Tg+10° C.), and particularly preferably from (Tg−30° C.) to Tg, of the cellulose acylate. Hereby, the re-adsorption of moisture in the hopper is suppressed, and the drying efficiency can be manifested more easily.

[2] Kneading Extrusion

Kneading extrusion is preferably carried out at 120° C. to 250° C., more preferably at 140° C. to 220° C., and particularly preferably at 150° C. to 200° C. Here, the melting temperature may be a constant temperature, or may be controlled in several parts. Preferred kneading time is 2 minutes to 60 minutes, more preferably 3 minutes to 40 minutes, and particularly preferably 4 minutes to 30 minutes. Moreover, it is preferable to carry out the process while maintaining the inside of the melt extruder under an inert gas (nitrogen, etc.) stream, or while evacuating with a vented extruder.

[3] Film Formation

The molten resin is subjected to removal of the pulsation of the extruder through a gear pump, subsequently filtered with a metal mesh filter or the like, and then extruded in a sheet form from a T-die installed subsequent to the filter onto a cooling drum. Extrusion may be conducted in a single layer, or alternatively, a multilayer may be extruded through a multi-manifold die or a feed-block die. Here, the thickness irregularity in the width direction can be adjusted by adjusting the interval of the die lips.

Thereafter, the resin is extruded onto a casting drum. Here, it is preferable to enhance the adhesion between the casting drum and the melt extruded sheet by using an electrostatic charging method, an air knife method, an air chamber method, a vacuum nozzle method, a touch roll method, or the like. This adhesion enhancement may be carried out on the entire surface or on a portion of the melt extruded sheet.

The casting drum is preferably at 60° C. to 160° C., more preferably at 70° C. to 150° C., and particularly preferably at 80° C. to 150° C. Subsequently, the sheet is peeled off from the casting drum, passed over a nip roll and taken up by winding. The winding speed is preferably 10 m/min, to 100 m/min, more preferably 15 m/min to 80 m/min, and particularly preferably 20 m/min to 70 m/min.

The width of the produced film is preferably 1 m to 5 m, more preferably 1.2 m to 4 m, and particularly preferably 1.3 m to 3 m. The thickness of the unstretched film thus obtained is preferably 30 μm to 400 μm, more preferably 40 μm to 300 μm, and particularly preferably 50 μm to 200 μm.

The sheet thus obtained is preferably trimmed at both edges before winding. The trimmed parts may be reused as the raw material for films of the same species or as the raw material for films of different species, after being subjected to pulverization, or after being subjected to granulation, or depolymerization and repolymerization, if necessary. Furthermore, it is also desirable to attach a laminate film on at least one side of the sheet from the viewpoint of preventing damages.

<Cellulose Acylate Solution>

Next, the cellulose acylate solution used for the production of a cellulose acylate film by the solvent casting method will be described.

(Amount of Residual Sulfate Moiety)

The cellulose acylate used in the cellulose acylate solution of the invention has an amount of residual sulfate moiety such that 50 ppm<S<500 ppm, wherein S is the content of sulfur atoms of the residual sulfate moiety.

The amount of residual sulfate moiety is more preferably such that 50 ppm<S<300 ppm, even more preferably 50 ppm<S<200 ppm, and particularly preferably 50 ppm<S<100 ppm. Within this range, the peel-off load of the cellulose acylate is small, and the thermal stability is good. When the amount of residual sulfate moiety is 50 ppm or less, the thermal stability becomes good, but the peel-off load increases, thus lower the productivity. On the other hand, when the amount of residual sulfate moiety is 500 ppm or greater, the thermal stability decreases, and especially in the case where the film is subjected to temperature elevation, the resulting optical film is likely to cause inappropriate coloration.

In order to set the amount of residual sulfate moiety within the above-mentioned range, the aforementioned amount can be controlled by appropriately carrying out optimization of the conditions for the acylation or partial hydrolysis (so-called aging) of cellulose, neutralization, warm water treatment, washing and the like.

The specific reason why the peel-off load of cellulose acylate having an amount of residual sulfate moiety of 50 ppm<S<500 ppm is not clear, but it is believed that most of the sulfate moiety are in the state of being bound to the cellulose as sulfate ester. Therefore, it is suspected that the properties of the cellulose acylate dope itself, or the hydrogen bonding or hydrophobic interaction between the dope and the support are subject to change, being manifested as the effect of reducing the peel-off load.

Moreover, the cellulose acylate having an amount of residual sulfate moiety of 50 ppm<S<500 ppm has good stability. Specific reasons therefor are not clear, but it is believed that when heating is carried out while sulfate moiety in excess are present in the cellulose acylate, oxidation or decomposition of cellulose acylate occurs to result in coloration, and the amount permitted in the production of a solvent cast film corresponds to this range.

The term “residual sulfate moiety” as used herein refers to the sum of the total amounts of the moieties present in the cellulose acylate in the form of free sulfuric acid, salts, esters, complexes and the like, and the amount is defined as the content of sulfur atoms. Thus, for example, 98 g of sulfur is converted to be equivalent to 32 g of sulfur atoms, and the content of sulfur atoms is determined. The content of sulfate moiety can be measured according to ASTM D-817-96.

(Amount of Residual Alkali Metal and Amount of Residual Group 2 Element)

In addition, according to the invention, the sum M of the amount of residual alkali metal M1 and the amount of residual Group 2 element M2 of the cellulose acylate is preferably such that 50 ppm<M<1000 ppm, more preferably 50 ppm<M<700 ppm, and particularly preferably 50 ppm<M<400 ppm. The alkali metal as used herein may exemplified by lithium, sodium, potassium, rubidium, cesium or the like, preferably lithium, sodium or potassium, and more preferably sodium or potassium. The Group 2 element may be exemplified by beryllium, magnesium, calcium, strontium, barium or the like, preferably magnesium, calcium, strontium, and more preferably magnesium or calcium. The presence of these metals can further enhance the effect of improving the thermal stability of the cellulose acylate of the invention by controlling the amount of residual sulfate moiety. The amount and type of the residual metals can be controlled by the amount and type of the compounds added as the neutralizing agent or stabilizer, the metal content in the water used, and the processing treatments.

Such amount of metal in the cellulose acylate can be quantified by analyzing the residues resulting from calcinations of cellulose acylate at high temperature by the methods of ion chromatography, atomic absorption spectrum analysis, ICP analysis, ICP-MS analysis or the like.

(Metal/Sulfur Equivalent Ratio)

The metal/sulfur equivalent ratio represented by the following Formula (A) calculated from the amount of residual sulfate moiety S′ of the cellulose acylate (S being the molar equivalent content of sulfur atoms), the molar equivalent M1′ of residual alkali metal, and the molar equivalent M2′ of residual Group 2 element is preferably 0.25 to 3, more preferably 0.5 to 2.5, and particularly preferably 0.75 to 2.0. When the equivalent ratio of metal/sulfur is 0.25 or greater, the thermal stability of cellulose acylate tends to become good. When the metal/sulfur equivalent ratio is 3 or less, the clouding of the cellulose acylate film or cellulose acylate solution is avoided, and the weather resistance or film formability of the film tends to become good.
Metal/sulfur equivalent ratio={(M1′/2)+M2′}/S′ (A):

(Preparation of Cellulose Acylate Solution)

The cellulose acylate solution of the invention can be prepared by the following process for production. For the solvent according to the process for production, any of the following chlorine-based organic solvents and non-chlorine-based organic solvents can be used, as long as it can dissolve cellulose acylate.

For the above-described chlorine-based organic solvent, preferred ones are dichloromethane or chloroform, and dichloromethane is particularly preferred. Mixing with non-chlorine-based organic solvents, other than chlorine-based organic solvents, is also allowed without any particular limitation. In this case, it is preferable to use at least 50 wt % of the chlorine-based organic solvent such as dichloromethane.

The non-chlorine-based organic solvents will be described in the following. That is, preferred examples of the non-chlorine-based organic solvent include solvents selected from esters, ketones, ethers, alcohols, hydrocarbons and the like, all having 3 to 12 carbon atoms. The esters, ketones and ethers may have cyclic structures. Compounds having two or more of any of the functional groups of the esters, ketones and ethers (i.e., —O—, —CO— and —COO—) also can be used, and the compounds may also have, for example, different functional groups such as alcoholic hydroxyl group. In the case of the solvent having two or more types of functional groups, the number of carbon atoms is favorably within the stipulated range of compounds having any functional groups.

Examples of the esters having 3 to 12 carbon atoms include methyl acetate, ethyl acetate, butyl acetate, methyl formate, ethyl formate, propyl formate and pentyl formate.

Examples of the ketones having 3 to 12 carbon atoms include acetone, methyl ethyl ketone, diethyl ketone, and diisobutyl ketone. Examples of the ethers having 3 to 12 carbon atoms include diisopropyl ether, dimethoxy methane, dimethoxyethane, 1,4-dioxane, 1,3-dioxolane, tetrahydrofuran, anisole and phenetole. Examples of the organic solvent having two or more functional groups include 2-ethoxyethyl acetate, 2-methoxyethanol and 2-butoxyethanol.

The aforementioned alcohols may be straight-chained, branched or cyclic, and among them, saturated aliphatic hydrocarbon-based alcohols are preferred. The hydroxyl group of alcohol may be any of primary to tertiary hydroxyl groups, and examples of the alcohol include methanol, ethanol, propanol, isopropyl alcohol, butanol, iso-butyl alcohol, sec-butyl alcohol, tert-butyl alcohol, pentanol, 2-methyl-2-butanol, hexanol, heptanol, n-octyl alcohol, n-nonyl alcohol and the like. Furthermore, for the alcohol, fluorine-based alcohols also can be used. Examples of the fluorine-based alcohol include 2-fluoroethanol, 2,2,2-trifluoroethanol, 2,2,3,3-tetrafluoro-1-propanol and the like.

Moreover, the aforementioned hydrocarbons may be straight-chained, branched or cyclic. Aromatic hydrocarbons and aliphatic hydrocarbon can be all used. The aliphatic hydrocarbons may be saturated or unsaturated. Examples of the hydrocarbons include cyclohexane, hexane, benzene, toluene and xylene. These alcohols and hydrocarbons may be used individually and in combination of two or more species, without being particularly limited.

Among these solvents, dichloromethane, methyl acetate, acetone, methyl formate, ethyl formate, methyl ethyl ketone, cyclopentanone, cyclohexanone, methyl acetoacetate, methanol, ethanol, propanol, isopropyl alcohol, butanol, iso-butyl alcohol, sec-butyl alcohol, tert-butyl alcohol, pentanol, 2-methyl-2-butanol, hexanol, cyclohexane, and hexane can be appropriately used from the viewpoints of handlability during the production process, cellulose acylate solubility, and remaining of the solvent in the flow cast film.

When the solvent used in the production process for the cellulose acylate solution of the invention includes a chlorine-based organic solvent as the main solvent, preferred combinations thereof may be mentioned as follows.

However, the invention is not limited to these combinations (the numbers in the parentheses as shown below indicate parts by weight).
Dichloromethane/butanol (75.0/25.0)
Dichloromethane/methanol/propanol (81.6/14.8/3.6)
Dichloromethane/methanol/isopropyl alcohol (81.6/14.8/3.6)
Dichloromethane/methanol/butanol (81.6/14.8/3.6)
Dichloromethane/methanol/iso-butyl alcohol (81.6/14.8/3.6)
Dichloromethane/methanol/sec-butyl alcohol (81.6/14.8/3.6)
Dichloromethane/methanol/tert-butyl alcohol (81.6/14.8/3.6)
Dichloromethane/methanol/pentanol (81.6/14.8/3.6)
Dichloromethane/methanol/hexanol (81.6/14.8/3.6)
Dichloromethane/methanol/ethanol/butanol (80/10/5/5)
Dichloromethane/acetone/methanol/isopropyl alcohol (80/10/5/5)
Dichloromethane/methanol/butanol/cyclohexane (80/10/5/5)
Dichloromethane/methyl ethyl ketone/methanol/butanol (80/10/5/5)
Dichloromethane/acetone/methyl ethyl ketone/ethanol/isopropyl alcohol (75/10/5/5/5)
Dichloromethane/cyclopentanone/methanol/isopropyl alcohol (80/7/8/5)
Dichloromethane/methyl acetate/butanol (80/10/10)
Dichloromethane/cyclohexanone/methanol/hexane (80/12/4/4)
Dichloromethane/methyl ethyl ketone/acetone/methanol/butanol (50/20/20/5/5)
Dichloromethane/1,3-dioxolane/methanol/butanol (70/20/5/5)
Dichloromethane/dioxane/acetone/methanol/butanol (60/20/10/5/5)
Dichloromethane/acetone/cyclopentanone/ethanol/iso-butyl alcohol/cyclohexane (73/10/4/5/4/4)
Dichloromethane/acetone/ethyl acetate/ethanol/butanol/hexane (65/10/10/5/5/5)
Dichloromethane/cyclopentanone/ethanol/butanol (78/7/10/5)

Moreover, with regard to the solvent used in the production process for the cellulose acylate solution of the invention, examples of the solvent that can be favorably used in the case of not including chlorine-based organic solvents include mixed solvent of three different non-chlorine-based organic solvents, in which the first solvent is at least one selected from methyl acetate, ethyl acetate, methyl formate, ethyl formate, acetone, dioxolane and dioxane, or mixtures of these; the second solvent is selected from ketones having 3 to 7 carbon atoms or acetoacetic acid esters; and the third solvent include alcohols and hydrocarbons having 1 to 10 carbon atoms. Furthermore, when the first solvent is a mixed liquid of two or more species, the second solvent may not be used.

The first solvent is more preferably methyl acetate, acetone, methyl formate, ethyl formate or mixtures of these. The second solvent is preferably methyl ethyl ketone, cyclopentanone, cyclohexanone or methyl acetylacetic acid, or may be mixtures of these.

The alcohol used as the third solvent may be straight-chained, branched or cyclic, and among those, saturated aliphatic hydrocarbons are preferred. The hydroxyl group of the alcohol may be any of primary to tertiary hydroxyl groups. Examples of the alcohols include methanol, ethanol, propanol, isopropyl alcohol, butanol, iso-butyl alcohol, sec-butyl alcohol, tert-butyl alcohol, pentanol, 2-methyl-2-butanol, hexanol, heptanol, n-octyl alcohol, n-nonyl alcohol and the like. For the aforementioned alcohol, fluorine-based alcohol also can be used. Examples of the fluorine-based alcohol include 2-fluoroethanol, 2,2,2-trifluoroethanol, 2,2,3,3-tetrafluoro-1-propanol and the like.

In addition, the hydrocarbons that can be used as the above-mentioned third solvent may be straight-chained, branched or cyclic. Also, aromatic hydrocarbons and aliphatic hydrocarbons can be all used. The aliphatic hydrocarbons may be saturated or unsaturated. Examples of the hydrocarbons include cyclohexane, hexane, benzene, toluene and xylene. The alcohols and hydrocarbons as the third solvent may be used individually or in combination of two or more species, without being limited.

In addition, the mixed solvent of non-chlorine-based organic solvents containing 1 wt % to 25 wt % of a solvent having a boiling point of 80° C. to 160° C. relative to the total amount of solvent preferably contains 20 to 95 wt % of the first solvent, 2 to 60 wt % of the second solvent, and 5 to 30 wt % of the third solvent, and more preferably 30 to 90 wt % of the first solvent, 3 to 50 wt % of the second solvent, and 3 to 25 wt % of the third solvent. Most preferably, the mixed solvent contains 30 to 90 wt % of the first solvent, 3 to 30 wt % of the second solvent, and 3 to 15 wt % of the third alcohol. Furthermore, when the first solvent is a mixed liquid, and the mixed solvent does not employ the second solvent, the mixed solvent preferably contains 20 to 90 wt % of the first solvent and 5 to 30 wt % of the third solvent, and more preferably 30 to 86 wt % of the first solvent and 7 to 25 wt % of the third solvent.

The non-chlorine-based organic solvents used in the invention are described in more detail in p. 12 to p. 16 of the Technical Report of Japan Institute of Invention and Innovation (Article No. 2001-1745, published on Mar. 15, 2001, Japan Institute of Invention and Innovation).

Preferred combinations of the non-chlorine-based organic solvents containing 1 wt % to 12 wt % of a solvent having a boiling point of 80° C. to 160° C. relative to the total amount of solvent, which can be used as the solvent used in the production process for the cellulose acylate solution according to the invention, are as follows. However, the invention is not limited to these (the numbers in the parentheses indicate parts by weight).
Methyl acetate/acetone/methanol/ethanol/butanol (75/10/5/5/5)
Methyl acetate/acetone/methanol/ethanol/isopropyl alcohol (75/10/5/5/5)
Methyl acetate/acetone/ethanol/butanol/cyclohexane (75/10/5/5/5)
Methyl acetate/acetone/ethanol/butanol (81/8/7/4)
Methyl acetate/acetone/ethanol/butanol (82/10/4/4)
Methyl acetate/acetone/ethanol/iso-butyl alcohol (80/10/4/6)
Methyl acetate/methyl ethyl ketone/methanol/butanol (80/10/5/5)
Methyl acetate/acetone/methyl ethyl ketone/ethanol/isopropyl alcohol (75/10/5/5/5)
Methyl acetate/cyclopentanone/methanol/isopropyl alcohol (82/8/6/4)
Methyl acetate/acetone/butanol (85/10/5)
Methyl acetate/cyclopentanone/acetone/ethanol/butanol (68/8/15/5/4)
Methyl acetate/cyclohexanone/methanol/hexane (78/12/5/5)
Methyl acetate/methyl ethyl ketone/acetone/ethanol/butanol (50/20/20/5/5)
Methyl acetate/1,3-dioxolane/ethanol/butanol (70/20/5/5)
Methyl acetate/dioxane/acetone/ethanol/butanol (60/20/10/5/5)
Methyl acetate/acetone/cyclopentanone/ethanol/so-butyl alcohol/cyclohexane (73/10/6/5/3/3)
Methyl formate/methyl ethyl ketone/acetone/ethanol/butanol (50/20/20/5/5)
Methyl formate/acetone/ethyl acetate/ethanol/butanol/hexane (65/10/10/5/5/5)
Acetone/cyclopentanone/ethanol/butanol (78/8/10/4)
Acetone/1,3,-dioxolane/ethanol/butanol (65/20/10/5)
1,3-dioxolane/cyclohexanone/methyl ethyl ketone/ethanol/butanol (70/8/13/5/4)

Furthermore, it is also preferable to further add a part of the solvent after dissolution and to dissolve in multiple stages (the numbers in the parentheses indicate parts by weight).
Prepare a cellulose acylate solution using methyl acetate/acetone/ethanol/butanol (81/8/7/4), filter, concentrate, and then further add 2 parts by weight of butanol
Prepare a cellulose acylate solution using methyl acetate/acetone/ethanol/butanol (84/10/4/2), filter, concentrate and then further add 4 parts by weight of butanol
Prepare a cellulose acylate solution using methyl acetate/acetone/ethanol (84/10/6), filter, concentrate and then further add 5 parts by weight of butanol

The cellulose acylate solution of the invention, in both cases of using chlorine-based organic solvents and non-chlorine-based organic solvents, preferably have 10 to 35 wt %, more preferably 12 to 33 wt %, and most preferably 14 to 30 wt %, of the cellulose acylate dissolved in the organic solvent. The method of achieving this cellulose acylate concentration may be carried out such that a predetermined concentration is reached in the dissolution step, or a low concentration solution (for example, 9 to 14 wt %) is prepared beforehand and then adjusted to a solution of predetermined high concentration by the below-described concentration process. Further, a high concentration cellulose acylate solution may be prepared beforehand and then adjusted to a cellulose acylate solution of predetermined low concentration by adding various additives. With any of these methods, the concentration of the cellulose acylate solution of the invention can be adjusted.

It is also preferable to dry cellulose acylate that has not been formed into film yet or that has been formed into film, prior to the dissolution of the cellulose acylate, to have a water content of 2 wt % or less, and more preferably 1 wt % or less.

It is also preferable to swell the cellulose acylate at 0° C. to 50° C. for 0.1 hour to 100 hours, after mixing the cellulose acylate with the solvent.

According to the invention, it is preferable to use a mixture of a cellulose acylate film that has been solution cast once with cellulose acylate that has not been formed into film. The proportion of the solution cast cellulose acylate contained in the entire cellulose acylate is preferably 1 wt % to 50 wt %, more preferably 2 wt % to 45 wt %, and even more preferably 3 wt % to 40 wt %. The cellulose acylate that has been solution cast once, have crystals generated in the cast film, and some of these crystals remain undissolved even upon re-dissolution and become the crystal seeds to facilitate crystallization during film formation. Thus, the strength of the film can be secure during peeling-off.

The cellulose formed into film may be directly dissolved, or may be dissolved after being pulverized. However, the latter is preferable in view of increasing the dissolution efficiency.

According to the invention, the cellulose acylate may be dissolved at ambient temperature, or may be dissolved by a cooling•heating method. For the cooling heating method, the methods as described in JP-A-11-323017, JP-A-10-67860, JP-A-10-95854, JP-A-10-324774, and JP-A-11-302388 can be used. Thus, a swelled mixture of a solvent and cellulose acylate can be dissolved using a screw-type kneader equipped with a cooling jacket.

Furthermore, the cellulose acylate solution of the invention is preferably concentrated and filtered, and those described in detail in p. 25 of the Technical Report of Japan Institute of Invention and Innovation (Article No. 2001-1745, published on Mar. 15, 2001, Japan Institute of Invention and Innovation) can be used.

(Additives)

Cellulose acylate solution of the present invention can further comprise various additives (for example, a peel-off promoting agent, plasticizer, an ultraviolet absorbent, an infrared absorbent, fine particles, a deterioration inhibitor, an optically anisotropic controlling agent, etc.) for corresponding use of the each preparation procedures. These additives can solid or oily material. Namely, their melting point or boiling point is not specifically limited.

With respect to the present invention, by the addition of peel-off promoting agent, the effect of the present invention can be made more remarkable. The pKa of the peel-off promoting agent of the present invention is preferably 1.0 to 5.0, more preferably 1.5 to 4.5. The substituents of the cellulose acrylate include the substituents such as COOCa or OSO₃Ca of the synthetic process origin. Therefore, it is possible to increase peel-off load by the interaction between Ca of the substituents and the oxygen atom of the support. It is thought that the replacement COOCa with COOH is carried out by the addition of a peel-off promoting agent having the above pKa ranges. In this regard, the interaction between cellulose acylate film and the support can make the peel-off load weak to lower.

With regard to the present invention, the peel-off promoting agents are preferably contained in an amount of 1 ppm to 4000 ppm, more preferably 5 ppm to 3000 ppm, and most preferably 10 ppm to 2500 ppm, relative to cellulose acylate. If the above content is more than 4000 ppm, in the drying procedure of cellulose acylate film, the amount of evaporation of the peel-off promoting agent is increased and became cold. Therefore, peel-off promoting agent which becomes liquid drop is dropped on the film to worsen the surface or the inner system of preparation is contaminated. In this regard, it is not preferable. Further, if the content is less than 1 ppm, the effect of peel-off load almost does not exist, and the productivity is insufficient.

The above peel-off promoting agent is selected from the group consisting of, for example, phosphoric ester, sulphonic ester, and an acid or salt thereof having a pKa (acid dissociation constant) of 1.0 to 5.0. Examples of the above peel-off promoting agent are preferably formic acid, acetic acid, lactic acid, benzoic acid, oxalic acid, malonic acid, succinic acid, glutaric acid, glucolic acid, malic acid, suberic acid, tartartic acid, citric acid, and salts thereof.

For example, the above plasticizer can be use the compounds described in the description of JP-A-2000-352620. Preferably, from the viewpoint of obtaining the effect of reduction of the change of Re and Rth by the humidity, mention may be made of, for example, alkylphthalylalkylglycollates and phosphoric acid ester or a carboxylate ester. For example, for alkyl phthalyl alkyl glycollates, mention may be made of, for example, methyl phthalyl methyl glycollate, ethyl phthalyl ethyl glycollate, propyl phthalyl propyl glycollate, butyl phthalyl butyl glycollate, octyl phthalyl octyl glycollate, methyl phthalyl ethyl glycollate, ethyl phthalyl methyl glycollate, ethyl phthalyl propyl glycollate, methyl phthalyl butyl glycollate, ethyl phthalyl butyl glycollate, butyl phthalyl methyl glycollate, butyl phthalyl ethyl glycollate, propyl phthalyl butyl glycollate, butyl phthalyl propyl glycollate, methyl phthalyl octyl glycollate, ethyl phthalyl octyl glycollate, octyl phthalyl methyl glycollate, octyl phthalyl ethyl glycollate.

For the phosphoric acid ester, mention may be made of, for example, triphenyl phosphate, tricresyl phosphate, and phenyl diphenyl phosphate.

For example, for the carboxylate ester, a dimethyl phthalate, a diethyl phthalate, a dibutyl phthalate, a dioctyl phthalate and phthalic acid esters such as diethyl hexyl phthalates and citric acid esters such as citric acid acetyl trimethyl, citric acid acetyl triethyl, and citric acid acetyl tributyl can be given. Further, other than those as described above, butyl oleate, methylacetyl ricinoleate, dibutyl sebacate, triacetin, etc. may be used singly or as a mixture thereof.

The content of this plasticizer is preferably 0 to 15% by weight, more preferably 0 to 10% by weight, and most preferably 0 to 8% by weight, relative to cellulose acylate. These plasticizers can be used in a mixture of two or more kinds, if necessary.

For example, the above ultraviolet absorbent may be, for example, those described in JP-A-2001-151901. Further, the infrared absorbent may be, for example, those described in JP-A-2001-194522. Each of these is preferably contained in an amount of 0.001 to 5% by weight, relative to cellulose acylate. The above fine particles are preferably ones having an average particle diameter of 5 to 3000 nm. These fine particles may be made of a metal oxide or a crosslinked polymer, which are preferably incorporated in an amount of 0.001 to 5% by weight, relative to cellulose acylate.

Examples of the deterioration inhibitor include an antioxidant, a peroxide decomposer, a radical inhibitor, a metal inactivation agent, an acid capture agent, and amine. And it is desirable that it is contained in an amount of 0.0001 to 2% by weight, relative to cellulose acylate. For example, as to the optical anisotropy controller, those as described JP-A-2003-66230, and JP-A-2002-49128 can be used. And it is desirable that it is contained in an amount of 0.1 to 15% by weight, relative to cellulose acylate.

The time for addition of these additives may be any time during the regulation process of the cellulose acylate solution. However, it is preferable that the additives are added at the end of this preparation process to add the preparation process. Furthermore, amount of addition of each material is not specifically limited if it exhibit functions, for example, they can be added in the above preferable ranges.

<Solution Film Formation>

For the method and the facilities to produce cellulose acylate film of the present invention, a solution casting film formation method and a solution casting film formation apparatus can be used as conventional cellulose triacetate film production. With regard to each manufacturing process, the Technical Report of Japan Institute of Invention and Innovation, Article No. 2001-1745, pp. 25-30 (Mar. 15, 2001) classifies it as casting (including co-casting), metal support, drying, peel-off, drawing, etc.

A concrete embodiment of the present invention is explained below according to a procedure.

(Film Formation Procedure)

The film formation procedure is the procedure that cellulose acylate solution is cast on the support, and solvent in the above cellulose acylate solution is evaporated to form a cellulose acylate film. Specifically, cellulose acylate solution (there is a case to feign “dope” as follows) prepared in a dissolving tank (vessel) is firstly stored in stock tank. And it is filtered and deaerated the foam contained in the dope to produce final preparation. The above dope is fed to a pressure type die through a pressure type metering gear pump that can feed a liquid highly precisely based on the number of rotations), and it is uniformly cast from a casting outlet (slit) of the pressure type die onto a support of an endlessly running casting section. In the casting, one kind cellulose acylate solution for a monolayer may be cast, or two or more kinds of cellulose acylate solutions may be multi-cast simultaneously or successively. In the case of carrying out casting steps for forming two or more layers, the kinds of cellulose acylate, solvents and additives for the respective layers of dopes, and the concentrations thereof may be the same or different.

The temperature of the metal support of the above cast section (the temperature forming a film of metal support) is preferably −50 to 80° C., more preferably −30 to 25° C., and most preferably −20 to 15° C. If the temperature of the support is less than −50° C., the evaporation of the solvent is slow, and thus the rest of cellulose acylate peeled off on the support at the time of the peeled off point is occur. Thus it is not preferable. If the temperature is over 80° C., the surface is deteriorated by the foam due to quickly evaporation of the solvent. In order to keep the temperature of metal support in the above cast section, it can be achieved by introduction of cool gas to a cast section, or cooling apparatus is equipped to the cast section to cool the flow obtaining part (space). At this time, it is noticed that not to attach water is important. And it is preferable to carry out by using a dry gas, etc.

(Peel-Off Process)

The peel-off process of the present invention is a process that cellulose acylate film forming on the support is peeled off from the support.

As to a peel-off process, the point, which a metal support running to endless of cast section is almost round, can be peel-off point. Half-dried cellulose acylate film ((so-called web) is peeled off from the metal support.

With regard to the present invention, the amount of remaining solvent in the film when half-dried cellulose acylate film (web) is peeled off from the metal support is preferably 10% by weight to 250% by weight, more preferably 15% by weight to 230% by weight, and the most preferably 20% by weight to 220% by weight. The amount of remaining solvent herein satisfies the following equation (1).
Amount of remaining solvent=(M−N)×100/N Equation (1):
wherein M is the mass of cellulose acylate film at the time of stretch, N means the mass of the cellulose acylate film after drying at 120° C. for 3 hours.

If the above amount of the remaining solvent is over 250% by weight, the rest of cellulose acylate may be peeled off on the support. Further, in the case where the amount is less than 10% by weight, the gel strength of cellulose acylate is increased, thus it cannot follow a curvature of the support rotating. By this, at the time of conveyance, it falls to the beneath of the support. In this regard, it may be occurs inferiority of conveyance. Further, as previously explain, with regard to peel-off process, from the support kept warm at −50° C. to 80° C., the cellulose acylate film having the amount of the remaining solvent of 10% by weight to 250% by weight is peeled off under the load of 1.0 g/cm to 60 g/cm.

In the same manner, when the cellulose acylate film is peeled off, the organic solvent content having boiling point 80° C. to 160° C. in the remaining solvent of the above cellulose acylate film is preferably 1.5% by weight to 50.0% by weight to the total amount of the remaining solvent.

(Drying Process)

With regard to the present invention, it is preferable to provide a drying process in which cellulose acylate film is dried. For the drying process, for example, both edges of cellulose acylate film which can be obtained by peel-off are clamped by clips, it is fed and dried by a tenter while holding it in the width direction, it is subsequently fed by means of a set of rolls of a dryer, drying is completed, and a predetermined length thereof is wound up by a winder. The combination of the tenter and the roll dryer can be changed according to the intended purpose.

For solution casting film formation which is used as silver halide photosensitive material or electric display, other than solution casting film formation apparatus, application apparatus is mainly added in order to surface processing of film such as substratum, antistatic layer, anti-halation backing layer, protective layer.

The above drying process is not specifically limited. However, from the point of ensure the photoelasticity of the film, the slowly temperature increasing drying where from the state of comprising solvent to slow increasing the temperature of the film is preferable. The retardation film obtained from cellulose acylate film of the present invention is often used with attached to the polarizing layer within the liquid crystal display device. The polarizing layer is often mono axial stretching by immersing an oxo to alcohol (PVA). Since PVA is hydrophilic, accompanying with a change of humidity, extension and contraction are repeated. Therefore, cellulose acylate film affixed together receives the contraction, extension strength. As a result, Re and Rth is changed due to a change of alignment of cellulose acylate molecules. The change of Re and Rt coefficient accompanying this strength can be measured by the photoelasticity. The photoelasticity is preferably 5×10⁻⁷ (cm²/kgf) to 30×10⁻⁷ (cm²/kgf), more preferably 6×10⁻⁷ (cm²/kgf) to 25×10⁻⁷ (cm²/kgf), most preferably 7×10⁻⁷ (cm²/kgf) to 20×10⁻⁷ (cm²/kgf).

The point to achieve this photoelasticity is to raise crystallinity and improve an elastic modulus. Comparing with the cellulose acetate, cellulose acylate of the present invention which has long chain ester has large steric hindrance. In this regard, progressing crystallization is difficult. Therefore, by slow temperature increasing drying, it can be accelerated an increasing of crystallinity. In the conventional process, after cellulose acylate film is peeled off from the support, for example, at the rate of 150° C./min or more, sudden heat is applied. By this effective remaining solvent is evaporated in crystallization. Therefore, to progress crystallization is difficult. For the slow temperature increasing drying, 40° C. to 120° C. of temperature increasing rate is preferably to 4° C./min to 60° C./min, more preferably 6° C./min to 40° C./min, and most preferably 8° C./min to 30° C./min.

This slow temperature increasing drying can be discontinuous temperature increasing by dividing a several temperature increasing zones, or it can be continuous temperature increasing by the production of temperature gradient with the temperature of wind is changed in the inlet and outlet of one drying zone. The latter is more preferable. By this crystallization can be carried out more effectively.

During slow temperature increasing, it is preferable not to stretch. Because of the volume of cellulose acylate is increased during stretching, and free volume is also increased. Therefore the effect of slow temperature increasing is offset.

The cooling method after drying completion and after stretching in the drying process of the present invention is not specifically limited. However, from the point of inhibit of the humidity change of Re and Rth of the film, it is more preferably that the cooling speed after drying completion or after stretching is slow. By the effect of main chain (cellulose skeleton) and acyl side chain which is substituted to cellulose, cellulose acylate reveals optically anisotropic property. Therefore, it is supposed that it is detected as Re and Rth. If the humidity is changed, it is expected that Re and Rth is changed by changing of conformation due to have a free volume of cellulose acylate or changing of state of dielectric vector due to salvation effect. For the above hypothesis, as to an effective method to inhibit the change of Re and Rth due to humidity, the method which can inhibit conformation change is proposed by a gap of molecule (free volume) of cellulose acylate make smaller. For this, it is preferable that cooling speed after drying completion or after stretching is slow. And the cooling speed between from the inlet of drying zone and stretching zone to 50° C. is preferably 2° C./min to 60° C./min, more preferably 3° C./min to 40° C./min, and most preferably 4° C./min to 30° C./min. Commonly it is cooled 100° C./min or more. Therefore, the above condition becomes cooled considerably slow.

Cellulose acylate is constricted accompanying with cooling. However, if it is under a glass transition temperature (Tg), the move ability of cellulose acylate is suddenly decline. Thus, it is thought that humidity change of Re and Rth can be made small by slow cooling described to have small free volume.

The cooling from Tg or more to Tg or less is easily occur after drying, stretching. At this time, it is preferable to slow cooling as described above.

This slow cooling can be carried out by any method. For example, it can be achieved that zone outlet is divided to several, and it is cooled step by step to a room temperature. Further, warm wind is blown to the heat treated zone outlet or it can provide a heat source (for example, infrared heater, halogen heater, panel heater, etc.).

(Wind-Up Process)

With regard to the method of production, after drying in a manner as described above, its both edges are trimmed off. Thereafter, it is subjected to an embossing process (knurling process) and then is wound up around a wind-up roll. The remaining solvent in the film which is finished drying is preferably from 0 to 5%, more preferably from 0 to 2%, even more preferably from 0 to 1% after the drying of cellulose acylate film is finished. The width of the film is preferably from 0.5 to 5 m, more preferably from 0.7 to 3 m, even more preferably from 1 to 2 m. The length of the wound film is preferably from 300 to 30000 m, more preferably from 500 to 10000 m, even more preferably from 1000 to 7000 m.

<Stretching of Cellulose Acylate Film>

In order to develop Re and Rth, it is preferred that cellulose acylate film prepared by a melt film formation method or a solution film formation method is stretched. The stretching may be carried out in a state of non-dried film in the process of film-formation (for example, between the time when peeling-off of the sheet from the casting supporting structure and the time of the completion of drying) or may be carried out after the completion of drying. The stretching may be carried out on-line in the process of film-formation or may be carried out off-line after a cellulose acylate film is wound-up after completion of film-formation.

The above stretching may be carried out at temperature in the range of preferably from Tg to (Tg+50° C.), more preferably from (Tg+1° C.) to (Tg+30° C.), and most preferably from (Tg+2° C.) to (Tg+20° C.). A stretching ratio may be preferably from 1% to 500%, more preferably from 3% to 400%, and most preferably from 5 to 300%. The stretching may be carried out in a single step or multiple steps. The stretching ratio herein used is defined as described below:
Stretch ratio(%)=100×{(length after stretching)−(length before stretching)}/(length before stretching).

Such stretching may be carried out by stretching which is performed in the direction of the length by the use of two or more pairs of nip roles the peripheral speed at the outlet of which is higher (lengthwise stretching), or by stretching which both edges of a film are grasped by a chuck and extended to crosswise direction (the direction perpendicular to lengthwise direction) (crosswise stretching). Generally, in either case, when a stretch ratio is higher, Rth become large. Further, Re can be made large by making a difference between a lengthwise stretching and a crosswise stretching large.

If the ratio of Re and Rth is controlled more freely, in the case of lengthwise stretching, it can be controlled by dividing the ratio of vertical and horizontal and crosswise into between nip rolls. In other words, by making a ratio of vertical and horizontal is lower, Rth/Re ratio can be made higher. In the case of crosswise stretching, it can be controlled by simultaneous stretching of the cross direction and lengthwise direction. On the contrary, by relaxation, it can be controlled. Namely, Rth/Re ratio can be made higher by lengthwise stretching. On the contrary, by relexation a lengthwise direction, Rth/Re ratio can be made lower.

The stretching speeds are preferably from 10%/minute to 10000%/minute, more preferably from 20%/minute to 1000%/minute, and particularly preferably from 30%/minute to 800%/minute.

An angle (θ) which the direction of film-formation (lengthwise direction) forms with a retardation axis of Re of a film is preferably as closer as possible to 0°, +90° or −90°. That is to say, in the case of lengthwise stretching, it is preferably as closer as possible to 0°, more preferably 0±3°, further more preferably 0±2° and particularly preferably 0±1°. In the case of crosswise stretching, it is preferably 90±3° or −90±3°, more preferably 90±2° or −90±2° and particularly preferably 90±1° or −90±1°.

The Re and Rth of cellulose acylate film before and after stretching are preferably satisfied (7) to (9) below.

(7): Re≦Rth

(8): 0 nm≦Re≦300 nm

(9): 0 nm≦Rth≦500 nm

Further, it is more preferable to satisfy (7a) to (9a) below.

(7a): Re×1.1≦Rth

(8a): 10≦Re≦200

(9a): 50≦Rth≦400

Further, it is especially more preferable to satisfy (7b) to (9b) below.

(7b): Re×1.2≦Rth

(8b): 20≦Re≦100

(9b): 80≦Rth≦350

The thickness of cellulose acylate film before and after stretch is preferably from 20 μm to 300 μm, more preferably from 30 μm to 250 μm and particularly preferably from 40 μm to 200 μm. The thickness irregularity of a cellulose acylate film is preferably 0% to 2% for both thickness direction and width direction at non-stretch or after stretch, more preferably 0% to 1.5%, especially preferably 0% to 1%.

In the present invention, Re, Rth indicate the in-plane retardation and the retardation in the direction of the thickness respectively in the wavelength of λ. Re is measured by making light having a wavelength of λ nm incident in the direction of the normal of the film in KOBRA 21ADH (trade name, manufactured by Oji Scientific Instruments). Rth is calculated by KOBRA 21ADH based on the retardation values measured in plural directions, such as the above Re, the retardation value measured by allowing light having a wavelength of λ nm to be incident from a direction inclined at an angle of +40° with the direction of the normal of the film by adopting the slow axis (which is determined by the KOBRA 21ADH) within the surface as a slant axis (rotation axis), and the retardation value measured by allowing light having a wavelength of λ nm to be incident from a direction inclined at an angle of −40° with the direction of the normal of the film by adopting the slow axis within the surface as a slant axis (rotation axis). The wave length of nm in the present specification is using 590 nm unless other specific value is not described. Herein, as the hypothetical value of the average refractive index, the values described in “Polymer Handbook” (JOHN WILEY & SONS, INC) and the values described in the catalogues of various optical films may be used. Unknown average refractive indexes may be determined by an Abbe refractometer. Average refractive indexes of major optical films are described as follows: cellulose acylate (1.48), cycloolefin polymer (1.52), polycarbonate (1.59), polymethyl methacrylate (1.49), and polystyrene (1.59). By inputting the hypothetical value of the average refractive index and the film thickness, KOBRA 21 ADH calculates nx, ny, nz.

The change of Re and Rth indicates that the difference between Re at 10% RH and Rth at 10% RH and Re at 80% RH and Rth at 80% RH is divided by Re at 60% RH and Rth at 60% RH and it indicates as %.

The change of Re and Rth accompanying humidity, it occurs a short time (several hours) and it is reversible change. And it is different from resistance to humidity (the change which occurs in the exposing of high humidity for long time (several weeks or more)).

<Surface Treatment>

A stretched or non-stretched cellulose acylate film may be subjected to a surface treatment, if necessary, in order to achieve strong adhesion between cellulose acylate film and each functional layers (e.g., subbing layer and backing layer). For example, a glow discharge treatment, an ultraviolet ray treatment, a corona discharge treatment, a flame treatment, an acid treatment, and an alkali treatment may be applied. The glow discharge treatment referred to herein may be a treatment with low-temperature plasma (thermal plasma) generated in a low-pressure gas having a pressure of 10⁻³ to 20 Torr (0.13 to 2700 Pa) or preferably with plasma under the atmospheric pressure. A plasma excitation gas is a gas which can be excited to plasma under conditions as described above, and examples thereof include argon, helium, neon, krypton, xenon, nitrogen, carbon dioxide, freons such as tetrafluoromethane, and a mixture thereof.

Details thereof are described in the technical report of Japan Institute of Invention and Innovation (Article No. 2001-1745, published on Mar. 15, 2001, Institute of Invention) pp. 30-32. In the plasma treatment under the atmospheric pressure, to which attention has been paid in recent years, for example, a radiating energy of 20 to 500 kGy is used under a condition of 10 to 1,000 keV, and preferably a radiating energy of 20 to 300 kGy is used under a condition of 30 to 500 keV. Of these treatments, an alkali saponifying treatment is particularly preferable, which treatment is quite effective as the surface treatment for cellulose acylate film.

The alkali saponifying treatment may be conducted by immersing the film into a saponifying solution, or applying a saponifying solution onto the film. In the case of the immersing method, the treatment can be attained by passing the film into a tank wherein an aqueous solution of NaOH, KOH or the like which has a pH of 10 to 14 and is heated to 20 to 80° C., is put for 0.1 to 10 minutes, neutralizing the solution on the film, washing the film, and drying the film.

The application method includes dip coating, curtain coating, extrusion coating, bar coating and type E coating.

As the solvent in the alkali saponifying treatment coating solution, it is preferable to employ a solvent which has an excellent wettability appropriate for applying the saponifying solution to a transparent support and can hold favorable surface conditions without forming any irregularity on the transparent support surface. More specifically speaking, it is preferable to use an alcoholic solvent, and particularly preferably isopropyl alcohol.

It is also possible to employ an aqueous solution of a surfactant as the solvent. As the alkali in the liquid saponifying solution, it is preferable to use an alkali soluble in the above-described solvent and KOH and NaOH are still preferable. It is preferable that the liquid saponifying agent has a pH value of 10 or more, still preferably 12 or more. Concerning the reaction conditions, it is preferable to perform the saponification at room temperature for 1 second to 5 minutes, still preferably for 5 seconds to 5 minutes and particularly preferably for 20 seconds to 3 minutes. After the completion of the alkali saponification reaction, it is preferable to wash with water or wash with acid and then wash with water, the face coated with the liquid saponifying agent. The solution-applying manner saponifying treatment, and the application of an alignment layer, which will be detailed later, may be continuously conducted. In the case, the number of steps can be reduced. These saponifying methods are specifically described in, for example, JP-A-2002-82226 and WO 02/46809.

It is preferable to form an undercoat layer on the film in order to bond the film to a functional layer. This layer may be applied onto the film after the above-mentioned surface treatment is conducted, or without conducting any surface treatment. Details of the undercoat layer are described in the technical report of Japan Institute of Invention and Innovation (Article No. 2001-1745, published on Mar. 15, 2001, Institute of Invention) p. 32.

The surface treatment, and the undercoating step may be integrated, as a final stage, into the film forming process, or may be carried out independently or in the middle of the step of forming the functional layer, which will be detailed just below.

Cellulose acylate film of the present invention can be very suitably used as a retardation film.

<Addition of a Functional Layer>

It is preferable to combine cellulose acylate film produced by the preparation method of the present invention and the retardation film using the same with one or more out of the functional layers details of which are described in the technical report of Japan Institute of Invention and Innovation (Article No. 2001-1745, published on Mar. 15, 2001, Institute of Invention), pp. 32 to 45. Of these functional layers, preferable are addition of a polarizing film (a polarizing plate), an optically compensating layer (an optically compensating sheet for liquid crystal display plate), and a reflection-preventing layer (an anti-reflection film).

(1) Addition of a Light Polarizing Layer (Production of a Polarizing Plate)

The polarizing plate of the present invention comprises polarizing film and two sheet of protective film which support the polarizing film. At least one side of the protective film has a cellulose acylate film or retardation film of the present invention.

[Material to be Used]

At present, a commercially available polarizing film may be generally formed by immersing a drawn polymer into a solution of iodine or a dichroic dye in a bath, thereby causing the iodine or dichroic dye to permeate the binder. As the polarizing film, a coating type light-polarizing film, typical examples of which are manufactured by Optiva Inc., can also be used. The iodine or the dichroic dye in the polarizing film is aligned in the binder, thereby exhibiting polarizing performance. Examples of dichroic dyes include azo series dyes, stilbene series dyes, pyrazolone series dyes, triphenylmethane series dyes, quinoline series dyes, oxazine series dyes, thiazine series dyes and anthraquinone series dyes. Of these dyes, water-soluble dyes are preferred.

The dichroic dyes preferably contain hydrophilic substituent (for example, sulfonic acid, amino and hydroxyl groups). Examples thereof include compounds described in the technical report of Japan Institute of Invention and Innovation, Article No. 2001-1745, p. 58 (published on Mar. 15, 2001).

The binders of polarizing film can be polymers capable of cross-linking by themselves, polymers capable of undergoing cross-linking reaction in the presence of a cross-linking agent, or combinations thereof. Examples of these binders include methacrylate series copolymer, styrene series copolymers, polyolefins, polyvinyl alcohols and modified polyvinyl alcohols, poly(N-methylolacrylamides), polyesters, polyimides, vinyl acetate copolymers, carboxymethyl celluloses, polycarbonates, and the like described in paragraph [0022] of the specification in JP-8-338913. A silane coupling agent can be used as a polymer. These binders preferably include water-soluble polymers (for example, poly(N-methylolacrylamides), carboxymethyl celluloses, gelatin, polyvinyl alcohols and modified polyvinyl alcohols, more preferably gelatin, polyvinyl alcohols and modified polyvinyl alcohols, most preferably polyvinyl alcohols and modified polyvinyl alcohols. It is particularly preferred to use two kinds of polyvinyl alcohols or modified polyvinyl alcohols having different polymerization degrees. Polyvinyl alcohols usable in the invention have a saponification degree in the range of, preferably 70 to 100%, more preferably 80 to 100%. The mass average polymerization degree of the polyvinyl alcohols is preferably from 100 to 5,000. With regard to modified polyvinyl alcohols, it is disclosed in JP-A-8-338913, JP-A-9-152509 and JP-A-9-316127 respectively. Two or more kinds of polyvinyl alcohols or modified polyvinyl alcohols may be used together.

The lower limit of the thickness of the binder is preferably 10 μm. The upper limit of the thickness is preferably as thin as possible from the viewpoint of light leakage from the liquid crystal display device. The thickness is preferably thinner than the thickness (about 30 μm) of polarizing plates commercially available at the present, and is more preferably 25 μm or less, further preferably 20 μm or less.

The binder in the polarizing film may be crosslinked. Therefore a polymer or monomer having a crosslinkable functional group may be incorporated into the binder, or a crosslinkable functional group may be given to the binder polymer itself. The crosslinking may be attained by light, heat, or pH change, so as to make it possible to cause the binder to have a crosslinked structure. Crosslinking agents are described in U.S. Pat. Re-issue No. 23297. A boron compounds (such as boric acid or borax) also may be used as a crosslinking agent. The amount of the crosslinking agent added to the binder is preferably from 0.1 to 20 wt % of the binder. In this case, the alignment of the polarizer and the wet heat resistance of the polarizing film become good.

After the end of the crosslinking reaction, the amount of the crosslinking agent which has not reacted is preferably 1.0 wt % or less, more preferably 0.5 wt % or less. This way makes it possible to improve the weather resistance of the film.

(Drawing of the Polarizing Film)

It is preferable that the light-polarizing film is drawn (drawing process) or is rubbed (rubbing process), and subsequently the film is dyed with iodine or a dichroic dye.

In the case of the drawing process, the draw ratio is preferably from 2.5 to 30.0, more preferably from 3.0 to 10.0. The drawing can be carried out by dry drawing in the air or wet drawing in the state that the film is immersed in water. The draw ratio in the dry drawing is preferably from 2.5 to 5.0, and the draw ratio in the wet drawing is preferably from 3.0 to 10.0. The drawing may be performed in parallel to the MD direction is carried (parallel drawing), or obliquely (oblique drawing). This drawing may be attained by one drawing operation or plural drawing operations. The drawing based on the plural drawing operations makes it possible to draw the film homogeneously even when a high-ratio drawing is performed.

More preferable is oblique drawing wherein the film is drawn at an angle of 10° to 80° oblique to the film-carried direction.

(a) Parallel Drawing Process

Before the film is drawn, the PVA film may be swelled. The swelling degree thereof (the ratio by weight of the film before the swelling to the film after the swelling) is preferably from 1.2 to 2.0. Thereafter, while the film may be continuously carried through guide rollers and so on, the film is drawn in an aqueous medium bath or a dyeing bath wherein a dichroic material is dissolved at a bath temperature of preferably 15 to 50° C., more preferably 17 to 40° C. The drawing can be attained by grasping the film by means of two pairs of nip rollers, the carrying rate of the backward nip rollers being made larger than that of the forward nip rollers. The draw ratio, which is the ratio of the length of the drawn film to that of the film at the initial stage (this being the same hereinafter), is preferably from 1.2 to 3.5, more preferably from 1.5 to 3.0 from the viewpoint of the above-mentioned effects and advantages. Thereafter, the film may be dried at 50 to 90° C. to yield a light-polarizing film.

(b) Oblique Drawing Process

As this process, a method described in JP-A-2002-86554 can be used wherein a tenter projected in an oblique direction is used to perform drawing. Since this drawing is performed in the air, it is necessary to hydrate the film beforehand so as to be made easy to draw. The water content in the film is preferably from 5 to 100%, more preferably from 10 to 100%.

The temperature when the film is drawn is preferably from 40° C. to 90° C., more preferably from 50° C. to 80° C. The humidity is preferably from 50% to 100% RH, more preferably from 70% to 100% RH, further preferably from 80% to 100% RH. The advance speed in the longitudinal direction is preferably 1 m/minute or more, more preferably 3 m/minute or more.

After the end of the drawing, the film is dried preferably at 50° C. to 100° C., more preferably at 60° C. to 90° C., preferably for 0.5 minutes to 10 minutes, and more preferably for 1 to 5 minutes.

The angle of the absorption axis of the thus-obtained polarizing film is preferably from 10° to 80°, more preferably from 30° to 60°, further preferably 40° to 50°.

[Adhesion]

The saponified cellulose acylate film and the polarizing layer prepared by the drawing may be adhered to each other to prepare a polarizing plate. About the direction along which they are adhered to each other, the angle between the direction of the flow casting axis of cellulose acylate film and the draw axis of the polarizing plate is preferably set to 45°.

The adhesive agent for the adhesion is not particularly limited. Examples thereof include PVA series resins (comprising modified PVA which may be modified with an acetoacetyl, sulfonic acid, carboxyl, oxyalkylene or some other group) or an aqueous solution of a boron compound. The PVA-series resins are particularly preferable. The thickness of the adhesive agent layer is preferably from 0.01 to 10 μm, more preferably from 0.05 to 5 μm after the layer is dried.

It is more preferable that the light transmittance of the thus-obtained polarizing plate is higher and the polarization degree thereof is higher. The light transmittance of the polarizing plate to light having a wavelength of 550 nm is preferably from 30 to 50%, more preferably from 35 to 50%, most preferably from 40 to 50%. The polarization degree thereof to light having a wavelength of 550 nm is preferably from 90 to 100%, more preferably from 95 to 100%, most preferably from 99 to 100%.

The thus-obtained polarizing plate is laminated on a λ/4 plate, whereby a circular polarization plate can be produced. In this case, the laminating is preferably carried out to set the angle between the retarded phase axis of the λ/4 plate and the absorption axis of the polarizing plate to 45°. At this time, the λ/4 plate is not particularly limited, and is preferably a λ/4 plate having a wavelength dependency such that the retardation thereof is smaller to a lower wavelength.

It is also preferable to use a λ/4 plate composed of a polarizing film having an absorption axis inclined at an angle of 20° to 70° to the longitudinal direction and an optically anisotropic layer made of a liquid crystal compound.

(2) Addition of an Optically Compensating Layer (Production of an Optically Compensating Sheet for Liquid Crystal Display)

The optically anisotropic layer is a layer for making compensation for a liquid crystal compound in a liquid crystal cell in a liquid crystal display device at the time of black display, and is added by forming an alignment layer on cellulose acylate film and further forming an optically anisotropic layer thereon.

The optically compensate film of the present invention has an optically anisotropy layer which is formed by alignment of a liquid crystal compound on the cellulose acylate film of the present invention or the retardation film of the present invention.

(Alignment Layer)

An alignment layer may be formed on the above-mentioned surface-treated cellulose acylate film. This film has a function of deciding the alignment direction of liquid crystal molecules. However, if a liquid crystal compound is aligned and subsequently the alignment state is fixed, the alignment layer is not necessarily essential as a constituent of the present invention since the alignment layer has fulfilled the function thereof. In other words, only the optically anisotropic layer which is in a fixed alignment state and is formed on the alignment layer is transferred onto a polarizer, whereby the polarizing plate using cellulose acylate film of the present invention can be produced.

The alignment layer can be provided by rubbing an organic compound (preferably a polymer), oblique evaporation of an inorganic compound, forming a layer having a micro group, or accumulation of an organic compound (for example, ω-tricosanoic acid, dioctadecylmethylammonium chloride or methyl stearate) by the Langmuir-Blodgett method (LB film). Furthermore, there have been known alignment films having an alignment function imparted thereto by applying an electrical field, applying a magnetic field or irradiating with light.

It is preferable to form the alignment layer by subjecting a polymer to rubbing treatment. In principle, the polymer used in the alignment layer has a molecular structure having a function of aligning liquid crystal molecules.

In the present invention, it is preferable to not only cause the polymer used in the alignment layer to have the above-mentioned function of aligning liquid crystal molecules, but also introduce, into the main chain of the polymer, a side chain having a crosslinkable functional group (for example, a double bond), or it is preferable to introduce, into a side chain of the polymer, a crosslinkable functional group having a function of aligning liquid crystal molecules.

The polymers used in the alignment film may be polymers capable of cross-linking by themselves, polymers capable of undergoing cross-linking reaction in the presence of a cross-linking agent, or combinations thereof. Examples of polymers usable in the invention include methacrylate series copolymers described in paragraph [0022] of the specification in JP-A-8-338913, styrene series copolymers, polyolefins, polyvinyl alcohols and modified polyvinyl alcohols, poly(N-methylolacrylamides), polyesters, polyimides, vinyl acetate copolymers, carboxymethyl celluloses, polycarbonates. Further, a silane coupling agent can be used as a polymer. Of these polymers, water-soluble polymers (for example, poly(N-methylolacrylamides), carboxymethyl celluloses, gelatin, polyvinyl alcohols or modified polyvinyl alcohols) are preferred. Further, gelatin, polyvinyl alcohols and modified polyvinyl alcohols are more preferably, polyvinyl alcohols and modified polyvinyl alcohols are most preferably. It is particularly preferable to use of two kinds of polyvinyl alcohols or modified polyvinyl alcohols having different polymerization degrees. Polyvinyl alcohols have a saponification degree in the range of, preferably 70 to 100%, more preferably 80 to 100%. The mass average polymerization degree of polyvinyl alcohols is from 100 to 5000.

The side chain having a function of aligning liquid crystal molecules in general has a hydrophobic group as a functional group. The specific kind of the functional group is decided dependently on the kind of the liquid crystal molecules and a required alignment state.

For example, the modifying groups of the modified polyvinyl alcohol can be introduced by copolymerization modification, by chain transfer modification and by block polymerization modification. Examples of the modifying group include a hydrophilic group (e.g., carboxylic group, sulfonic group, phosphonic group, amino group, ammonium group, amido group, thiol group), a hydrocarbon group having 10 to 100 carbon atoms, a fluorine-substituted hydrocarbon group, a thioether group, a polymerizable group (unsaturated polymerizable group, epoxy group, aziridinyl group), and an alkoxysilyl group (trialkoxysilyl, dialkoxysilyl, monoalkoxysilyl). The modified polyvinyl alcohols are, e.g., described in JP-A-2000-155216, paragraphs [0022] to [0145], and JP-A-2002-62426, paragraphs [0018] to [0022].

When a side chain having a crosslinkable functional group is bonded to the main chain of the alignment layer polymer or a crosslinkable functional group is introduced into a side chain thereof having a function of aligning liquid crystal molecules, the alignment layer polymer can be copolymerized with a polyfunctional monomer contained in the optically anisotropic layer. As a result, strong bonding based on covalent bonds is attained between the polyfunctional monomer molecules, between the alignment layer polymer molecules, and between the polyfunctional monomer molecule and the alignment layer polymer molecule. Consequently, the introduction of the crosslinkable functional group into the alignment layer polymer makes it possible to improve the strength of the optically compensating sheet remarkably.

The crosslinkable functional group of the alignment layer polymer preferably contains a polymerizable group in the same manner as the polyfunctional monomer. Specific examples thereof are described in JP-2000-155216, paragraphs [0080] to [0100]. The alignment layer polymer can be crosslinked with a crosslinking agent, separately from the above-mentioned crosslinkable functional group.

Examples of the above crosslinking agent include aldehydes, N-methylol compounds, dioxane derivatives, compounds that works when the carboxylic group is activated, active vinyl compounds, active halogen compounds, isooxazoles and dialdehyde starch. Two or more crosslinking agents may be used in combination. Compounds described in, e.g., JP-A-2002-62426, paragraphs [0023] to [0024] can be used. For the above crosslinking agent, reactive aldehydes are preferred, and glutaraldehyde is particularly preferred.

The amount of the crosslinking agent is in the range of preferably 0.1 to 20% by weight, more preferably 0.5 to 15% by weight based on the amount of the polymer. The amount of non-reacted crosslinking agent remaining in the alignment film is preferably 1.0% by weight or less, more preferably 0.5 wt % or less. The adjustment as described above makes it possible to give a sufficient endurance to the alignment layer without generating any reticulation even if the alignment layer is used in a liquid crystal display device for a long time or is allowed to stand still in high-temperature and high-humidity atmosphere for a long time.

The above alignment layer can be basically formed by coating a solution containing the polymer (the alignment layer forming material) and the cross-linking agent as recited above on a transparent substrate, drying by heating (to cause cross-linking reaction) and rubbing the coating surface. The cross-linking reaction, as mentioned above, may be carried out in an arbitrary stage after coating the solution on the transparent substrate. In the case of using a water-soluble polymer, such as polyvinyl alcohol, as the alignment layer forming material, a mixture of water with an organic solvent having a defoaming action (for example, methanol) is preferably employed as the coating solution. The suitable ratio of water to methanol is preferably from 0:100 to 99:1, more preferably from 0:100 to 91:9, by weight. By this, the generation of foams can be prevented to ensure markedly decreased defects in the alignment layer, and the surface of the optically anisotropic layer.

Examples of a coating method for the alignment layer which can be adopted include a spin coating method, a dip coating method, a curtain coating method, an extrusion coating method, a rod coating method or a roll coating method. Of these methods, the rod coating method is preferred over the others. The suitable thickness of the polymer layer after drying is from 0.1 to 10 μm. The drying by heating can be performed at a temperature of 20° C. to 110° C. In order to form cross-links to a satisfactory extent, the drying temperature is preferably from 60° C. to 110° C., particularly preferably from 80° C. to 100° C. The drying time is generally from 1 minute to 36 hours, preferably from 1 to 30 minutes. Further, it is preferable to adjust the pH to an optimum value for the cross-linking agent used. In the case of using glutaraldehyde as a cross-linking agent, the suitable pH is from 4.5 to 5.5, especially 5.

The alignment layer may be provided on the transparent support or the above undercoating layer. After the above-described polymer layer is crosslinked, the surface of the layer may be subjected to rubbing treatment to form the alignment layer.

The above rubbing treatment can be adopted the treatment methods widely used for aligning liquid crystals of LCD. Namely, the method of rubbing the surface of an alignment layer in a fixed direction by means of paper, gauze, felt, rubber, or nylon or polyester fiber can be employed for alignment. In general, it can be carried out by rubbing several times the polymer surface with cloth into which fibers having the same length and the same diameter are transplanted evenly.

When the rubbing treatment method carries out industrially, it can be achieved by contacting a rotating rubbing roll with a transported film having an alignment layer. The circularity, cylindricality and deflection of the roll itself are preferably all 30 μm or below. The wrap angle of a film with a rubbing roll is from 0.1 to 90°. However, as disclosed in JP-A-8-160430, there is a case that the steady rubbing treatment is effected by winding a film around the roll at an angle of 360° or more. It is preferable that the film is conveyed at a speed of 1 to 100 m/min. Further, it is appropriate to choose the rubbing angle from the range of 0 to 60°. In the case of using a liquid crystal display device, it is preferable to set the rubbing angle from 40 to 50°. In particular, it is advantageous to adjust the rubbing angle to 45°.

The film thickness of the thus-obtained alignment layer is preferably from 0.1 to 10 μm.

Next, liquid crystal molecules of an optically anisotropic layer may be aligned onto the alignment layer. Thereafter, the alignment layer polymer may be caused to react with the polyfunctional monomer contained in the optically anisotropic layer, or a crosslinking agent may be used to crosslink the alignment layer polymer, if necessary.

The liquid crystal molecules used in the optically anisotropic layer may be rod-like liquid crystal molecules or disk-like liquid crystal molecules. The rod-like liquid crystal molecule and the disk-like liquid crystal molecule may each be a high molecular weight liquid crystal or a low molecular weight liquid crystal. Furthermore, a compound about which a low molecular weight liquid crystal is crosslinked to exhibit no liquid crystallinity may be included.

[Rod-Like Liquid Crystal Molecule]

As to the above rod-like liquid crystal compounds, azomethines, azoxy compounds, cyanobiphenyls, cyanophenylesters, benzoic acid esters, cyclohexane carboxylic acid phenylesters, cyanophenylcyclohexanes, cyano-substituted phenylpyrimidines, alkoxy-substituted phenylpyrimidines, phenyldioxanes, tolans, and alkenylcyclohexylbenzonitrils, and the like can be used preferably.

The rod-like liquid crystal molecule may also include a metal complex. A liquid crystal polymer containing, as recurring units thereof, rod-like liquid crystal molecules can also be used as the rod-like liquid crystal molecule. In other words, the rod-like liquid crystal molecule may be bonded to a (liquid crystal) polymer.

Rod-like liquid crystal molecules are described in Quarterly Chemical Review, Vol. 22, “Chemistry of Liquid Crystal” edited by the Chemical Society of Japan (1994), Chapters 4, 7, and 11, and “Liquid Crystal Device Handbook” edited by Japan Society for the Promotion of Science, 142nd Committee, chapter 3.

The birefringence of the rod-like liquid crystal molecules is preferably from 0.001 to 0.7.

The above rod-like liquid crystal molecule preferably has a polymerizable group in order to fix the alignment state thereof. The polymerizable group is preferably a radical polymerizable unsaturated group or a cation polymerizable group. Specific examples thereof include polymerizable groups and polymerizable liquid crystal compounds described in JP-A-2002-62427, paragraphs [0064] to [0086].

(Disk-Like Liquid Crystal Molecule)

Illustrative of the disk-like (discotic) liquid crystal molecule can include benzene derivatives disclosed in a study report of C. Destrade et al., Mol. Cryst., vol. 71, page 111 (1981), truxene derivatives disclosed in a study report of C. Destrade et al., Mol. Cryst., vol. 122, page 141 (1985), and Phyics. Lett., A, vol. 78, page 82 (1990), cyclohexane derivatives disclosed in a study report of B. Kohne et al., Angew. Chem. Soc., vol. 96, page 70 (1984), macrocycles of azacrown series and phenylacetylene series disclosed in a study report of J. M. Lehn et al., J. Chem. Commun. page 1794 (1985), a study report of and J. Zhang et al., and J. Am. Chem. Soc. vol. 116, page 2655 (1994).

The above disk-like liquid crystal molecule may include compounds, which shows liquid crystallization, having a structure in which straight chain groups such as alkyl, alkoxy, and/or substituted benzoyloxy are radially substituted as side chains of a parent core locating at the center of the molecule. The above molecule or a cluster of the molecules is preferably the compound which has rotational symmetry and can give a particular alignment. About the optically anisotropic layer made from the disk-like liquid crystal molecules, it is unnecessary that the compound which is finally contained in the optically anisotropic layer is made of a disk-like liquid crystal molecule. For example, a low molecular weight disk-like liquid crystal molecule having a thermo- or photo-reactive group is polymerized or crosslinked by heat or light to form a polymer that does not behave as liquid crystal. Such polymer can be also used in the invention. Preferred examples of the disk-like liquid crystal molecule are described in JP-A-8-50206. Further, JP-A-8-27284 discloses polymerization of a disk-like liquid crystal molecule.

In order to fix the above disk-like liquid crystal molecule by polymerization, it is necessary to bond a polymerizable group as a substituent to the disk-like core of the disk-like liquid crystal molecule. A compound wherein the disk-like core and the polymerizable group are bonded through a linking group is preferred. By this structure, the alignment state of the compound can be kept in the polymerization reaction. Examples of the compound include compounds described in JP-A-2000-155216, paragraphs [0151] to [0168].

In hybrid alignment, an angle between major axis (disc plane) of disk-like liquid crystal molecule and plane of polarizing film increases or decreases with increase of distance from plane of polarizing film and in the direction of depth from the bottom of the optically anisotropic layer. The above angle preferably decreases with increase of the distance. Further, examples of variation of the angle include continuous increase, continuous decrease, intermittent increase, intermittent decrease, variation containing continuous increase and decrease, and intermittent variation containing increase or decrease. The intermittent variation contains an area where the inclined angle does not vary in the course of the thickness direction of the layer. The angle preferably totally increases or decreases in the layer, even if it does not vary in the course. The angle more preferably increases totally, and it is particularly preferred to increase continuously.

Average direction of major axis of disk-like liquid crystal molecule on the alignment layer side can be generally controlled by selecting the disk-like liquid crystal molecule or materials of the alignment layer, or by selecting methods for the rubbing treatment. The direction of major axis (disc plane) of disk-like liquid crystal molecule on the surface side (air side) can be generally controlled by selecting the disk-like liquid crystal molecule or the kinds of additives used together with the disk-like liquid crystal molecule.

Examples of the additives which are used with disk-like liquid crystal molecule include plasticizer, surface active agent, polymerizable monomer and polymer. Further, the extent of variation of the alignment direction of major axis can be also controlled by the above selection.

(Other Compositions of the Optically Anisotropic Layer)

The use of a plasticizer, a surfactant, a polymerizable monomer and others together with the above liquid crystal molecules makes it possible to improve the uniformity of the coating film to be obtained, the strength of the film, the alignment of the liquid crystal molecules, and others. It is preferable that these are compatible with the liquid crystal molecules and can change the tilt angle of the liquid crystal molecules or do not inhibit the alignment.

The polymerizable monomer may be a radical polymerizable compound or a cation polymerizable compound. And it is preferably a polyfunctional radical polymerizable monomer. More preferably, the polymerizable monomer is a monomer copolymerizable with the above-mentioned liquid crystal compound having the polymerizable group. Examples thereof include monomers described in JP-A-2002-296423, paragraphs [0018] to [0020]. The added amount of the compound is preferably from 1 to 50%, more preferably from 5 to 30 wt % of the disk-like liquid crystal molecules.

The above surfactant may be a conventional compound. A fluorine-containing compound is particularly preferable. Specific examples thereof include compounds described in JP-A-2001-330725, paragraphs [0028] to [0056].

It is preferable that the polymer used together with the disk-like liquid crystal molecules can change the tilt angle of the disk-like liquid crystal molecules.

As an example of these polymers, cellulose ester can be included. Preferable examples of the cellulose ester are described in JP-A-2000-155216, paragraph [0178]. In order not to inhibit the alignment of the liquid crystal molecules, the added amount of the polymer is preferably from 0.1 to 10% by weight, more preferably from 0.1 to 8 wt % of the liquid crystal molecules.

The transition temperature from discotic-nematic liquid-crystal phase to solid phase of the disk-like liquid crystal molecule is preferably in the range of 70 to 300° C., especially more preferably in the range of 70 to 170° C.

[Formation of Optically Anisotropic Layer]

The optically anisotropic layer can be formed by applying a coating solution, which contains the liquid crystal molecule together with the following polymerization initiator or optional components, onto the alignment layer.

As the solvent to be used in preparing the coating solution, it is preferable to use an organic solvent. Examples of the organic solvent include amides (for example, N,N-dimethylformamide), sulfoxides (for example, dimethyl sulfoxide), heterocyclic compounds (for example, pyridine), hydrocarbons (for example, benzene, hexane), alkylhalides (for example, chloroform, dichloromethane and tetrachloroethane), esters (for example, methyl acetate and butyl acetate), ketones (for example, acetone, methyl ethyl ketone), ethers (for example, tetrahydrofuran and 1,2-dimethoxyethane). Alkyl halides and ketones are preferred. It is also possible to use two or more organic solvents together.

The coating solution can be applied by a publicly known method (for example, the wire bar coating method, the extrusion coating method, the direct gravure coating method, the reverse gravure coating method or the die coating method).

The film thickness of the optically anisotropic layer is preferably from 0.1 to 20 μm, more preferably from 0.5 to 15 μm, and most preferably from 1 to 10 μm.

(Holding the Alignment State of a Liquid Crystal Molecule)

The liquid crystal molecule thus aligned can be fixed while holding the alignment state. The fixation is preferably carried out by the polymerization reaction. The polymerization reaction includes a heat polymerization reaction with the use of a heat polymerization initiator and a photopolymerization reaction with the use of a photopolymerization initiator. As the above polymerization reaction, the photopolymerization reaction is preferred.

Examples of the photopolymerization initiator include α-carbonyl compounds (described in U.S. Pat. Nos. 2,367,661 and 2,367,670), acyloin ether (described in U.S. Pat. No. 2,448,828), α-hydrocarbon-substituted acyloin compounds (described in U.S. Pat. No. 2,722,512), polynuclear quinone compounds (described in U.S. Pat. Nos. 3,046,127 and 2,951,758), combinations of a triarylimidazole dimer with p-aminophenyl ketone (described in U.S. Pat. No. 3,549,367), acridine and phenazine compounds (described in JP-A-60-105667 and U.S. Pat. No. 4,239,850) and oxadiazol compounds (described in U.S. Pat. No. 4,212,970).

It is preferable to use the photopolymerization initiator in an amount of from 0.01 to 20% by weight, more preferably from 0.5 to 5% by weight, based on the solid matters in the coating solution.

In the photo-irradiation for polymerizing the liquid crystal molecule, it is preferable to use UV light.

The irradiation energy preferably ranges from 20 mJ/cm² to 50 J/cm², more preferably ranges from 20 mJ/cm² to 5000 mJ/cm², further preferably ranges from 100 mJ/cm² to 800 mJ/cm². To accelerate the photopolymerization reaction, the photoirradiation may be carried out under heating.

A protective layer may be formed on the optically anisotropic layer.

It is also preferable to combine this optically compensating film with a polarizing film. Specifically, a coating solution for forming optically anisotropic layers, as described above, is applied onto the surface of a polarizing film, thereby forming an optically anisotropic layer. As a result, produced is a thin polarizing plate giving only a small stress (strain×sectional area×elastic modulus) with a change in the size of the polarizing film without using any polymer film between the polarizing film and the optically anisotropic layer. By fitting a polarizing plate according to the present invention into a large-sized liquid crystal display device, images having a high display quality can be displayed without causing problems, such as light leakage.

The tilt angle between the polarizing film and the optically compensating layer is preferably adjusted by drawing the layers in such a manner that the angle is matched with the angle between the transmission axis of two polarizing films adhered onto both surfaces of a liquid crystal cell which constitutes a LCD and the lengthwise or lateral direction of the liquid crystal cell. Such an angle is generally 45°, but it is not always 45° in some of the latest transmission, reflection and semi-transmission type LCD modes. Therefore, it is preferable that the drawing direction be optionally adjustable in order to conform to the design of LCD.

(Liquid Crystal Display Device)

Each of liquid crystal modes wherein such an optically compensating film is used is described.

(TN Mode Liquid Crystal Display Device)

The liquid crystal display device of TN mode is widely used in color TFT liquid crystal display device, and hence is described in many publications. The alignment state of the liquid crystal cell in the TN mode at the time of black display is the state that rod-like liquid crystal molecules in the central portion of the cell stand up and the rod-like liquid crystal molecules lie down in portions near substrates of the cells.

OCB Mode Liquid Crystal Display Device:

The liquid crystal display device of OCB mode is a liquid crystal cell of bend alignment mode in which rod-like liquid crystal molecules in upper part and ones in lower part are substantially reversely (symmetrically) aligned. A liquid crystal display device having the liquid crystal cell of bend alignment mode is disclosed in U.S. Pat. Nos. 4,583,825 and 5,410,422. Since rod-like liquid crystal molecules in upper part and ones in lower part are symmetrically aligned, the liquid crystal cell of bend alignment mode has self-optical compensatory function. Therefore, this mode is referred to as OCB (Optically Compensatory Bend) liquid crystal mode.

In the same manner as in the TN mode, in a liquid crystal cell in the OCB mode, the alignment state of the liquid crystal in the cell at the time of black display is the state that rod-like liquid crystal molecules in the central portion of the cell stand up and the molecules lie down in portions near substrates of the cells.

VA Mode Liquid Crystal Display Device:

The VA mode liquid crystal display device is characterized by aligning rod-like liquid crystal molecules in substantially vertically direction. The liquid crystal cell of VA mode include (1) a liquid crystal cell of VA mode in a narrow sense (described in JP-A-2-176625), in which rod-like liquid crystal molecules are substantially vertically aligned while voltage is not applied, and the molecules are substantially horizontally aligned while voltage is applied, (2) a liquid crystal cell (of MVA mode) (described in SID97, Digest of tech. Papers (Digest of tech. Papers), 28 (1997), 845), in which the VA mode is modified to be multi-domain type so as to enlarge the viewing angle; (3) a liquid crystal cell (n-ASM mode) (described in Liquid crystal forum of Japan, Digest of tech. Papers (1998), 58-59), in which rod-like liquid crystal molecules are substantially vertically aligned while voltage is not applied, and the molecules are substantially aligned in twisted multi-domain alignment while voltage is applied; and (4) a liquid crystal cell of SURVIVAL mode (published in LCD international 98).

IPS Mode Liquid Crystal Display Device:

The IPS mode liquid crystal display device is characterized in that when an electric voltage is not applied, in general, rod like liquid crystal molecules are aligned substantially parallel. The alignment of liquid crystal changes with an electric voltage application, thereby allowing switching of modes. Specific devices described in JP-2004-365941, JP-A-2004-12731, JP-A-2004-215620, JP-A-2002-221726, JP-A-2002-55341, JP-A-2003-195333 may be used.

Other Liquid Crystal Display Devices:

Also for the ECB and STN modes, optical compensation can be attained on the basis of the same approach as described above.

(3) Addition of a Reflection-preventing Layer

(Production of Reflection-preventing Film)

A reflection-preventing film of the present invention may have a reflection-preventing layer on a cellulose acylate film of the present invention or a retardation film of the present invention.

A reflection-preventing film generally formed by laying a low refractive index layer, which functions as an antifouling property layer also, and at least one layer having a higher refractive index than the low refractive index layer (i.e., a high refractive index layer, a middle refractive index layer), on a cellulose acylate film of the present invention.

Examples of the method for forming a multilayered film wherein transparent thin films made of inorganic compounds (such as metal oxides) having different refractive indexes are laminated include a chemical vapor deposition (CVD) method, a physical vapor deposition (PVD) method, and a method of forming a metal compound such as metal alkoxide into a film made of colloidal metal oxide particles by a sol-gel method, and subjecting the film to post-treatment (such as ultraviolet radiation described in JP-A-9-157855, or plasma treatment described in JP-A-2002-327310) to form a thin film.

Meanwhile, as reflection-preventing films having a high productivity, suggested are various reflection-preventing films obtained by laminating thin films, each of which is made of inorganic particles dispersed in a matrix, by coating.

Further, as the above reflection-preventing film, a reflection-preventing film, which may be a reflection-preventing film produced by making fine irregularities in the topmost surface of the reflection-preventing film formed by coating as described above to give anti-glare property to the surface, can be given.

Any one of the above-mentioned manners can be applied to cellulose acylate film of the present invention. However, the coating manner (coating type) is particularly preferable.

[Layer Structure of the Coating Type Reflection-Preventing Film]

A reflection-preventing film at least having a layer structure obtained by forming, on a substrate, a middle refractive index layer, a high refractive index layer, and a low refractive index layer (the outermost layer) in this order, is designed to have refractive indexes satisfying the following relationship.

Relationship: The refractive index of the high refractive index layer>the refractive index of the middle refractive index layer>the refractive index of the transparent substrate>the refractive index of the low refractive index layer.

A hard coat layer may be formed between the transparent substrate (cellulose acylate film of the present invention) and the middle refractive index layer. Further the reflection-preventing film may be composed of a middle refractive index hard coat layer, a high refractive index layer, and a low refractive index layer.

With regard the above reflection-preventing film, examples are described in JP-A-8-122504, JP-A-8-110401, JP-A-10-300902, JP-A-2002-243906, and JP-A-2000-111706. And a different function may be given to each of the layers. Examples thereof include a low refractive index layer having antifouling property, and a high refractive index layer having antistatic property (for example, JP-A-10-206603, JP-A-2002-243906, and the like).

The haze of the antireflection film is preferably 5% or less, more preferably 3% or less. The strength of the film is preferably H or harder, further preferably 2H or harder, and most preferably 3H or harder, in terms of the pensile hardness test, according to JIS K5400.

[High Refractive Index Layer and Middle Refractive Index Layer]

The higher refractive index layer (the high refractive index layer and the middle refractive index layer) of the reflection-preventing film is a curable film containing at least inorganic compound superfine particles having a high refractive index and an average particle size of 100 nm or less, and matrix binder.

The high refractive index, inorganic compound superfine particles may be made of an inorganic compound having a refractive index of 1.65 or more, preferably a refractive index of 1.9 or more. Examples of the high refractive index, inorganic compound superfine particles, include oxides of Ti, Zn, Sb, Sn, Zr, Ce, Ta, La, In, and the like, and composite oxides containing these metal atoms.

Examples of the embodiment of such superfine particles to be used, include the particles whose surface is treated with a surface-treating agent (such as a silane coupling agent (JP-A-11-295503, JP-A-11-153703, and JP-A-2000-9908), an anionic compound or an organometallic coupling agent (JP-A-2001-310432), the particles in which a core-shell structure is formed to have high refractive index particles be a core (JP-A-2001-166104), and the particles to be used in combination with a specific dispersing agent (for example, JP-A-11-153703, specification of U.S. Pat. No. 6,210,858, JP-A-2002-2776069, and the like).

The material which forms the matrix binder may be any of thermoplastic resins and thermosetting resins film which is so far known.

Further, the material which forms the matrix binder is preferably at least one composition selected from a composition comprising a polyfunctional compound containing at least two radical polymerizable groups and/or cation polymerizable groups, a composition comprising an organometallic compound containing a hydrolyzable group, and a composition comprising a partial condensate thereof. Examples of the material to be used include compounds described in JP-A-2000-47004, JP-A-2001-315242, JP-A-2001-31871, and JP-A-2001-296401.

Further, a curable film obtained from a metal alkoxide composition and a metal alkoxide compound formed from a hydrolysis condensate of a metal alkoxide is preferably used. For the curable film, examples are described in JP-A-2001-293818 and the like.

The refractive index of the high refractive index layer is preferably in the range of 1.70 to 2.20. The thickness of the high refractive index layer is preferably from 5 nm to 10 μm, more preferably from 10 nm to 1 μm.

The refractive index of the middle refractive index layer is adjusted so as to become a value between the refractive index of the low refractive index layer and the refractive index of the high refractive index layer. The refractive index of the middle refractive index layer is preferably in the range of 1.50 to 1.70.

[Low Refractive Index Layer]

The low refractive index layer is laminated on the high refractive index layer. The low refractive index layer has a refractive index preferably in the range of 1.20 to 1.55, more preferably in the range of 1.30 to 1.50.

The above low refractive-index layer is preferably formed as an outermost layer having scratch resistance and antifouling property. In order to improve the scratch resistance largely, it is effective to give lubricity to the surface. For this, it is possible to use the method of the thin film layer by the introduction of a silicone by conventionally known silicone, or the introduction of fluorine by fluorine-containing compound.

The refractive index of the fluorine-containing compound is preferably 1.35 to 1.50, more preferably 1.36 to 1.47. The preferable fluorine-containing compound is the compound comprising 35 to 80% by weight of fluorine atoms, and comprising crosslinkable or polymerizable functional group.

As the above fluorine-containing compounds described in JP-A-9-222503, paragraphs [0018] to [0026] of the specification, JP-A-11-38202, paragraphs [0019] to [0030] of the specification, JP-A-2001-40284, paragraphs [0027] to [0028] of the specification, JP-A-2000-284102, and the like can be used.

The above silicone compound is preferably a compound which has a polysiloxane structure, and preferably a compound which contains, in the polymer chain thereof, a curable functional group or polymerizable functional group so as to have a crosslinked structure in the film to be formed. Examples thereof include reactive silicones (such as “Silaplane” (manufactured by Chisso Corporation), and polysiloxane containing at both ends thereof silanol groups (described in JP-A-11-258403), and the like.

It is preferable to conduct the crosslinking or polymerizing reaction of the fluorine-containing polymer and/or the siloxane polymer having a crosslinkable or polymerizable group, by radiation of light or heating at the same time of or after applying a coating solution for forming an outermost layer containing a polymerization initiator, a sensitizer, and others.

Further, as to low refractive index layer, preferable is also a sol-gel cured film obtained by curing an organometallic compound, such as a silane coupling agent, and a silane coupling agent which contains a specific fluorine-containing hydrocarbon group, in the presence of a catalyst, by condensation reaction.

Examples of these silane coupling agent include silane compounds which contain a polyfluoroalkyl group, or partially-hydrolyzed condensates (such as those described in JP-A-58-142958, 58-147483, 58-147484, 9-157582 and 11-106704), and silyl compounds which contains a poly(perfluoroalkyl ether) group, which is a long chain group containing fluorine (such as compounds described in JP-A-2000-117902, 2001-48590, and 2002-53804).

It is also preferable that the low refractive index layer is made to contain, as an additive other than the above, a filler (such as silicon dioxide(silica), low refractive index inorganic compound particles having a primary average particle size of 1 to 150 nm made, for example, of fluorine-containing particles (e.g. magnesium fluoride, calcium fluoride, barium fluoride), organic fine particles, as described in JP-A-11-3820, paragraphs [0020] to [0038] of the publication), a silane coupling agent, a lubricant, a surfactant, and the like. In the case that the low refractive index layer is positioned beneath the outermost layer, the low refractive index layer may be formed by a gas phase method (such as a vacuum vapor deposition, a sputtering method, an ion plating method, or a plasma CVD method). The low refractive index layer is preferably formed by a coating method, since the layer can be formed at low costs.

The thickness of the low refractive index layer is preferably from 30 to 200 nm, more preferably from 50 to 150 nm, and most preferably from 60 to 120 nm.

[Hardcoat Layer]

The hardcoat layer can be formed on the surface of a support of cellulose acylate film of the present to provide a sufficient mechanical strength to a reflection-preventing film. Especially hardcoat layer is preferably disposed between the support and the above high refractive index layer.

The hard coat layer is preferably formed by crosslinking reaction or polymerizing reaction of a curable compound through light and/or heat. The curable functional group of curable compound is preferably a photopolymerizable functional group. An organometallic compound which contains a hydrolyzable functional group is preferably an organic alkoxysilyl compound.

Specific examples of these compounds are the same as exemplified as the high refractive index layer.

Specific examples of the composition which constitutes the hard coat layer include compositions described in JP-A-2002-144913 and 2000-9908, and WO 02/46617.

The above high refractive index layer can function as a hard coat layer also. In this case, it is preferable to use the manner described about on the high refractive index layer, to disperse particles finely to be incorporated into the hard coat layer to be formed.

The hard coat layer may contain particles having an average particle size of 0.2 to 10 μm, so as to be caused to function as an anti-glare layer also. The anti-glare layer has an anti-glare function (which will be detailed in the below).

The film thickness of the hard coat layer may be appropriately set according to the application thereof. The film thickness of the hard coat layer is preferably from 0.2 to 10 μm, more preferably from 0.5 to 7 μm.

The strength of the hard coat layer is preferably H or harder, further preferably 2H or harder, and most preferably 3H or harder, in terms of the pensile hardness, according to JIS K5400 test. The hard coat layer is preferably one which is less in an abraded amount in a taber test according to JIS K5400.

[Forward Scattering Layer]

In the case that cellulose acylate film of the present invention is applied to a liquid crystal display device, a forward scattering layer may be fitted to the film in order to improve the field angle of the display device when the angle of visibility is inclined up and down or right and left. It can have both of a hard coat function and a forward scattering function by dispersing fine particles having different refractive indexes in the above hard coat layer.

For example, any of the following structures may be used, which are described in JP-A-11-38208 in which the forward scattering coefficient is specified, in JP-A-2000-199809 in which the relative refractive indexes of a transparent resin and fine-particles are made to fall in the specific ranges, respectively, and in JP-A-2002-107512 in which the haze value is made to be 40% or more.

[Other Layers]

It may be further provided with a primer layer, an anti-static layer, an undercoating layer and a protective layer.

[Coating Methods]

The respective layers of the reflection-preventing film can be formed by application of dip coat, air knife coat, curtain coat, roller coat, wire bar coat, gravure coat, micro gravure coat, and extrusion coat (specification of U.S. Pat. No. 2,681,294) methods.

[Antiglare Function]

The reflection-preventing film may have an antiglare function for scattering light from the outside. The antiglare function can be obtained by making unevenness in a surface of the reflection-preventing film. In the case that the reflection-preventing film has the antiglare function, the haze of the reflection-preventing film is preferably 3 to 30%, more preferably 5 to 20%, and most preferably 7 to 20%.

In order to form irregularities in the surface of the antireflection film, any method capable of forming the irregularities and keeping the resultant surface form sufficiently can be used. Examples of the method include a method of using fine particles in the low refractive index layer to form irregularities in the surface of the film (for example, JP-A-2000-271878, etc), a method of adding a small amount (0.1 to 50% by weight) of relatively large particles (particle size: 0.05 to 2 μm) to the layer (high refractive index layer, middle refractive index layer or hard coat layer) to be formed beneath the low refractive index layer so as to form a surface uneven film, and then forming the low refractive index layer thereon while keeping this surface uneven form (for example, JP-A-2000-281410, JP-A-2000-95893, JP-A-2001-100004, and JP-A-2001-281407), and methods of transferring uneven forms physically onto the surface of a formed topmost layer (antifouling layer) by coating (for example, JP-A-63-278839, JP-A-11-183710 and JP-A-2000-275401 as embossing methods).

From the start of the above liquid crystal display device, image display device can be preferably used at least one selected from the group consisting of cellulose acylate film of the present invention, retardation film of the present invention, the polarizing plate of the present invention, optically compensate film of the present invention, and the reflection-preventing film of the present invention. Accordingly, it can be provide an image display device having excellent optical properties.

<Measurement Method>

Hereinafter, the measurement using the present invention is described.

(1) Measurement of Peel-Off Load

Peel-off load is measured as follows. Cellulose acylate solution was cast onto a stainless plate (SUS plate) kept warm at 15° C. which is the same as that of the support of the film formation, and the solvent was evaporated by the time lapse to form a cellulose acylate film onto a SUS plate. Then, the load can be performed, when the film thus formed was peeled off from a SUS plate at 200 mm/sec, by using of a load cell. At this time, the amount of the remaining solvent of cellulose acylate film was calculated from the mass of the film when the film was peeled off and the mass of the film after the drying at 120° C. for 3 hors. It confirms previously whether the peel-off load in the amount of the remaining solvent of 10% by weight to 250% by weight is in the range of 1.0 g/cm to 60 g/cm.

(2) Measurement of the Amount of Organic Solvent Having a Boiling Point of 80° C. to 160° C. in the Peel-Off Film.

The amount of organic solvent having a boiling point of 80° C. to 160° C. in the peel-off film is measured as follows. Cellulose acylate film peeled from the support is quickly put in a weighing bottle which contains dioxolane, and dissolve cellulose acylate sufficiently. The amount of the solvent in this cellulose acylate solution is quantitative measured by gas chromatography (GC-18A: manufactured by Shimadzu Corporation), and calculate the composition of remaining solvent in the peel-off film. By this the amount of the solvent having a boiling point of 80° C. to 160° C. to the total solvent can be calculated. At this time, it confirms that difference between the amount of the solvent measured and the above value by the mass method is not existed.

(3) Peeled Bunch Stain

The existence and nonexistence of peeled bunch stain is judged as follows. For example one side of a peeled film is painted over without unevenness with black ink equally and from the opposite side of applied side a reflected image of transmitted light is observed visually at divergent angle. By this it can be judged whether a line like stain is observed.

(4) Change of Re and Rth Accompanying with Re, Rth, and Humidity.

Firstly, the 3 points (middle, edges parts (location of both edges of 5% of total width) of width direction is sampling every 10 m long direction at 3 times. Then 9 sheets of sample having a size of 1 cm×1 cm are taken out.

Then the above described sample film was allowed to stand at a temperature of 25° C. and at a relative humidity (RH) of 60% for three hours or above to adjust the moisture in the sample film. The measurement was carried out at a temperature of 25° C. and 60% RH by the use of an automatic double refractometer “KOBRA-21ADH/PR” (trade mark) manufactured by OJI KEISOKUKI Co. Ltd. The retardation (Re) in the inside of the film and the retardation (Rth) in the direction of the thickness of the film are measured. These are assumed as Re (60% RH), Rth (60% RH). In the case, if it is not specifically described, Re, Rth represent the value of Re (60% RH) and Rth (60% RH).

Further, by the use of this sample as it is, the measurement of Re (10% RH) and Rth (10% RH) was carried out at a temperature of 25° C. and 10% RH. Even more particularly, this samples were measured at a temperature of 25° C. and 80% RH, and assumed as Re (80% RH) and Rth (80% RH).

With regard to the sample, the change of the humidity Re, the change of the humidity Rth is calculated according to following equation. And it is calculated by the average of 9 points of measurement degree.
Change of humidity Re(% Relative humidity %)=[100×{absolute value of difference between Re(80% RH) and Re(10% RH)}/Re(60% RH)]/70
Change of humidity Rth(% Relative humidity)=[100×{absolute value of difference between Rth(80% RH) and Rth (10% RH)}/Rth(60% RH)]/70

(5) Photoelasticity Coefficient

(a) Sample having 1 cm width×10 cm long is cut off to a 2 kinds such as long direction is MD direction and TD direction respectively.

(b) This is set to an Ellipsometry measurement device (M−150 made by Japanese Spectrum), and along the long direction (10 cm length), 100 g, 200 g, 300 g, 400 g, 500 g is loaded while Re is measured at a temperature of 25° C. and 60% RH by light of 632.8 nm.

(c) The stress (the value of dividing load by sectional area) is plotted in a horizontal axis, and change of Re(nm) is plotted in a vertical axis. From the inclination, photoelasticity (cm²/kgf) is calculated.

(d) By average a measured value of two kinds of samples, it is assumed as photoelasticity (cm²/kgf).

(6) Substitution Degree of Cellulose Acylate

Acyl substitution degree of cellulose acylate was obtained by ¹³C-NMR according to the method of Tezuka at al., Carbohydr. Res., 273 (1995) 83-91.

(7) Minute Polarizing Contaminants

A sample film after melt film formation or after stretching was observed with a polarizing microscope having crossed polarizers, at a magnification of 100 times. And number of white contaminant of 1 μm to less than 10 μm observed under the microscope was counted visually and shown by number per 1 mm².

(8) Coloration

The coloration of non-stretched film thus obtained is observed visually and result of evaluation is described in Table 2 as 5 steps as follows.

1. No coloration is observed.

2. Slight coloration is observed.

3. Moderate coloration is observed.

4. Considerable coloration is observed.

5. Very considerable coloration is observed.

1 and 2 levels are permitted as an article.

### EXAMPLES

Hereinafter, the present invention will be described in more detail with reference to Examples of a cellulose acylate solution and a cellulose acylate film, but the invention is not limited to these.

[Synthesis of Cellulose Acylate]

### Synthesis Example 1

(Synthesis of Cellulose Acetate Butyrate B-1 to B-4)

250 g of cellulose (hardwood pulp) having 125 g of acetic acid sprayed thereonto was put into a reactor with a reflux apparatus, left to stand for 30 hours while heating to 40° C., and then agitated for 1 hour while heating to 40° C. Cellulose thus pretreated was swollen and grinded and was made to be fluff. The reactor was cooled to cool cellulose to room temperature or less.

Apart from them, a mixture of 221 g of acetic acid, 189 g of acetic anhydride, 1251 g of butyric acid, 1123 g of butyric anhydride and 17.5 g of sulfuric acid as an acylating agent was prepared and cooled to −25° C. and then added all at once to the reactor receiving the cellulose pretreated. After a lapse of 1.5 hours, the temperature of the inside of the reactor was raised to 17° C. and the reaction was continued for six hours. The time when the raw material cellulose was disappeared from the reaction mixture to become a homogeneous solution was regarded as a terminal point of acylation. The molar ratio of total acetyl groups/total butyryl groups in the step of acylation is calculated as 0.333. The reactor was cooled on an iced water bath maintained at 0° C. and to the reactor was added a mixture of 760 g of acetic acid, 1198 g of acetic acid and 219 g of water, which was cooled to about 5° C., over a period of one hour. The temperature of the inside of the reactor was raised to 60° C. and agitation was performed for 4 hours (aging).

Subsequently, a mixed solution of 77 g of magnesium acetate tetrahydrate (2 equivalents with respect to sulfuric acid), 77 g of acetic acid and 77 g of water were added to the reactor (neutralization), and the agitation was carried out at 60° C. for 2 hours. A mixture of acetic acid (20 L of total volume) and water (15 L of total volume) were added to the reactor while gradually increasing the proportion of water to thus precipitate cellulose acetate butyrate. The precipitate of cellulose acetate butyrate thus obtained was sufficiently washed by hot water of 75° C. and after washing, agitated in 0.005% aqueous solution of calcium hydroxide for 0.5 hour, and further washed by water until a cleaning fluid being pH 7 and then vacuum dried at 90° C. to obtain a cellulose acetate butyrate B-1. Apart from them, similarly, a cellulose acetate butyrate B-2 was synthesized by partially adding magnesium acetate in the step of age; a cellulose acetate butyrate B-3 was synthesized by further performing precipitation immediately after neutralization; and a cellulose acetate butyrate B-4 was synthesized by neutralizing, agitating at 60° C. for 30 minutes and further performing precipitation. Any of cellulose acetate butyrates B-1 to B-4 had the acetylation degree of 1.20, the butyration degree of 1.50, and the polymerization degree of 280.

### Synthesis Example 2

(Synthesis of Cellulose Acetate Butyrate B-5)

200 g of cellulose (hardwood pulp) having 100 g of acetic acid sprayed thereonto was put into a reactor with a reflux apparatus, left to stand for 30 hours while heating to 40° C., and then agitated for 1 hour while heating to 40° C. Cellulose thus pretreated was swollen and grinded and was made to be fluff. The reactor was cooled to cool cellulose to room temperature or less.

Apart from them, a mixture of 161 g of acetic acid, 449 g of acetic anhydride, 742 g of butyric acid, 1349 g of butyric anhydride and 14.0 g of sulfuric acid as an acylating agent was prepared and cooled to −25° C. and then added all at once to the reactor receiving the cellulose pretreated. After a lapse of 1.5 hours, the temperature of the outside of the reactor was raised to 17° C. and the reaction was continued for six hours. The time when the raw material cellulose was disappeared from the reaction mixture to become a homogeneous solution was regarded as a terminal point of acylation. The molar ratio of total acetyl groups/total butyryl groups in the step of acylation is calculated as 0.515. The reactor was cooled on an iced water bath maintained at 0° C. and to the reactor was added a mixture of 558 g of acetic acid and 279 g of water, which was cooled to about 5° C., over a period of 1.5 hours. The temperature of the inside of the reactor was raised to 60° C. and agitation was performed for 2.5 hours (aging).

Subsequently, a mixed solution of 61 g of magnesium acetate tetrahydrate (2 equivalents with respect to sulfuric acid), 61 g of acetic acid and 61 g of water were added to the reactor (neutralization), and the agitation was carried out at 60° C. for 2 hours. A mixture of acetic acid (20 L of total volume) and water (15 L of total volume) were added to the reactor while gradually increasing the proportion of water to thus precipitate cellulose acetate butyrate. The precipitate of cellulose acetate butyrate thus obtained was sufficiently washed by hot water of 75° C. and after washing, agitated in 0.005% aqueous solution of calcium hydroxide for 0.5 hour, and further washed by water until a cleaning fluid being pH 7 and then vacuum dried at 90° C. to obtain a cellulose acetate butyrate B-5. The cellulose acetate butyrate B-5 thus obtained had the acetylation degree of 1.51, the butyration degree of 1.19, and the polymerization degree of 280.

### Synthesis Example 3

(Synthesis of Cellulose Acetate Butyrate B-6: Cellulose Acylate Other than the Invention (for Comparison))

200 g of cellulose (hardwood pulp) having 100 g of acetic acid sprayed thereonto was put into a reactor with a reflux apparatus, left to stand for 30 hours while heating to 40° C., and then agitated for 1 hour while heating to 40° C. Cellulose thus pretreated was swollen and grinded and was made to be fluff. The reactor was cooled to cool cellulose to room temperature or less.

Apart from them, a mixture of 161 g of acetic acid, 449 g of acetic anhydride, 742 g of butyric acid, 1349 g of butyric anhydride and 14.0 g of sulfuric acid as an acylating agent was prepared and cooled to −25° C. and then added all at once to the reactor receiving the cellulose pretreated. After a lapse of 1.5 hours, the temperature of the outside of the reactor was raised to 17° C. and the reaction was continued for six hours. The reactor was cooled on an iced water bath maintained at 0° C. and to the reactor was added a mixture of 558 g of acetic acid and 279 g of water, which was cooled to about 5° C., over a period of 1.5 hours.

Subsequently, a mixed solution of 61 g of magnesium acetate tetrahydrate, 61 g of acetic acid and 61 g of water were added to the reactor (neutralization). A mixture of acetic acid (20 L of total volume) and water (15 L of total volume) were added to the reactor while gradually increasing the proportion of water to thus precipitate cellulose acetate butyrate. The precipitate of cellulose acetate butyrate thus obtained was sufficiently washed by hot water of 70° C. and after washing, agitated in 0.005% aqueous solution of calcium hydroxide for 0.5 hour, and further washed by water until a cleaning fluid being pH 7 and then vacuum dried at 80° C. to obtain a cellulose acetate butyrate B-6. The cellulose acetate butyrate B-6 thus obtained had the acetylation degree of 1.73, the butyration degree of 1.23, and the polymerization degree of 320.

### Synthesis Example 4

(Synthesis of Cellulose Acetate Butyrate B-7: Cellulose Acylate Other than the Invention (for Comparison))

100 g of cellulose (hardwood pulp) having 100 g of acetic acid sprayed thereonto was put into a reactor with a reflux apparatus and agitated at 25° C. for 1 hour. Cellulose thus pretreated was swollen and grinded and was made to be fluff. The reactor was put on an iced water bath maintained at 5° C. for one hour to cool cellulose.

Apart from them, a mixture of 875 g of acetic acid, 1058 g of acetic anhydride, 358 g of butyric acid, 410 g of butyric anhydride and 14.0 g of sulfuric acid as an acylating agent was prepared and cooled to −20° C. and then added all at once to the reactor receiving the cellulose pretreated. After a lapse of 1 hour, the temperature of the outside of the reactor was raised to 20° C. and the reaction was continued for 4 hours. The time when the raw material cellulose was disappeared from the reaction mixture to become a homogeneous solution was regarded as a terminal point of acylation. The molar ratio of total acetyl groups/total propionyl groups in the step of acylation is calculated as 3.995. The reactor was cooled on an iced water bath maintained at 5° C. and to the reactor was added a mixture of 1039 g of acetic acid and 346 g of water over a period of 90 minutes. The temperature of the inside of the reactor was raised to 60° C. and agitation was performed for 2 hours. Subsequently, a mixed solution of 61 g of magnesium acetate tetrahydrate (2 equivalents with respect to sulfuric acid), 61 g of acetic acid and 61 g of water were added to the reactor (neutralization). A mixture of acetic acid (10 L of total volume) and water (15 L of total volume) were added to the reactor while gradually increasing the proportion of water to thus precipitate cellulose acetate butyrate. The precipitate of cellulose acetate butyrate thus obtained was sufficiently washed by hot water of 70° C. and after washing, agitated in 0.005% aqueous solution of calcium hydroxide for 0.5 hour, and further washed by water until a cleaning fluid being pH 7. The cellulose acetate butyrate B-7 thus obtained was vacuum dried at 70° C. The cellulose acetate butyrate B-7 had the acetylation degree of 2.61, the butyration degree of 0.20, and the polymerization degree of 295.

### Synthesis Example 5

A cellulose acetate butyrate B-8 was obtained in the same manner as in Synthesis Example 4 in which the formulation of the acylating agent was changed.

### Synthesis Example 6

Further, in the sample B-1 of Synthesis Example 1, a cellulose acetate butyrate B-9 was prepared by using four times the amount of magnesium acetate tetrahydrate used in the neutralization, using the concentration of the aqueous solution of calcium hydroxide of 0.05% and drying as it was without washing after treating with the aqueous solution of calcium hydroxide.

### Synthesis Example 7

Moreover, in the sample B-1 of Synthesis Example 1, a cellulose acetate butyrate B-10 was prepared by using 0.5 times the amount of magnesium acetate tetrahydrate used in the neutralization without treating with the aqueous solution of calcium hydroxide.

In each compound of Synthesis Examples 1 to 7, a sulfate moiety content (residual sulfate group amount) was measured by ASTM D-817-96. Further, a nitric acid was added to the sample, multiwave ashed, and then dissolved in water. Amounts of calcium and magnesium were measured by an ICP-OES method, and amounts of sodium and potassium were measured by an AAS/flame color method. Table 1 shows the substitution degree, the polymerization degree, the residual sulfate group amount (as the content of the sulfur atom), the amounts of calcium, magnesium, sodium and potassium, and metal/sulfate equivalent ratio.

Moreover, any of the compounds in Synthesis Examples 1 to 7 had the ratio of weight average polymerization degree to number average polymerization degree, as measured and calculated by GPC, in the range of 1.9 to 3.05 and an apparent density, as measured in accordance with the method as defined in JIS K-7365, in the range of 0.7 to 1.12 g/cm³.

### Synthesis Example 8

(Synthesis of Cellulose Acetate Propionate P-1 to P-4)

Onto 200 g of cellulose (cotton linter), 200 g of acetic acid was sprayed, and the resultant was put into a reactor with a reflux apparatus and agitated for 1 hour while heating in an oil bath adjusted at 40° C. Cellulose thus pretreated was swollen and grinded and was made to be fluff. The contents of the reactor were cooled to room temperature or less.

Apart from them, a mixture of 177 g of acetic acid, 463 g of acetic anhydride, 864 g of propionic acid, 1096 g of propionic anhydride and 14 g of sulfuric acid as an acylating agent was prepared and cooled to −25° C. and then added all at once to a reactor receiving the cellulose pretreated. After 1.5 hours, the temperature of the inside of the reactor was set to 22° C. and the reaction was continued for 5.5 hours. The reactor was cooled to 0° C. and to the reactor was added a mixture of 1099 g of acetic acid and 366 g of water, which was cooled to about 5° C., over a period of 1 hour. The temperature of the inside of the reactor was raised to 60° C. and agitation was performed for 2 hours (aging).

Subsequently, a mixed solution of 61 g of magnesium acetate tetrahydrate, 61 g of acetic acid and 61 g of water was added to the reactor (neutralization), and agitated at 60° C. for 2 hours. A mixture of (10 L of total volume) acetic acid and water (10 L of total volume) was added to the reactor while gradually increasing the proportion of water to thus precipitate cellulose acetate propionate. The precipitate of cellulose acetate propionate thus obtained was sufficiently washed with hot water of 50° C., and then agitated in a 0.005% aqueous solution of calcium hydroxide for 0.5 hour. Further, the resultant was washed by water until a cleaning fluid being pH 7 and then vacuum dried at 90° C. to obtain a cellulose acetate propionate P-1. Apart from them, in the similar manners, except that magnesium acetate was partially added in the aging process, P-2 was synthesized; in the similar manners, except that the aging was performed at 50° C., P-3 was synthesized; and in the similar manners, except that a neutralizing agent was partially added during the aging, and further neutralization, agitation at 60° C. for 2 hours, and then reprecipitation were sequentially performed, P-4 was synthesized.

According to ¹H-NMR and GPC measurements, the cellulose acetate propionate P-1, P-2 and P-4 thus obtained had the acetylation degree of 1.29, the propionylation degree of 1.55, and the polymerization degree of 305. The cellulose acetate propionate P-3 thus obtained had the acetylation degree of 1.30, the propionylation degree of 1.57, and the polymerization degree of 320.

### Synthesis Example 9

(Synthesis of Cellulose Acetate Propionate P-5)

Onto 180 g of cellulose (cotton linter), 54 g of acetic acid was sprayed, and the resultant was put into a reactor with a reflux apparatus and agitated for 2 hours while adjusting to 40° C. Cellulose thus pretreated was swollen and grinded and was made to be fluff. The contents of the reactor were cooled to room temperature or less.

Apart from them, a mixture of 868 g of propionic acid, 1524 g of propionic anhydride and 12.6 g of sulfuric acid as an acylating agent was prepared and cooled to −25° C. and then added all at once to a reactor receiving the cellulose pretreated. The maximum temperature of the inside of the reactor was set to 23° C. and the reaction was continued for 5 hours. The reactor was cooled to 0° C. and to the reactor was added a mixture of 813 g of acetic acid and 271 g of water, which was cooled to about 5° C., over a period of 1 hour. The temperature of the inside of the reactor was raised to 40° C. and agitation was performed for 1 hour (aging).

Subsequently, a mixed solution of 55 g of magnesium acetate tetrahydrate, 55 g of acetic acid and 55 g of water was added to the reactor (neutralization). A mixture of acetic acid (10 L of total volume) and water (10 L of total volume) was added to the reactor while gradually increasing the proportion of water to thus precipitate cellulose acetate propionate. The precipitate of cellulose acetate propionate thus obtained was sufficiently washed with hot water of 50° C. and then agitated in a 0.005% aqueous solution of calcium hydroxide for 0.5 hour, and further washed by water until a cleaning fluid being pH 7 and then vacuum dried at 90° C. to obtain a cellulose acetate propionate P-5.

According to ¹H-NMR and GPC measurements, the cellulose acetate propionate P-5 thus obtained had the acetylation degree of 0.23, the propionylation degree of 2.52, and the polymerization degree of 250.

### Synthesis Example 10

(Synthesis of Cellulose Acetate Propionate P-6)

Onto 50 g of cellulose (cotton linter), 25 g of acetic acid was sprayed, and the resultant was put into a reactor with a reflux apparatus and agitated for 1 hour while adjusting to 40° C. Cellulose thus pretreated was swollen and grinded and was made to be fluff. The contents of the reactor were cooled to room temperature or less.

Apart from them, a mixture of 11 g of acetic anhydride, 470 g of propionic anhydride and 3.5 g of sulfuric acid as an acylating agent was prepared and cooled to −30° C. and then added all at once to a reactor receiving the cellulose pretreated. After 2 hours, the temperature of the inside of the reactor was raised to 25° C. and the reaction was continued for 4.5 hours. The reactor was cooled to 0° C. and to the reactor was added a mixture of 231 g of acetic acid and 77 g of water, which was cooled to about 5° C., over a period of 1 hour. The temperature of the inside of the reactor was raised to 40° C. and agitation was performed for 10 minutes (aging).

Subsequently, a mixed solution of 15 g of magnesium acetate tetrahydrate, 15 g of acetic acid and 15 g of water was added to the reactor (neutralization), and agitated at 60° C. for 2 hours. A mixture of acetic acid (3 L of total volume) and water (3 L of total volume) were added to the reactor while gradually increasing the proportion of water to thus precipitate cellulose acetate propionate. The precipitate of cellulose acetate propionate thus obtained was sufficiently washed with hot water of 40° C. and then agitated in a 0.005% aqueous solution of calcium hydroxide for 0.5 hour, and further washed by water until a cleaning fluid being pH 7 and then vacuum dried at 90° C. to obtain a cellulose acetate propionate P-6.

According to ¹H-NMR and GPC measurements, the cellulose acetate propionate P-6 thus obtained had the acetylation degree of 0.45, the propionylation degree of 2.47, and the polymerization degree of 240.

### Synthesis Example 11

(Synthesis of Compounds P-C1 and PC2 which are not in Accordance to the Invention)

1) P-C1

A compound P-C1 was synthesized by using cotton linter as a raw material in the same manner as in Synthesis Examples 8 to 10, except that the formulation of the acylating agent and reaction conditions were changed. (the acetylation degree of 0.05, the propionylation degree of 2.35, and the polymerization degree of 220)

2) P-C2

A compound P-C2 was synthesized by using cotton linter as a raw material in the same manner as in Synthesis Examples 8 to 10, except that the formulation of the acylating agent and reaction conditions were changed. (the acetylation degree of 2.60, the propionylation degree of 0.25, and the polymerization degree of 250)

### Synthesis Example 12

(Synthesis of Cellulose Acetate Propionate P-7)

Cellulose Acetate Propionate P-7 was synthesized by using hardwood pulp as a raw material in the same manner as in P-2 of Synthesis Examples 8. (the acetylation degree of 1.31, the propionylation degree of 1.55, and the polymerization degree of 170)

Each of cellulose acylate P-1 to P-6, and P-C1 to P-C3 was subject to measurement, in the same manner as in Synthesis Examples 1 to 7, and the results were shown in Table 2. Each of cellulose acylate P-1 to P-7 had a weight average polymerization degree/number average polymerization degree ranging from 1.9 to 3.2, as measured by a GPC method, and an apparent density ranging from 0.7 to 1.12. Further, each of P-1 to P-7, P-C1, and P-C2 had a metal/sulfur equivalent ratio ranging from 0.25 to 3, as calculated by the equation (A).

### Synthesis Example 13

(Synthesis of Cellulose Acetate Propionate P-11 to P-15)

Onto 150 g of cellulose (hardwood pulp), 75 g of acetic acid was sprayed, and the resultant was put into a reactor with a reflux apparatus and agitated for 1 hour while heating in an oil bath adjusted at 40° C. Cellulose thus pretreated was swollen and grinded and was made to be fluff. The contents of the reactor were cooled to room temperature or less.

Apart from them, a mixture of 12.5 g of acetic anhydride, 1854 g of propionic anhydride and 10.5 g of sulfuric acid as an acylating agent was prepared and cooled to −25° C. and then added all at once to a reactor receiving the cellulose pretreated. The maximum temperature of the inside of the reactor was set to 24° C. and the reaction was continued for 5.5 hours. The time when cellulose as a raw material is lost to form a uniform solution was defined as an ending point of acylation. In this acylation process, the molar ratio of the acetyl group/propionyl group as calculated is 0.063. The reactor was cooled to 0° C. and to the reactor was added a mixture of 918 g of acetic acid and 306 g of water, which was cooled to about 5° C., over a period of 1.5 hours. The temperature of the inside of the reactor was raised to 40° C. and agitation was performed for 1 hour (aging).

Subsequently, a mixed solution of 46 g of magnesium acetate tetrahydrate (2 equivalents with respect to sulfuric acid), 46 g of acetic acid and 46 g of water was added to the reactor (neutralization), and agitated at 60° C. for 2 hours. A mixture of (1 L of total volume) acetic acid and water (3 L of total volume) was added to the reactor while gradually increasing the proportion of water to thus precipitate cellulose acetate propionate. The precipitate of cellulose acetate propionate thus obtained was sufficiently washed with hot water of 75° C., and then agitated in a 0.005% aqueous solution of calcium hydroxide for 0.5 hour. Further, the resultant was washed by water until a cleaning fluid being pH 7 and then vacuum dried at 90° C. to obtain a cellulose acetate propionate P-11. Apart from them, in the similar manners, except that magnesium acetate was partially added in the aging process, P-12 was synthesized; in the similar manners, except that the aging was performed for 0.5 hour, P-13 was synthesized; in the similar manners, except that a neutralizing agent was partially added during the aging, and further neutralization, agitation at 60° C. for 2 hours, and then reprecipitation were sequentially performed, P-14 was synthesized; and in the similar manners, except that aging was not performed, but neutralization was performed immediately after the quenching of the acid anhydride, P-15 was synthesized.

According to ¹H-NMR and GPC measurements, the cellulose acetate propionate P-11 and P-12 thus obtained had the acetylation degree of 0.26, the propionylation degree of 2.66, and the polymerization degree of 220. The cellulose acetate propionate P-13 thus obtained had the acetylation degree of 0.26, the propionylation degree of 2.68, and the polymerization degree of 230. The cellulose acetate propionate P-14 had the acetylation degree of 0.26, the propionylation degree of 2.68, and the polymerization degree of 190. The cellulose acetate propionate P-15 had the acetylation degree of 0.26, the propionylation degree of 2.70, and the polymerization degree of 230.

### Synthesis Example 14

(Synthesis of Cellulose Acetate Propionate P-16)

180 g of cellulose (hardwood pulp) having 90 g of acetic acid sprayed thereonto was put into a reactor with a reflux apparatus and agitated for 2 hours while heating in an oil bath adjusted at 40° C. Cellulose thus pretreated was swollen and grinded and was made to be fluff. The contents of the reactor were cooled to room temperature or less.

Apart from them, a mixture of 97 g of acetic acid, 658 g of propionic acid, 1735 g of propionic anhydride and 12.6 g of sulfuric acid as an acylating agent was prepared and cooled to −25° C. and then added all at once to the reactor receiving the cellulose pretreated. The maximum temperature of the inside of the reactor was set to 22° C. and the reaction was continued for five hours. The time when the raw material cellulose was disappeared from the reaction mixture to become a homogeneous solution was regarded as a terminal point of acylation. The molar ratio of total acetyl groups/total propionyl groups in the step of acylation is calculated as 0.101. The reactor was cooled to 0° C. and to the reactor was added a mixture of 1430 g of acetic acid, 1211 g of propionic acid and 300 g of water, which was cooled to about 5° C., over a period of two hours. The temperature of the inside of the reactor was raised to 40° C. and agitation was performed for 1.5 hours (aging).

Subsequently, a mixed solution of 55 g of magnesium acetate tetrahydrate (2 equivalents with respect to sulfuric acid), 55 g of acetic acid and 55 g of water were added to the reactor (neutralization). A mixture of (2 L of total volume) acetic acid and water (3 L of total volume) were added to the reactor while gradually increasing the proportion of water to thus precipitate cellulose acetate propionate. The precipitate of cellulose acetate propionate thus obtained was washed by hot water of 70° C. for 4 hours and after washing, agitated in 0.005% aqueous solution of calcium hydroxide for 45 minutes, and further washed by water until a cleaning fluid being pH 7 and then vacuum dried at 90° C. to obtain a cellulose acetate propionate P-16.

According to ¹H-NMR and GPC measurements, the cellulose acetate propionate P-16 thus obtained had the acetylation degree of 0.52, the propionylation degree of 2.40, and the polymerization degree of 260.

### Synthesis Example 15

(Synthesis of Cellulose Acetate Propionate P-17)

180 g of cellulose (softwood pulp) having 90 g of acetic acid sprayed thereonto was put into a reactor with a reflux apparatus and agitated for 1 hour while adjusting at 60° C. Cellulose thus pretreated was swollen and grinded and was made to be fluff. The contents of the reactor were cooled to room temperature or less.

Apart from them, a mixture of 7 g of acetic anhydride, 2022 g of propionic anhydride and 12.6 g of sulfuric acid as an acylating agent was prepared and cooled to −30° C. and then added all at once to the reactor receiving the cellulose pretreated. The maximum temperature of the inside of the reactor was set to 35° C. and the reaction was continued for three hours. The reactor was cooled to 0° C. and to the reactor was added a mixture of 1023 g of acetic acid and 341 g of water, which was cooled to about 5° C., over a period of two hours. The temperature of the inside of the reactor was raised to 60° C. and agitation was performed for 1 hour (aging).

Subsequently, a mixed solution of 55 g of magnesium acetate tetrahydrate, 55 g of acetic acid and 55 g of water were added to the reactor (neutralization). A mixture of (1.5 L of total volume) acetic acid and water (3 L of total volume) were added to the reactor while gradually increasing the proportion of water to thus precipitate cellulose acetate propionate. The precipitate of cellulose acetate propionate thus obtained was sufficiently washed by hot water of 40° C. and after washing, agitated in 0.005% aqueous solution of calcium hydroxide for 0.5 hour, and further washed by water until a cleaning fluid being pH 7 and then vacuum dried at 90° C. to obtain a cellulose acetate propionate P-17.

According to ¹H-NMR and GPC measurements, the cellulose acetate propionate P-17 thus obtained had the acetylation degree of 0.33, the propionylation degree of 2.52, and the polymerization degree of 190.

### Synthesis Example 16

(Synthesis of Compounds P-C11 and P-C12 Other than the Invention)

1) P-C11

A compound P-C11 was synthesized by using hardwood pulp as a raw material in the same manner as in Synthesis Examples 13 to 15 in which the formulation of the acylating agent and reaction conditions were changed. (the acetylation degree of 0.05, the propionylation degree of 2.35, and the polymerization degree of 230)

1) P-C12

A compound P-C12 was synthesized by using hardwood pulp as a raw material in the same manner as in Synthesis Examples 13 to 15 in which the formulation of the acylating agent and reaction conditions were changed. (the acetylation degree of 2.60, the propionylation degree of 0.25, and the polymerization degree of 250)

### Synthesis Example 17

(Synthesis of Cellulose Acetate Propionate P-18)

Cellulose Acetate Propionate P-18 was synthesized by using cotton linter as a raw material in the same manner as in P-12 of Synthesis Example 13. (the acetylation degree of 0.27, the propionylation degree of 2.65, and the polymerization degree of 220)

Measurements for cellulose acylates P-11 to 18, P-C11 and P-C12 thus obtained were carried out in the same manner as in Synthesis Examples 1 to 7 and results thereof were shown in Table 3. Any of cellulose acylates P-11 to 18 had the ratio of weight average polymerization degree to number average polymerization degree, as measured by GPC, of 1.9 to 3.2 and an apparent density of 0.17 to 1.12. Further, any of cellulose acylates P-11 to 18, P-C11 and P-C12 had the equivalent ratio of metal/sulfuric acid of 0.25 to 3, as calculated by the formula (A).

### Synthesis Example 18

(Synthesis of Cellulose Acetate Butyrates B-1′, B-21, B-22 and B-23)

Cellulose acetate butyrates B-1′, B-21, B-22 and B-23 were synthesized by partially changing the synthesis procedure in B-1 of Synthesis Example 1.

In the synthesis of B-1 of Synthesis Example 1, cellulose acetate butyrate B-1′ was synthesized by changing that the precipitate of cellulose acetate butyrate was washed by hot water of 75° C. for 4 hours.

In the synthesis of B-1 of Synthesis Example 1, cellulose acetate butyrate B-21 was synthesized by using two times the amount of magnesium acetate used in the neutralization, using the concentration of the aqueous solution of calcium hydroxide of 0.01% and drying without washing after treating with the aqueous solution of calcium hydroxide.

In the synthesis of B-1 of Synthesis Example 1, cellulose acetate butyrate B-22 was synthesized by changing the agitation time at 60° C. after neutralization (post-heating time) into 4 hours.

In the synthesis of B-1 of Synthesis Example 1, 250 g of cellulose (hardwood pulp) grinded into small pieces was put into a reactor and in particular was not pretreated and an acylating agent (a mixture of 346 g of acetic acid, 189 g of acetic anhydride, 1251 g of butyric acid, 1123 g of butyric anhydride and 17.5 g of sulfuric acid), which was cooled to −25° C., was added all at once to the reactor. After a lapse of 1.5 hours, the temperature of the inside of the reactor was raised to 17° C. and the reaction was continued for six hours, but the reaction was not completed. Further, agitation was performed for tow hours. Slight turbidity in the reaction mixture was observed, but at this time, acylation was terminated. The molar ratio of total acetyl groups/total butyryl groups in the step of acylation is calculated as 0.333. Cellulose acetate butyrate B-23 was synthesized in the same treatment as in B-1.

### Synthesis Example 19

(Synthesis of Cellulose Acetate Butyrates B-5′, B-24 and B-25)

Cellulose acetate butyrates B-5′, B-24 and B-25 were synthesized by partially changing the synthesis procedure in B-5 of Synthesis Example 2.

In the synthesis of B-5 of Synthesis Example 2, cellulose acetate butyrate B-5′ was synthesized by changing that the precipitate of cellulose acetate butyrate was washed by hot water of 75° C. for 6 hours.

In the synthesis of B-5 of Synthesis Example 2, cellulose acetate butyrate B-24 was synthesized by changing the agitation time at 60° C. after neutralization (post-heating time) into 4 hours.

In the synthesis of B-5 of Synthesis Example 2, cellulose acetate butyrate B-25 was synthesized by changing that cellulose acetate butyrate was washed at 20° C. for 6 hours.

### Synthesis Example 20

(Synthesis of Cellulose Acetate Propionates P-11′, P-21, P-22 and P-23)

Cellulose acetate propionates P-11′, P-21, P-22 and P-23 were synthesized by partially changing the synthesis procedure in P-11 of Synthesis Example 13.

In the synthesis of P-11 of Synthesis Example 13, cellulose acetate butyrate P-11′ was synthesized by changing that the precipitate of cellulose acetate butyrate was washed by hot water of 75° C. for 5 hours.

In the synthesis of P-11 of Synthesis Example 13, cellulose acetate propionate P-21 was synthesized by changing the agitation time at 60° C. after neutralization (post-heating time) into 6 hours.

In the synthesis of P-11 of Synthesis Example 13, Cellulose acetate propionate P-22 was synthesized by adding the same amount of the mixture of magnesium acetate/acetic acid/water as in the synthesis of P-11 after the completion of aging and immediately thereafter carrying out reprecipitation.

In the synthesis of P-11 of Synthesis Example 13, Cellulose acetate propionate P-23 was synthesized by adding 918 g of acetic acid and 306 g of water after acylation, adding the same amount of the mixture of magnesium acetate/acetic acid/water as in the synthesis of P-11 without heat aging and immediately thereafter carrying out reprecipitation.

### Synthesis Example 21

(Synthesis of Cellulose Acetate Propionate P-16′)

In the synthesis of P-16 of Synthesis Example 14, cellulose acetate propionate P-16′ was synthesized by changing the post-heating for carrying out the agitation time at 60° C. for 4 hours after neutralization.

### Synthesis Example 22

(Synthesis of Cellulose Acetate Butyrate B-7′)

In the synthesis of B-7 of Synthesis Example 4, cellulose acetate butyrate B-7′ was synthesized by changing the post-heating for carrying out the agitation time at 60° C. for 4 hours after neutralization.

Measurements for cellulose acylates synthesized in Synthesis Examples 18 to 22 were carried out in the same manner as in Synthesis Examples 1 to 7 and results thereof were shown in Table 4. Any of cellulose acylates synthesized in Synthesis Examples 18 to 20 had the ratio of weight average polymerization degree to number average polymerization degree, as measured and calculated by GPC, of 1.9 to 3.05 and an apparent density, as measured in accordance with the method as defined in JIS K-7365, of 0.7 to 1.12 g/cm³.

### Example 1

1. Solution Casting of Cellulose Acylate Film

(1) Cellulose Acylate

The cellulose acylate synthesized by the method described in the Synthesis Examples above was used.

(2) Preparation of Cellulose Acylate Solution

(i) Preparation of Solvent

A solvent having a solvent composition consisting of dichloromethane (82.0 wt %), methanol (15.0 wt %) and butanol (3.0 wt %) was prepared

(ii) Drying of Cellulose Acylate

The above-described cellulose acylates were respectively dried to have a water content of 0.5% or less.

(iii) Addition of Additives

Additives of the following compositions were added to the solvent obtained above. The following amounts of addition are all ratios with respect to the steady dry weight of the cellulose acylates. Furthermore, in Samples 2-1 to 2-9, the amount of addition of plasticizer A was changed to 3.1 wt %, and the amount of addition of the optical anisotropy controlling agent was changed to 2.85 wt %, while in Samples 3-1 to 3-10, the amount of addition of plasticizer A was changed to 3.05 wt %, and the amount of addition of the optical anisotropy controlling agent was changed to 2.9 wt %.

[Composition of Additives]

Plasticizer A: triphenyl phosphate (3 wt %)

Plasticizer B: biphenyldiphenyl phosphate (1 wt %)

Optical anisotropy controlling agent: plate-shaped compound described in [Kagaku 1] of JP-A-2003-66230 (3 wt %)

UV agent a: 2,4-bis-(n-octylthio)-6-(4-hydroxy-3,5-di-tert-butylanilino)-1,3,5-triazine (0.5 wt %)

UV agent b: 2(2′-hydroxy-3′,5′-di-tert-butylphenyl)-5-chlorobenzotriazole (0.2 wt %)

UV agent c: 2(2′-hydroxy-3′,5′-di-tert-amylphenyl)-5-chlorobenzotrizole (0.1 wt %)

Microparticles: silicon dioxide (particle size 20 nm, Mohs hardness: about 7) (0.25 wt %)

Citric acid ethyl ester (monoester: diester (=1:1 mixture)) (0.2 wt %)

(iv) Swelling•Dissolution

The cellulose acylate was added with agitation to the solution containing the above-obtained additives. After stopping the agitation, the cellulose acylate was subjected to swelling at 25° C. for 3 hours to produce slurry. The slurry was stirred again to completely dissolve the cellulose acylate.

(v) Filtration•Concentration

Thereafter, the slurry was filtered through a filter paper having an absolute filtration accuracy of 0.01 mm (Toyo Roshi Co., Ltd., #63) and further filtered through a filter paper having an absolute filtration accuracy of 2.5 μm (Nihon Pall, Ltd., FH025) to obtain a cellulose acylate solution. The concentration of the cellulose acylate solution was 25 wt % (total solids content×100/(total solids content+amount of solvent).

(3) Peelability Test

The cellulose acylate solution was flow cast on an SUS sheet maintained at 15° C., to attain a thickness after drying of 80 μm. A cellulose acylate film was formed on the SUS sheet by evaporating the solvent over time, and then the cellulose acylate film was peeled off from the SUS sheet at a rate of 200 mm/sec, the load at this point being measured with a load cell.

(4) Film Formation

The cellulose acylate solution described above was warmed up to 35° C. and flow cast on a mirror-surfaced stainless steel support by the following band method. According to the band method, the cellulose acylate solution was flow cast through a delivery valve on a mirror-surfaced stainless steel support with a band of 60 m in length and maintained at 15° C. The delivery valve used was one similar to the type described in JP-A-11-314233. Also, the temperature in the chamber of the flow casting part was set at 40° C., and the air for heat supply was blown at a rate of 30 m/sec. At the point when the residual solvent reaches 100 wt %, the cellulose acylate film was peeled off from the mirror-surfaced stainless steel support at a load of 20 g/cm, and the temperature was elevated (temperature elevation and lowering) between 40° C. and 120° C. such that the rate of temperature elevation was 30° C./min. Subsequently, the cellulose acylate film was dried at 120° C. for 5 minutes and at 145° C. for 20 minutes, and then gradually cooled at a rate of 30° C./min to obtain a cellulose acylate film. The obtained film was trimmed by 3 cm at both edges, was then provided with knurling of 100 μm in height at positions 2 to 10 mm away from both edges, and was taken up by winding on a 3000-m roll.

The results of the peel-off load test for the cellulose acylate film produced by such method and the results of the surface state after film formation are presented in Table 1 below.

TABLE 1

| | Cellulose acylate | | | | | Evaluation | | | | | | | | |
|---|---|---|---|---|---|---|---|---|---|---|---|---|---|---|
| | | | | | Degree | Amount | | | | | | | | |
| | | | | | of | of | | | | | Metal/ | | | |
| Sam- | | | | | poly- | residual | | | | | sulfate | Peel-off | | |
| ple | | Raw | | B | mer- | sulfate | Ca | Mg | Na | K | Equivalent | load | Surface | |
| No. | Type | material | A | (Butyryl) | ization | (ppm) | (ppm) | (ppm) | (ppm) | (ppm) | ratio | (g/cm) | state | Remark |
| 1-1 | B-1 | Hardwood | 1.20 | 1.50 | 280 | 75 | 32 | 29 | 5 | 1 or | 0.90 | 43 | Good | Present |
| | | Pulp | | | | | | | | less | | | | invention |
| 1-2 | B-2 | Hardwood | 1.20 | 1.50 | 280 | 23 | 43 | 13 | 3 | 1 or | 2.34 | 130 | Peel-off | Comparative |
| | | Pulp | | | | | | | | less | | | step un- | Example |
| | | | | | | | | | | | | | evenness | |
| 1-3 | B-3 | Hardwood | 1.20 | 1.50 | 280 | 240 | 65 | 94 | 6 | 1 or | 0.76 | 26 | Good | Present |
| | | Pulp | | | | | | | | less | | | | invention |
| 1-4 | B-4 | Hardwood | 1.20 | 1.50 | 280 | 98 | 47 | 31 | 3 | 1 or | 0.83 | 35 | Good | Present |
| | | Pulp | | | | | | | | less | | | | invention |
| 1-5 | B-5 | Hardwood | 1.51 | 1.19 | 280 | 96 | 39 | 32 | 4 | 1 or | 0.80 | 39 | Good | Present |
| | | Pulp | | | | | | | | less | | | | invention |
| 1-6 | B-6 | Hardwood | 1.73 | 1.23 | 320 | 580 | 110 | 190 | 7 | 1 or | 0.60 | 12 | Film | Comparative |
| | | Pulp | | | | | | | | less | | | whitening | Example |
| 1-7 | B-7 | Hardwood | 2.61 | 0.20 | 295 | 69 | 23 | 21 | 4 | 1 or | 0.71 | 50 | Foaming | Comparative |
| | | Pulp | | | | | | | | less | | | | Example |
| 1-8 | B-8 | Hardwood | 2.40 | 0.40 | 300 | 79 | 33 | 27 | 2 | 1 or | 0.81 | 54 | Good | Present |
| | | Pulp | | | | | | | | less | | | | invention |
| 1-9 | B-9 | Hardwood | 1.20 | 1.50 | 280 | 72 | 730 | 450 | 10 | 1 or | 16.54 | 47 | Slight | Present |
| | | Pulp | | | | | | | | less | | | clouding | invention |
| 1-10 | B-10 | Hardwood | 1.20 | 1.50 | 280 | 160 | 3 | 22 | 4 | 1 or | 0.22 | 32 | Slight | Present |
| | | Pulp | | | | | | | | less | | | coloring | invention |

The peel-off load of the cellulose acylate film of the invention was confirmed to be within the range of 1.0 g/cm to 60 g/cm, which is preferable for production suitability. On the contrary, Sample 1-2 produced from the cellulose acylate B-2, which is not included in the scope of the invention, and has an amount of residual sulfate in the range disclosed in the above-described JP-2003-279729 (1 to 50 ppm as the content of sulfur element), had large peel-off load and inferior production suitability. As such, it can be seen that the cellulose acylate solution having an amount of residual sulfate in the range according to the invention exhibits good production suitability.

When Sample 1-1 of the invention is compared with Sample 1-8 of the invention, both samples have almost the same amounts of residual sulfate moiety, but it was confirmed that Sample B-1 produced from the cellulose acylate B-1 which has the substitution degree in a range preferred to that of the invention had smaller peel-off load and was superior.

Sample 1-9 produced from the cellulose acylate B-9 which has a larger amount of metal with respect to residual sulfate moiety than the preferred range of the invention, has the peel-off load in the preferable range, but slight clouding was detected at a practically negligible level due to the drying process. Also, Sample 1-10 produced from the cellulose acylate B-10 which has a smaller amount of metal with respect to residual sulfate moiety than the preferred range of the invention was detected to have slight coloration, though at a practically negligible level, due to the heating and drying process. As such, the sample having the ratio of sulfur and metal in the preferred range of the invention was confirmed to be much superior in view of satisfying both thermal stability and surface state.

While the cellulose acylate film of the invention showed good surface state, the cellulose acylate film of the Comparative Example (Sample 1-7), whose degree of butyryl substitution was not included in the scope of the invention, was subject to failure of foaming. Further, the cellulose acylate B-6 of the Comparative Example, whose amount of residual sulfate exceeded the preferred range of the invention, was recognized to have slight coloration due to heating at the drying step before film formation and was found to have low thermal stability. In addition to this, the film produced from B-6 (Sample 1-6) was subject to failure of whitening and was found to be inappropriate for optical film. From these results, the effect of the invention is obvious.

TABLE 2

| | Cellulose acylate | | | | | Evaluation | | | | | | | |
|---|---|---|---|---|---|---|---|---|---|---|---|---|---|
| | | | | | Degree | Amount of | | | | | Peel-off | | |
| Sample | | | | B | of | residual | Ca | Mg | Na | K | load | Surface | |
| No. | Type | Raw material | A | (Propionyl) | polym. | (ppm) | (ppm) | (ppm) | (ppm) | (ppm) | (g/cm) | state | Remark |
| 2-1 | P-1 | Cotton | 1.29 | 1.55 | 305 | 300 | 48 | 125 | 10 | 1 or | 35 | Good | Present |
| | | linter | | | | | | | | less | | | invention |
| 2-2 | P-2 | Cotton | 1.29 | 1.55 | 305 | 160 | 15 | 90 | 11 | 1 or | 30 | Good | Present |
| | | linter | | | | | | | | less | | | invention |
| 2-3 | P-3 | Cotton | 1.30 | 1.57 | 320 | 420 | 65 | 240 | 12 | 1 or | 39 | Good | Present |
| | | linter | | | | | | | | less | | | invention |
| 2-4 | P-4 | Cotton | 1.29 | 1.55 | 305 | 40 | 6 | 25 | 9 | 1 or | 89 | Peel-off | Comparative |
| | | linter | | | | | | | | less | | step | Example |
| | | | | | | | | | | | | unevenness | |
| 2-5 | P-5 | Cotton | 0.23 | 2.52 | 250 | 180 | 30 | 24 | 5 | 1 or | 32 | Good | Present |
| | | linter | | | | | | | | less | | | invention |
| 2-6 | P-6 | Cotton | 0.45 | 2.47 | 240 | 240 | 42 | 85 | 5 | 1 or | 36 | Good | Present |
| | | linter | | | | | | | | less | | | invention |
| 2-7 | P-C1 | Cotton | 0.05 | 2.35 | 220 | 100 | 11 | 36 | 6 | 1 or | 85 | Peel-off | Comparative |
| | | linter | | | | | | | | less | | step | Example |
| | | | | | | | | | | | | unevenness | |
| 2-8 | P-C2 | Cotton | 2.60 | 0.25 | 250 | 130 | 9 | 90 | 7 | 1 or | 48 | Foaming | Comparative |
| | | linter | | | | | | | | less | | | Example |
| 2-9 | P-C3 | Hardwood | 1.31 | 1.55 | 305 | 170 | 23 | 140 | 22 | 1 or | 55 | Good | Present |
| | | Pulp | | | | | | | | less | | | invention |

The peel-off load of the cellulose acylate film of the invention was confirmed to be within the range of 1.0 g/cm to 60 g/cm, which is preferable for production suitability. When the cellulose acylate P-2 employing cotton linter as the raw material and the cellulose acylate P-7 of the invention employing pulp as the raw material are compared, it can be seen that although the property values are almost equal, the cellulose acylate of the invention derived from cotton linter is superior in the aspect of peelability. Furthermore, the cellulose acylate of the invention has less influence of the degree of polymerization on the peelability, and exhibits excellent properties capable of film formation in a wide range of degree of polymerization.

On the contrary, the cellulose acylate P-4 whose content of residual sulfate moiety is beyond the range of the invention, and P-C1 whose degree of acyl substitution is beyond the range of the invention, have larger peel-off loads than the cellulose acylates of the invention and inferior production suitability compared with the samples of the invention. Also, P-C2 whose degree of acetyl substitution and degree of propionyl substitution are both beyond the ranges of the invention, have the peel-off load in the range capable of production, but foaming that is undesirable under the conditions for film formation of the invention was observed.

In addition, the cellulose acylate films of the invention were compared in detail. Only the sample employing P-3 had no problem as to be supplied as commercial products when a forced heating test at 130° C. for 8 hours was carried out, but faint coloration was recognized, and the sample was found to have slightly low thermal stability. On the other hand, in the samples employing the cellulose acylates of the invention other than those, such as P-1, coloration was not observed, and thus it was found that the invention is particularly effective since the amount of residual sulfate moiety is 300 ppm or less in terms of sulfur atoms.

TABLE 3

| | Cellulose acylate | | | | | Evaluation | | | | | | | |
|---|---|---|---|---|---|---|---|---|---|---|---|---|---|
| | | | | | Degree | Amount of | | | | | Peel-off | | |
| Sample | | Raw | | B | of | residual | Ca | Mg | Na | K | load | | |
| No. | Type | material | A | (Propionyl) | polym. | (ppm) | (ppm) | (ppm) | (ppm) | (ppm) | (g/cm) | Surface state | Remark |
| 3-1 | P-11 | Hardwood | 0.26 | 2.66 | 220 | 280 | 30 | 110 | 3 | 1 or | 31 | Good | Present |
| | | Pulp | | | | | | | | less | | | invention |
| 3-2 | P-12 | Hardwood | 0.26 | 2.66 | 220 | 120 | 11 | 40 | 5 | 1 or | 39 | Good | Present |
| | | Pulp | | | | | | | | less | | | invention |
| 3-3 | P-13 | Hardwood | 0.26 | 2.68 | 230 | 410 | 60 | 240 | 6 | 1 or | 28 | Good | Present |
| | | Pulp | | | | | | | | less | | | invention |
| 3-4 | P-14 | Hardwood | 0.26 | 2.66 | 190 | 28 | 1 | 11 | 3 | 1 or | 95 | Peel-off step | Comparative |
| | | Pulp | | | | | | | | less | | unevenness | Example |
| 3-5 | P-15 | Hardwood | 0.26 | 2.70 | 230 | 590 | 75 | 320 | 11 | 1 or | 24 | Whitening | Comparative |
| | | Pulp | | | | | | | | less | | | Example |
| 3-6 | P-16 | Hardwood | 0.52 | 2.40 | 260 | 160 | 55 | 120 | 3 | 1 or | 45 | Good | Present |
| | | Pulp | | | | | | | | less | | | invention |
| 3-7 | P-17 | Hardwood | 0.33 | 2.52 | 190 | 170 | 23 | 95 | 4 | 1 or | 43 | Good | Present |
| | | Pulp | | | | | | | | less | | | invention |
| 3-8 | P-C11 | Hardwood | 0.05 | 2.35 | 230 | 90 | 20 | 50 | 7 | 1 or | 110 | Peel-off step | Comparative |
| | | Pulp | | | | | | | | less | | unevenness | Example |
| 3-9 | P-C12 | Hardwood | 2.60 | 0.25 | 250 | 160 | 30 | 110 | 3 | 1 or | 45 | Whitening | Comparative |
| | | Pulp | | | | | | | | less | | | Example |
| 3-10 | P-18 | Cotton | 0.27 | 2.65 | 220 | 120 | 25 | 75 | 5 | 1 or | 32 | Good | Present |
| | | linter | | | | | | | | less | | | invention |

It can be confirmed that the peel-off load of the cellulose acylate film of the invention is within the range of 1.0 g/cm to 60 g/cm, which is preferable for production suitability. Further, when P-16 or P-17 is compared with P-11 or P-12, it can be seen that the cellulose acylate having high degree of propionylation of the invention is more effective. P-17 of the invention has good peelability despite its low degree of polymerization.

On the contrary, in P-15 having the content of residual sulfate moiety above the range of the invention, and P-C12 having both the degree of acetyl substitution and the degree of propionyl substitution out of the range of the invention, the peelability was good, but whitening that is undesirable for films was observed. Further, P-C11 having the degree of acyl substitution below the range of the invention, and Sample P-14 having the amount of residual sulfate moiety below the range of the invention, which is not included in the invention, had larger peel-off loads than the cellulose acylates of the invention and inferior production suitability.

When a forced heating test at 130° C. for 8 hours was carried out, P-13 had no problem in being supplied as commercial product, but faint coloration was recognized. P-15 which was not included in the invention was recognized to have coloration that would cause problem in being supplied as commercial product. On the other hand, in the samples employing the cellulose acylates of the invention other than those, such as P-11, coloration was not observed, and thus it was found that the amount of residual sulfate moiety needed to be 500 ppm or less, and particularly preferably 300 ppm or less. P-11 through P-17 of the invention all had no differences causing problems in practice in the aspect of peelability when compared with P-18 derived from cotton linter, while they are characterized in that they can be produced from raw materials of low prices, compared with P-18.

### Example 2

The same procedure as in Example 1 was carried out, except that the solvent composition according to Example 1 was changed to comprise 82.0 wt % of methyl acetate (boiling point 58° C.), 10.1 wt % of acetone (boiling point 56° C.), 4.0 wt % of ethanol (boiling point 78° C.), and 3.9 wt % of butanol (boiling point 117° C.); with respect to the above section “1. (2) (iii) Addition of additives”, the additive were prepared to comprise plasticizer A: triphenyl phosphate (9 wt %) and plasticizer B: biphenyldiphenyl phosphate (3 wt %); after introduction and agitation, the cellulose acylate solution was transported by a screw pump with its axial center warmed to 40° C., cooled from the screw periphery, and passed over the cooled part at −75° C. for 3 minutes; with respect to the section “(4) Film formation”, the spatial temperature during film formation was set at 80° C., and the blowing rate of the air for heat supply at the flow casting part was set at 20 m/sec. Here, peeling was carried out at a peel-off load of 40 g/cm. Further, cooling was carried out using a coolant cooled by a freezer to −80° C.

The results of the peel-off load test for the cellulose acylate produced by such method and the surface state after film formation were evaluated. The peel-off load of the cellulose acylate film of the invention was in the range of 1.0 g/cm to 60 g/cm, which is preferable for production suitability, and the cellulose acylate film exhibited good surface state.

### Example 3

Moreover, according to Example 1 of the technical report of the Japan Institute of Invention and Innovation (Article No. 2001-1745), trilayer co-flow casting was carried out using the cellulose acylate solutions produced in the respective above-described Examples. Similarly to Examples 1 and 2, the peel-off load of the cellulose acylate film of the invention was in the range of 1.0 g/cm to 60 g/cm, which is preferable for production suitability, and the cellulose acylate film exhibited good surface state.

### Example 4

(1) Sample B-5-2 having an apparent density of 0.4 was produced by changing the conditions for re-precipitation of the Sample B-5 of Synthesis Example 1. The obtained Sample B-5-2 was used for the preparation of solution and film formation according to Example 1. Although the production suitability was slightly deteriorated because removal of air bubbles was difficult, the peel-off load was 38 g/cm, which was desirable.

Also, Sample B-5-3 having a ratio of weight average degree polymerization/number average degree of polymerization of 1.5 was produced by subjecting the Sample B-5 of Synthesis Example 1 to repeated re-dissolution in acetic acid and re-precipitation in a poor solvent (mixed solvent of acetic acid/water). The yield at this time was 20% or less of the amount of Sample B-5, and the product was inferior in the aspect of industrial profitability. The obtained Sample B-5-3 was used for the production of solution and film formation according to Example 1, and the peel-off load was 36 g/cm, which was desirable.

(2) Sample P-2-2 having an apparent density of 0.4 was produced by changing the conditions for re-precipitation of the Sample P-2 of Synthesis Example 8. The obtained Sample P-2-2 was used for the production of solution and film formation according to Example 1. The peelability of the obtained film was 41 g/cm, which was in the desirable range of the invention, but removal of air bubbles during the preparation of solution was difficult.

Also, Sample P-2-3 having a ratio of weight average degree polymerization/number average degree of polymerization of 1.5 was produced by subjecting the Sample P-1 of Synthesis Example 8 to repeated re-dissolution in acetic acid and re-precipitation in a poor solvent (mixed solvent of acetic acid/water). The obtained Sample P-2-3 was used for the production of solution and film formation according to Example 1, and the peelability was 37 g/cm, which was in the desirable range of the invention. However, the yield of P-2-3 was 15% or less of Sample P-2, but it was not suitable in the aspect of industrial profitability.

P-2-4 was also produced in the same manner as in the process for P-2 of Synthesis Example 8, except that the amount of magnesium acetate for the neutralization in Synthesis Example 8 was doubled, the concentration of the aqueous solution of calcium hydroxide was 0.01%, and the product obtained after the treatment with an aqueous solution of calcium hydroxide was directly dried without washing with water. The value of the metal/sulfur equivalent ratio of this sample calculated according to the above Formula (A) was 4.0. P-2-4 thus obtained was used for the production of solution and film formation according to Example 1. The peelability of the obtained film was 42 g/cm, which was in the desirable range of the invention, but clouding undesirable for a cellulose acylate solution was observed, which required time for filtration.

(3) Sample P-2-2 having an apparent density of 0.4 was produced by changing the conditions for re-precipitation of the Sample P-12 of Synthesis Example 13. The obtained Sample P-2-2 was used for the production of solution and film formation according to Example 1. The peelability of the obtained film was 39 g/cm, which was in the desirable range of the invention, but removal of air bubbles during the preparation of solution was difficult.

Also, Sample P-2-3 having a ratio of weight average degree polymerization/number average degree of polymerization of 1.5 was produced by subjecting the Sample P-11 of Synthesis Example 13 to repeated re-dissolution in acetic acid and re-precipitation in a poor solvent (mixed solvent of acetic acid/water). The obtained Sample P-2-3 was used for the production of solution and film formation according to Example 1, and the peelability was 36 g/cm, which was in the desirable range of the invention. However, the yield of P-2-3 was 15% or less of Sample P-2, but it was not suitable in the aspect of industrial profitability.

P-2-4 was also produced in the same manner as in the process for P-12 of Synthesis Example 13, except that the amount of magnesium acetate for the neutralization in Synthesis Example 13 was doubled, the concentration of the aqueous solution of calcium hydroxide was 0.01%, and the product obtained after the treatment with an aqueous solution of calcium hydroxide was directly dried without washing with water. The value of the metal/sulfur equivalent ratio of this sample calculated according to the above Formula (A) was 4.0. P-2-4 thus obtained was used for the production of solution and film formation according to Example 1. The peelability of the obtained film was 41 g/cm, which was in the desirable range of the invention, but clouding undesirable for a cellulose acylate solution was observed, which required time for filtration.

### Example 5

(Pelletization of Cellulose Acylate)

The cellulose acylate described in Table 4 was dried by air blowing at 120° C. for 3 hours, and the water content determined according to the Carl Fisher method was 0.1 wt %, plasticizers selected as follows were added, and 0.05 wt % of silicon dioxide (Aerosil R972V) was added at the total level.

Plasticizer A: triphenyl phosphate

Plasticizer B: dioctyl adipate

A mixture of these was kneaded in the hopper of a twin screw kneading extruder. In addition, a vacuum vent was provided in this twin screw kneading extruder to conduct evacuation (set at 0.3 atmospheres).

After melting in this way, the mixture was extruded in a strand form of 3 mm in diameter into a water bath, immersed therein for 1 minute (strand solidification), subsequently the strands were passed through water at 10° C. for 30 seconds to cool and were cut to a length of 5 mm. The pellets thus produced were dried at 100° C. for 10 minutes and then packed in a bag.

(Melt Casting)

The cellulose acylate pellets thus produced were dried in a vacuum dryer at 110° C. for 3 hours. These were charged into the hopper adjusted to Tg−10° C., melted at 195° C. for 3 hours, and then subjected to film formation. Here, the speed of the casting drum was adjusted to T/D times (lip interval/thickness of formed film) the speed of extrusion to obtain a film of desired thickness (D)

The casting drum was set at Tg−10° C., and solidification was conducted over this drum to form a film. At this time, leveling was carried out by the use of a leveling static application method, in which a wire of 10 kV was placed at a position 10 cm away from a touch point of the film on a casting drum. The solidified melt was peeled off from the surface of the casting drum and its both edges (5% of the total width) were trimmed immediately before winding. Then, the resulting film was subjected to processing (knurling) to make both edges have a width of 10 mm and a thickness of 50 μm, and then was wound around a roll by 3000 m at 30 m/minute. The width of the unstretched film thus obtained was all 1.5 m at each level, and the thickness is described in Table 5. The results of evaluating the film thus obtained for microscopic polarizing foreign matters, Re, Rth and coloration are also described in Table 5.

TABLE 4

| | Cellulose acylate | | | | Evaluation | | | | | | |
|---|---|---|---|---|---|---|---|---|---|---|---|
| | | | | Degree | | | | | | Peel-off | |
| Sample | | | | of | Amount of | | | | | load | |
| No. | Type | A | B | polym. | residual (ppm) | Ca (ppm) | Mg (ppm) | Na (ppm) | K (ppm) | (g/cm) | Remark |
| 4-1 | B-1′ | 1.20 | Butyryl = 1.50 | 280 | 75 | 11 | 24 | 4 | 1 or less | 0.58 | Present invention |
| 4-2 | B-21 | 1.20 | Butyryl = 1.50 | 280 | 72 | 153 | 80 | 4 | 1 or less | 3.22 | Present invention |
| 4-3 | B-22 | 1.20 | Butyryl = 1.50 | 280 | 28 | 9 | 11 | 3 | 1 or less | 0.86 | Present invention |
| 4-4 | B-23 | 1.22 | Butyryl = 1.49 | 250 | 77 | 13 | 22 | 3 | 1 or less | 0.54 | Comparative Example |
| 4-5 | B-5′ | 1.51 | Butyryl = 1.19 | 280 | 96 | 15 | 37 | 4 | 1 or less | 0.67 | Present invention |
| 4-6 | B-24 | 1.51 | Butyryl = 1.19 | 280 | 42 | 15 | 24 | 6 | 1 or less | 1.15 | Present invention |
| 4-7 | B-25 | 1.51 | Butyryl = 1.19 | 280 | 150 | 20 | 125 | 7 | 1 or less | 1.25 | Present invention |
| 4-8 | P-11′ | 0.26 | Propionyl = 2.66 | 220 | 28 | 1 | 11 | 3 | 1 or less | 0.63 | Present invention |
| 4-9 | P-21 | 0.26 | Propionyl = 2.66 | 220 | 20 | 1 | 8 | 3 | 1 or less | 0.68 | Present invention |
| 4-10 | P-22 | 0.26 | Propionyl = 2.66 | 220 | 320 | 35 | 120 | 4 | 1 or less | 0.60 | Comparative Example |
| 4-11 | P-23 | 0.26 | Propionyl = 2.70 | 230 | 590 | 75 | 180 | 11 | 1 or less | 0.52 | Comparative Example |
| 4-12 | P-16′ | 0.52 | Propionyl = 2.40 | 260 | 64 | 3 | 17 | 5 | 1 or less | 0.45 | Present invention |
| 4-13 | B-7′ | 2.61 | Butyryl = 0.20 | 295 | 59 | 7 | 16 | 3 | 1 or less | 0.49 | Comparative Example |

TABLE 5

| | Cellulose acrylate film | | | Evaluation | | | | | |
|---|---|---|---|---|---|---|---|---|---|
| Sample | Cellulose | | | Microscopic | Re | Rth | Amount of residual | | |
| No. | acrylate | Plasticizer | Thickness | Foreign Matters | (nm) | (nm) | sulfate moiety | Coloration | Remark |
| 4-1 | B-1′ | A | 83 | 1 | 7 | 11 | 75 | 1 | Present invention |
| 4-2 | B-21 | A | 81 | 0 | 3 | 14 | 72 | 1 | Present invention |
| 4-3 | B-22 | A | 84 | 1 | 2 | 3 | 28 | 1 | Present invention |
| 4-4 | B-23 | A | 83 | 11 | 5 | 7 | 77 | 2 | Comparative Example |
| 4-5 | B-5′ | A | 75 | 1 | 4 | 9 | 96 | 1 | Present invention |
| 4-6 | B-24 | A | 93 | 1 | 5 | 11 | 42 | 1 | Present invention |
| 4-7 | B-25 | A | 95 | 1 | 5 | 12 | 150 | 2 | Present invention |
| 4-8 | P-11′ | B | 86 | 0 | 3 | 3 | 28 | 1 | Present invention |
| 4-9 | P-21 | B | 91 | 1 | 6 | 8 | 20 | 1 | Present invention |
| 4-10 | P-22 | A | 86 | 0 | 3 | 4 | 320 | 3 | Comparative Example |
| 4-11 | P-23 | A | 79 | — | — | — | 590 | 5 | Comparative Example |
| 4-12 | P-16′ | B | 93 | 0 | 10 | 14 | 64 | 1 | Present invention |
| 4-13 | B-7′ | A | — | — | — | — | 59 | | Comparative Example |

The samples produced from Sample B-1′, B-21, B-5′, P-11′, P-21 and P-16′ of the invention having small amounts of residual sulfate moiety, which were subjected to post-heating after neutralization, were all found to have little or no coloration. The sample produced from B-25 which was washed at a low temperature tended to have slightly deteriorated color tone compared with the sample washed with warm water, and thus it was found that the invention was further made effective by washing with warm water.

In this regard, all of the Samples for Comparison P-22 and P-23 produced without post-heating had large coloration, and especially P-23 having many residual sulfate moiety was at a level incapable of being produced as commercial product.

It was found that the samples produced according to the method for production of the invention all provided cellulose acylate having less microscopic foreign mattes suitable for optical film, but when compared with the Samples for Comparison B-23 and B-1 which were not subjected to the pretreatment process of acylation, the samples had a lot of microscopic foreign matters and were inferior in the characteristics for optical film.

Moreover, the cellulose acetate butyrate B-7 whose substitution degree was beyond the range of the invention, had high melting point, and thus had much coloration at the melting temperature during pelletization and was not capable of melt casting.

### Example 6

[Evaluation of Optical Properties and Moisture Dependency]

The cellulose acylate films described in Examples 1 through 3 and 5 were evaluated for Re, Rth, moisture dependency and optical elasticity. As a result, the cellulose acylate films of the invention described in Examples 1 through 3 and 5 exhibited good properties that satisfy the following ranges.

Re(nm)≦Rth(nm)

0≦Re(nm)≦300

0≦Rth(nm)≦500

0≦ΔRe (%/relative humidity %)≦90

0≦ΔRth (%/relative humidity %)≦90

5×10⁻⁷≦optical elasticity (cm²/kgf)≦30×10⁻⁷

### Example 7

[Application of Cellulose Acylate Film]

1) Production of Stretched Film

The unstretched films of the invention described in Examples 1 through 3 and 5 were stretched, and the respective cellulose acylate films were MD stretched at a rate of 100%/sec and TD stretched at a rate of 20%/sec at a temperature 10° C. higher than Tg. The process of stretching was carried out by simultaneous biaxial stretching of sequential stretching where longitudinal stretching and then transverse stretching are carried out sequentially, and by simultaneous biaxial stretching where longitudinal and transverse stretching were simultaneously carried out. The Re, Rth, moisture dependency and optical elasticity of the cellulose acylate films produced by such stretching process were measured, and the cellulose acylate films of Examples 1 through 3 and 5 of the invention gave good results satisfying the following ranges.

Re(nm)≦Rth(nm)

0≦Re(nm)≦300

0≦Rth(nm)≦500

0≦ΔRe (%/relative humidity %)≦90

0≦ΔRth (%/relative humidity %)≦90

5×10⁻⁷≦optical elasticity (cm²/kgf)≦30×10⁻⁷

In addition, the glass transition temperature (Tg) of the respective cellulose acylate films was measured by the following method.

20 mg of a cellulose acylate film was placed in the measuring pan of DSC. This was heated from 30° C. to 240° C. at a rate of 10° C./min under a nitrogen stream (1^{st} run) and then cooled to 30° C. at a rate of −50° C./min. Subsequently the film was heated again from 30° C. to 240° C. (2^{nd} run), and the glass transition temperature (Tg) was determined for the 2^{nd} run. According to the invention, Tg refers to the temperature where the baseline starts to eccentrize from the low temperature side.

2) Production of Polarizing Plate

(1) Saponification of the Cellulose Acylate Film

For the above-described cellulose acylate films of the invention, the unstretched and stretched cellulose acylate films were saponified as the procedure described below.

A 1.5 mol/L aqueous solution of NaOH was used as saponification liquid. This saponification liquid was heated at 60° C. in which a cellulose acylate film was immersed for two minutes. Thereafter, the cellulose acylate film was immersed in a 0.05 mol/L aqueous solution of sulfuric acid for 30 seconds and was passed through a washing bath.

(2) Preparation of Polarizing Layer

According to Example 1 described in JP-A-2001-141926, the cellulose acylate film was passed through two pairs of nip rolls with different peripheral speeds to stretch the film longitudinally, and thus a polarizing layer having a thickness to 20 μm was produced.

(3) Lamination

The polarizing layer thus obtained and two sheets selected from the unstretched and stretched cellulose acylate film saponified in such a manner as described above were adhered such that the polarizing layer was interposed between the cellulose acylate films and then the films were adhered using a 3% aqueous solution of “PVA-117H” manufactured by KURARAY Co. Ltd. as an adhesive so that the polarizing axis and the longitudinal direction of the cellulose acylate films were in 90°. Among these, the unstretched and stretched cellulose acylate films were mounted on a 20-in VA type liquid crystal display device described in FIG. 2-9 in JP-A-2000-154261 at 25° C. and relative humidity of 60%, and this was brought to 25° C. and relative humidity of 10%. By using the cellulose acylate film of the invention, good performance with small color tone change and less display unevenness could be obtained.

Further, when a polarizing plate was produced by using the cellulose acylate film of the invention in the same manner as in the polarizing plate stretched according to Example 1 of JP-A-2002-86554, using a tenter so that the axis of stretching was inclined 45°, good results could be obtained as in the above.

3) Production of Optical Compensation Film

Instead of the cellulose acetate film coated with a liquid crystal layer of Example 1 of JP-A-11-316378, the stretched cellulose acylate films of the invention which had been subjected to saponification were mounted on the bend alignment liquid crystal cell described in Example 9 of JP-A-2002-62431 at 25° C. and a relative humidity of 60%, and this was brought to 25° C. and a relative humidity of 10%. By using the cellulose acylate film of the invention, good display performance with small contrast change could be obtained.

Moreover, an optical compensation filter film was produced using the stretched cellulose acylate film of the invention, instead of the cellulose acetate film coated with a liquid crystal layer of Example 1 of JP-A-7-333433. In this case, good optical compensation film could be obtained.

Further, the polarizing plate and the retardation polarizing plate employing the cellulose acylate films of the invention were used in the liquid display device described in Example 1 of JP-A-10-48420, the optically anisotropic layer containing discotic liquid crystal molecules and the alignment layer coated with polyvinyl alcohol described in Example 1 of JP-A-9-26572, the 20-in VA type liquid crystal display device 1 described in FIGS. 2-9 of JP-A-2000-154261, the 20-in OCB type liquid crystal display device described in FIGS. 10-15 of JP-A-2000-154261, and the IPS type liquid crystal display device described in FIG. 11 of JP-A-2004-12731. Good liquid crystal display devices were obtained.

4) Production of Low Reflection Film

A low reflection film was produced by using the above-described stretched cellulose acylate film according to Example 47 of the Technical Report of the Japan Institute of Invention and Innovation (Article No. 2001-1745), and good optical performance could be obtained by using the cellulose acylate film of the invention.

Further, the above-mentioned low reflection film was mounted on the outermost layers of the liquid crystal display device described in Example 1 of JP-A-10-48420, the 20-in VA type described in FIGS. 2-9 of JP-A-2000-154261, and the 20-in OCB type liquid crystal display device described in FIGS. 10-15 of JP-A-2000-154261, and evaluation was carried out. Good liquid crystal display devices were obtained.

According to the present invention, cellulose acylate films having good peelability, excellent surface state and excellent productivity can be obtained. The invention is a useful invention with high industrial applicability.

The present disclosure relates to the subject matter contained in Japanese Patent Application No. 25227/2005 filed on Feb. 1, 2005, Japanese Patent Application No. 25229/2005 filed on Feb. 1, 2005, Japanese Patent Application No. 25230/2005 filed on Feb. 1, 2005, and Japanese Patent Application No. 25232/2005 filed on Feb. 1, 2005, which are expressly incorporated herein by reference in their entirety.

The foregoing description of preferred embodiments of the invention has been presented for purposes of illustration and description, and is not intended to be exhaustive or to limit the invention to the precise form disclosed. The description was selected to best explain the principles of the invention and their practical application to enable others skilled in the art to best utilize the invention in various embodiments and various modifications as are suited to the particular use contemplated. It is intended that the scope of the invention not be limited by the specification, but be defined claims set forth below.

What is claimed is:

1. A method for production of cellulose acylate satisfying the requirements of (1) to (3) below:
(1): 2.5≦A+B≦3
(2): 0≦A≦2.5
(3): 0.3≦B≦3
wherein A represents the substitution degree of an acetyl group, and B represents the sum of the substitution degrees of an acyl group having 3 to 7 carbon atoms, and
comprising at least
1) contacting cellulose with a carboxylic acid having 2 to 7 carbon atoms and maintaining the system at 20° C. to 100° C. (pretreatment process);
2) acylating the cellulose obtained after the pretreatment process, with an acylating agent in the presence of a sulfuric acid catalyst (acylation process); and
3) maintaining the reaction mixture at 30° C. to 100° C. for at least 1 hour in a state where base is present in a stoichiometric excess with respect to sulfate moiety (post-heating process), the post-heating process being carried out in any step between after the acylation process and before re-precipitation.

2. The method for production of cellulose acylate according to claim 1, wherein A in (2) is 0.05 or larger.

3. The method for production of cellulose acylate according to claim 1, wherein the acylation process satisfies the requirement of (B) below:
0<(MA/MB)≦2.0 (B):
wherein MA represents the total molar amount of the acetyl group contained in the reaction mixture for the acylation process, and MB represents the total molar amount of an acyl group having 3 to 7 carbon atoms contained in the reaction mixture for the acylation process.

4. The method for production of cellulose acylate according to claim 1, which produces a cellulose acylate having a propionyl group or a butyryl group as the acyl group having 3 to 7 carbon atoms.

5. The method for production of cellulose acylate according to claim 1, wherein the cellulose and the carboxylic acid having 2 to 7 carbon atoms are contacted with each other and maintained at 40° C. to 100° C. in the pretreatment process.

6. The method for production of cellulose acylate according to claim 1, wherein the maximum temperature reached during acylation is controlled to be 30° C. or lower in the acylation process.

7. The method for production of cellulose acylate according to claim 1, wherein the amount of base in the post-heating process is 1.2 equivalents to 50 equivalents with respect to sulfate moiety.

8. The method for production of cellulose acylate according to claim 1, wherein the base used in the post-heating process is the carbonate, organic acid salt, phosphate, hydroxide or oxide of at least one selected from the group consisting of ammonium, alkali metals, Group 2 metals and Group 13 elements.

9. The method for production of cellulose acylate according to claim 1, wherein the reaction mixture is maintained at 40° C. to 100° C. in the post-heating process.

10. The method for production of cellulose acylate according to claim 1, wherein the reaction mixture is maintained at 30° C. to 100° C. for 2 hours to 100 hours in the post-heating process.

11. The method for production of cellulose acylate according to claim 1, comprising washing cellulose acylate at 40° C. to 95° C. for 1 hour to 100 hours.

12. A Cellulose acylate produced by the method for production according to claim 1.

13. A cellulose acylate solution satisfying the requirements of (1) to (3) below, and containing a cellulose acylate having an amount of residual sulfate moiety such that 50 ppm<S<500 ppm, wherein S is the content of sulfur atoms of the residual sulfate moiety:
(1): 2.5≦A+B≦3
(2): 0≦A≦2.5
(3): 0.3≦B≦3
wherein A represents the substitution degree of an acetyl group, and B represents the sum of the substitution degrees of an acyl group having 3 to 7 carbon atoms.

14. The cellulose acylate solution according to claim 13, wherein the cellulose acylate satisfies the requirements of (4) to (6) below:
(4): 2.5≦A+B≦3
(5): 0.1≦A≦1.7
(6): 0.9≦B≦2.95
wherein A represents the substitution degree of an acetyl group, and B represents the sum of the substitution degrees of an acyl group having 3 to 7 carbon atoms.

15. The cellulose acylate solution according to claim 13, wherein the acyl group having 3 to 7 carbon atoms is a butyryl group.

16. The cellulose acylate solution according to claim 13, wherein the acyl group having 3 to 7 carbon atoms is a propionyl group.

17. The cellulose acylate solution according to claim 13, wherein the amount of residual sulfate moiety is 50 ppm<S<300 ppm, wherein S is the content of sulfur atoms of the residual sulfate moiety.

18. The cellulose acylate solution according to claim 13, wherein the sum M of the amount of residual alkali metal M1 and the amount of residual Group 2 element M2 of the cellulose acylate is 50 ppm<M<1000 ppm.

19. The cellulose acylate solution according to claim 13, wherein the metal/sulfur equivalent ratio obtained from the following Formula (A) involving the amount of residual sulfate moiety S′, S′ being the molar-equivalent amount of the content of sulfur atoms, the molar-equivalent amount of residual alkali metal M1′ and the molar-equivalent amount of residual Group 2 element M2′ of the cellulose acylate, is 0.25 to 3:
Metal/sulfur equivalent ratio={(M1′/2)+M2′}/S′ (A):

20. The cellulose acylate solution according to claim 13, wherein the apparent density of the cellulose acylate is 0.7 to 1.2.

21. The cellulose acylate solution according to claim 13, wherein the weight average degree of polymerization/number average degree of polymerization obtained by gel permeation chromatography of the cellulose acylate is 1.6 to 3.6.

22. The cellulose acylate solution according to claim 13, wherein the cellulose acylate is a cellulose acylate made from cotton linter.

23. The cellulose acylate solution according to claim 13, wherein the cellulose acylate is a cellulose acylate made from softwood pulp or hardwood pulp.

24. The cellulose acylate solution according to claim 13, wherein the cellulose acylate is a cellulose acylate produced by at least
1) contacting cellulose with a carboxylic acid having 2 to 7 carbon atoms and maintaining the system at 20° C. to 100° C. (pretreatment process);
2) acylating the cellulose obtained after the pretreatment process, with an acylating agent in the presence of a sulfuric acid catalyst (acylation process); and
3) maintaining the reaction mixture at 30° C. to 100° C. for at least 1 hour in a state where base is present in a stoichiometric excess with respect to sulfate moiety (post-heating process), the post-heating process being carried out in any step between after the acylation process and before re-precipitation.

25. A method for production of cellulose acylate film, comprising forming a film from the cellulose acylate solution according to claim 13 by the solution casting method.

26. A cellulose acylate film formed from the cellulose acylate solution according to claim 13 by the solution casting method.

27. A cellulose acylate film formed by dissolving the cellulose acetate according to claim 12.

28. The cellulose acylate film according to claim 26, wherein the in-plane retardation (Re) and the retardation of the thickness direction (Rth) satisfy the requirements of (7) to (9) below:
(7): Re≦Rth
(8): 0 nm≦Re≦300 nm
(9): 0 nm≦Rth≦500 nm.

29. The cellulose acylate film according to claim 26, which is stretched 1% to 500% in at least one direction.

30. A retardation film using the cellulose acylate film according to claim 26.

31. A polarizing plate comprising a polarizing layer and two sheets of protective films having the polarizing layer interposed in between, wherein at least one of the protective films is the cellulose acylate film according to claim 26 or the retardation film using the cellulose acylate film.

32. An optical compensation film having an optically anisotropic layer formed by aligning a liquid crystalline compound on the cellulose acylate film according to claim 26 or the retardation film using the cellulose acylate film.

33. A reflection-preventing film having a reflection-preventing layer on the cellulose acylate film according to claim 26 or the retardation film using the cellulose acylate film.

34. An image display device comprising the cellulose acylate film according to claim 26.

35. The image display device according to claim 34, comprising a retardation film having the cellulose acylate film.

36. The image display device according to claim 34, comprising a polarizing plate having the cellulose acylate film.

37. The image display device according to claim 34, comprising an optical compensation film having the cellulose acylate film.

38. The image display device according to claim 34, comprising a reflection-preventing film having the cellulose acylate film.
